(19) United States
(12) Patent Application Publication
(10) Pub. No.: US 2022/0350605 A1
(43) Pub. Date: Nov. 3, 2022

(54) INFORMATION PROCESSING APPARATUS

(71) Applicant: Sony Group Corporation, Tokyo (JP)

(72) Inventors: Hiro IWASE, Tokyo (JP); Yuhei TAKI, Tokyo (JP); Kunihito SAWAI, Tokyo (JP); Masaki TAKASE, Tokyo (JP); Akira MIYASHITA, Tokyo (JP)

(73) Assignee: Sony Group Corporation, Tokyo (JP)

(21) Appl. No.: 17/613,494

(22) PCT Filed: May 15, 2020
(86) PCT No.: PCT/JP2020/019374

§ 371 Date: Jun. 27, 2022

(30) Foreign Application Priority Data
May 30, 2019 (JP) 2019-101310

(51) Int. Cl. G06F 9/30; G10L 15/22

(52) U.S. Cl. CPC G06F 9/3017; G10L 15/22

(57) ABSTRACT

The present disclosure relates to an information processing apparatus that easily performs collective execution of a plurality of habitual operations of a user.

A habitual operation cluster formed with a plurality of operations having a habituation score higher than a predetermined threshold is registered, the registered habitual operation cluster is presented, and the habitual operation cluster is collectively executed on the basis of a user operation or a user utterance, the habituation score indicating the degree of habituation of the user operation. The present disclosure can be applied to ac information processing apparatus.

### TECHNICAL FIELD

The present disclosure relates to an information processing apparatus, and more particularly, to an information processing apparatus capable of collectively executing a plurality of user's habitual operations with ease.

### BACKGROUND ART

A technique has been suggested for estimating an operational habit of a user from the operation history of the user, and assisting the user s operations.

For example, a technique has been suggested for storing as operation history, predicting the next operation from a transition probability, and performing the predicted next operation (see Patent Document 1).

Also, a technique has been suggested for estimating a viewing habit in terms of a day or time from a viewing history, and assisting operations related to viewing (see Patent Document 2).

### CITATION LIST

### Patent Documents

Patent Document 1: Japanese Patent No. 5340774
Patent Document 2: Japanese Patent No. 5175518

### SUMMARY OF THE INVENTION

### Problems to be Solved by the Invention

By the technique disclosed in Patent Literature 1, however, it is not possible to estimate a plurality of operations (a cluster as a group of operations, end determination) having simultaneity in consideration of the time interval between operations, and further, it is not possible to detect a plurality of operations among which the order of operations can be changed.

Further, by the technique disclosed in Patent Document 2, habituation based on continuity or simultaneity in a plurality of operations cannot be estimated.

The present disclosure has been made in view of such circumstances, and particularly, aims to enable easy collective execution of a plurality of user's habitual operations by clustering these operations as a cluster of operations.

### Solutions to Problems

An information processing apparatus of a first aspect of the present disclosure is an information processing apparatus including a control unit that calculates a habituation score indicating the degree of habituation of a user operation, and registers a plurality of operations as a habitual operation cluster, the habituation score of the operations being higher than a predetermined threshold.

In the first aspect of the present disclosure, the habituation score indicating the degree of habituation of a user operation is calculated, and a plurality of operations having the habituation score higher than a predetermined threshold is registered as a habitual operation cluster.

An information processing apparatus of a second aspect of the present disclosure is an information processing apparatus including a control unit that collectively executes a habitual operation cluster on the basis of a user operation or a user utterance, the habitual operation cluster having being registered in advance and including a plurality of operations having a higher habituation score than a predetermined threshold, the habituation score indicating the degree of habituation of the user operation.

In the second aspect of the present disclosure, a habitual operation cluster that is registered beforehand and includes a plurality of operations having a habituation score higher than a predetermined threshold is collectively executed on the basis of a user operation or a user utterance, the habituation score indicating the degree of habituation of the user operation.

### BRIEF DESCRIPTION OF DRAWINGS

FIG. 1 is a diagram for explaining conventional browsing.

FIG. 2 is a diagram for explaining a conventional macro registration process.

FIG. 3 is a diagram for explaining an outline of the present disclosure.

FIG. 4 is a diagram for explaining an example configuration of an information processing apparatus to which the technology of the present disclosure is applied.

FIG. 5 is a diagram for explaining habituation scores corresponding to user operation information.

FIG. 6 is a flowchart for explaining a habitual operation clustering process.

FIG. 7 is a chart for explaining integration of habitual operation clusters.

FIG. 8 is a chart for explaining integration of habitual operation clusters.

FIG. 9 is a diagram showing an example presentation of a habitual operation cluster.

FIG. 10 is a diagram showing an example presentation of a habitual operation cluster.

FIG. 11 is a diagram showing an example presentation of a habitual operation cluster.

FIG. 12 is a diagram for explaining conversion of a habitual operation cluster into a macro.

FIG. 13 is a flowchart for explaining a GUI macro conversion process.

FIG. 14 is a diagram for explaining an example in which the termination operation of a habitual operation cluster is detected, and macro conversion is suggested.

FIG. 15 is a flowchart for explaining a macro conversion suggesting processing at a time of the termination operation of a habitual operation cluster.

FIG. 16 is a diagram for explaining an example in which the top operation of a habitual operation cluster is detected, and macro conversion is suggested, on the basis of a macro conversion instruction by voice during an operation.

FIG. 17 is a flowchart for explaining a habitual operation cluster macro conversion suggesting process based on a voice macro conversion instruction.

FIG. 18 is a diagram for explaining an example in which collective execution of a habitual operation cluster is suggested at the time of the top operation of the habitual operation cluster.

FIG. 19 is a flowchart for explaining a collective execution suggesting process at the time of the top operation of a habitual operation cluster.

FIG. 20 is a diagram for explaining an example in which collective execution of a habitual operation cluster including keywords having a high degree of coincidence with keywords uttered by the user is suggested.

FIG. 21 is a flowchart for explaining a process of suggesting collective execution of a habitual operation cluster having a high degree of coincidence with keywords uttered by the user.

FIG. 22 is a diagram for explaining another example presentation of a habitual operation cluster including a keyword having a high degree of coincidence with an uttered keyword.

FIG. 23 is a diagram for explaining an example process (1) in a case where an error occurs in collective execution of a habitual operation cluster.

FIG. 24 is a diagram for explaining an example process (2) in a case where an error occurs is collective execution of a habitual operation cluster.

FIG. 25 is a diagram for explaining an example process (3) in a case where an error occurs is collective execution of a habitual operation cluster.

FIG. 26 is a flowchart for explaining an error handling process.

FIG. 27 is a flowchart for explaining a cluster dividing process.

FIG. 28 is a diagram for explaining an example process (1) in a case where an operation in the middle of a registered habitual operation cluster is detected.

FIG. 29 is a diagram for explaining an example process (2) in a case where an operation in the middle of a registered habitual operation cluster is detected.

FIG. 30 is a diagram for explaining an example process (3) is a case where an operation in the middle of a registered habitual operation cluster is detected.

FIG. 31 is a flowchart for explaining an intermediate operation handling process.

FIG. 32 is a flowchart for explaining an utterance trigger control process.

FIG. 33 is a flowchart for explaining an operation trigger control process.

FIG. 34 is a diagram for explaining an example configuration of a general-purpose personal computer.

### MODES FOR CARRYING OUT THE INVENTION

The following is a detailed description of preferred embodiments of the present disclosure, with reference to the accompanying drawings. Note that, in this specification and the drawings, components having substantially the same functional configurations are denoted by the same reference numerals, and explanation of them will not be repeated.

The following is a description of modes for carrying out the present technology. Explanation will be made in the following order.

1. Outline of the present disclosure

2. Preferred embodiment

3. Examples in which processes are carried out by software

<<1. Outline of the Present Disclosure>>

<Browsing>

The present disclosure is to enable easy collective execution of a plurality of habitual operations of a user.

First, an outline of the present disclosure is explained.

To explain an outline of the present disclosure, an example case where a user browses using a web browser of a personal computer (PC), for example, is now described.

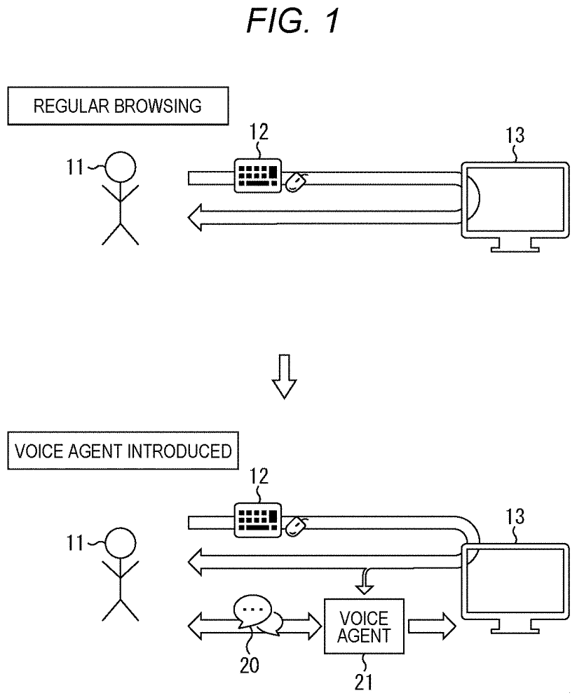

In normal browsing, as shown in the upper portion of FIG. 1, a user 11 operates an operation input device 12 including a keyboard, a mouse, and the like of a PC 13, and inputs a keyword, various operation instructions, and the like, to cause the browser to search for an article, so that a search result is presented, and browsing is realized.

However, in an operation to be performed by the user 11 operating the operation input device 12 to input a keyword and various operation instructions as shown in the upper portion of FIG. 1, a plurality of pieces of information needs to be input in a predetermined order, and the operation becomes more and more complicated as the amount of information to be input becomes larger.

Also, in the case of habitual operations, a plurality of similar operations needs to be repeatedly performed.

Therefore, as shown in the lower portion of FIG. 1, a technique has been suggested for receiving a voice input through a voice input device 20 or the like such as a microphone in addition to the operation input device 12, and inputting a voice in an interactive manner through a voice agent 21.

In this case, the user 11 can operate the operation input device 12, or interactively input information in the form of an utterance to the voice agent 21 via the voice input device 20.

As a result, in a case where the voice agent 21 is used, in an input operation using the operation input device 12, a plurality of necessary operations is turned into a macro, and the associated phrase is simply uttered, so that the plurality of necessary operation can be collectively executed, as shown in the lower portion of FIG. 1.

That is, a plurality of operations is turned into a macro, is associated with one phrase, and is stored. When the stored phrase is uttered, the plurality of operations as a macro is collectively executed.

To collectively execute a plurality of operations converted into a macro by an utterance of a predetermined phrase as above, a plurality of operations first needs to be converted into a macro, be associated with the predetermined phrase, and be registered. This process is a macro registration process.

<Macro Registration Process in Browsing>

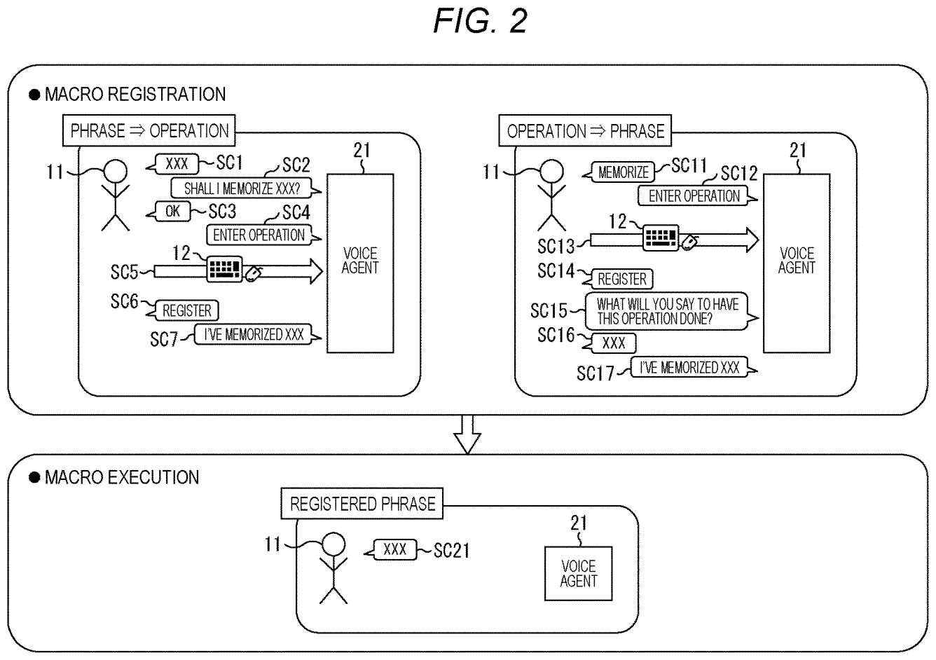

As shown in the upper portion of FIG. 2, there are two methods of this macro registration process.

Specifically, according to a first method of the macro registration process, when there is an utterance of a phrase not registered with a macro, a plurality of operations is associated with the phrase and is stored as a macro, as shown in the upper left portion of FIG. 2.

Further, according to a second method of the macro registration process, after converting a plurality of operations into a macro, when the phrase to be associated and stored is uttered, the plurality of operations associated with the phrase and turned into a macro is stored, as shown in the upper right portion of FIG. 2.

(First Method of the Macro Registration Process)

For example, according to the first method of the macro registration process, when the voice agent 21 detects a phrase “XXX” uttered by the user 11 via the voice input device 20 in a process SC1 as shown in the upper left portion of FIG. 2, the voice agent 21 determines whether or not the phrase is a macro-registered phrase.

In a case where the phrase is not a macro-registered phrase herein, the voice agent 21 in a process SC2 presents information such as “Shall I memorize XXX?” in the form of an image or a voice from the display, the speaker, or the like (not shown) of the PC 13, for example, and inquires whether or not a plurality of operations should be associated with the phrase “XXX” and be registered as a macro.

In response to this inquiry, when an utterance of a phrase “OK” by the user 11 is detected via the voice input device 20 in a process SC3, the voice agent 21 recognizes that there is a request for registration of a plurality of operations associated with “XXX” as a macro.

Next, in a process SC4, the voice agent 21 outputs “Enter operation” in the form of an image or a voice from the display, the speaker, or the like (not shown) of the PC 13, for example, to notify the user 11 that the operation input device 12 is now prepared for sequentially storing the contents of subsequent operations by the user 11.

In response to this, the operation input device 12 is operated by the user 11 in a process SC5, to input a plurality of operations to be registered as a macro, and the voice agent 21 sequentially stores the plurality of input operations.

After the plurality of operation inputs is completed, a phrase “register” is uttered by the user 11 in a process SC6, for example, so that the voice agent 21 recognizes that the plurality of operation inputs for macro registration has been completed.

In a process SC7, the voice agent 21 then associates the phrase “XXX” with the plurality of operations stored so far, registers the plurality of operations as a macro, and outputs “I've memorized XXX” in the form of an image or a voice from the display, the speaker, or the like (not shown.) of the PC 13, for example, to notify the user 11 that the plurality of operation inputs made so far has been converted into a macro, been associated the phrase “XXX”, and been registered.

In this series of processes, the plurality of operation inputs is associated with the phrase “XXX”, and is registered as a macro.

As a result, in processes thereafter, when the user 11 utters “XXX” as shown in the lower portion of FIG. 2, for example, the voice agent 21 recognizes that an instruction to execute the macro registered with “XXX” has been issued from the user, and then collectively executes the plurality of operation inputs registered with the associated phrase.

(Second Method of the Macro Registration Process)

According to the second method of the macro registration process, to register a plurality of operations as a macro in response to a predetermined phrase, the user 11 utters “memorize”, for example, as shown in the upper right portion of FIG. 2.

When detecting the phrase “memorize” uttered by the user 11 via the voice input device 20 in a process SC11, the voice agent 21 recognizes that a plurality of operations is to be registered as a macro in response to a predetermined phrase.

Therefore, in a process SC12, the voice agent 21 outputs “Enter operation” in the form of an image or a voice from the display, the speaker, or the like (not shown) of the PC 13, for example, to notify the user 11 that the operation input device 12 is now prepared for sequentially storing the contents of subsequent operations by the user 11.

In response to this, the operation input device 12 is operated by the user 11, to input the plurality of operations to be registered as a macro, and the voice agent then stores the plurality of operation inputs in a process SC13.

When completing the plurality of operation inputs to be registered as a macro, the user 11 utters a phrase “register”, to notify the voice agent 21 of the completion of the plurality of operation inputs.

As a result, the voice agent 21 detects the phrase “register” uttered by the user 11 via the voice input device 20 in a process SC14, and thus, recognizes the completion of the plurality of operation inputs to be registered as a macro.

Further, in a process SC15, the voice agent 21 outputs “What will you say to have this operation done?” in the form of an image or a voice from the display, the speaker, or the like (not shown) of the PC 13, for example, to inquire about the stored phrase associated with the plurality of operations to be registered as a macro, the phrase having been input by the user 11 operating the operation input device 12.

In response to this, the user 11 issues an instruction to register the plurality of operations stored so far as a macro associated with the phrase “XXX”, for example.

In a process SC16, when detecting the phrase “XXX” uttered by the user 11 via the voice input device 20, the voice agent 21 recognizes that there has been an instruction to register the plurality of operations stored so far as a macro associated with the phrase “XXX”.

In a process SC17, the voice agent 21 registers the plurality of operations stored so far as a macro associated with the phrase “XXX”. The voice agent 21 then outputs “I've memorized XXX” in the form of an image or a voice from the display, the speaker, or the like (not shown) of the PC 13, for example, to notify the user 11 that the plurality of operation inputs made so far has been converted into a macro, been associated the phrase “XXX”, and been registered.

In this series of processes, the plurality of operation inputs is associated with the phrase “XXX”, and is registered as a macro.

After such registration, when the user 11 utters the phrase “XXX”, the plurality of operations registered as the associated macro is also collectively executed, as shown in the lower portion of FIG. 2.

However, the macro registration process described above is based on the premise that the user has stored a plurality of operations according to both the first method and the second method, and therefore, only the stored plurality of operations can be associated with a phrase and be registered.

In other words, macro registration cannot be performed, unless the user recognizes and understands which operations he/she habitually performs among usual operations during normal browsing.

Further, even in a case where the user recognizes and understands his/her habitual operations and can perform macro registration, if the user fails to remember the phrase registered with the macro, the user might not be able to collectively execute the plurality of operations registered as a macro by uttering the phrase registered with the macro.

In the present disclosure, a plurality of habitual operations of the user is estimated as a cluster from an operation history, and the user is made to recognize the cluster. In this manner, a plurality of operations is collectively performed while the load on the user is reduced.

<Clustering of a User Operation History>

Therefore, in the present disclosure, a plurality of operations having high degrees of habituation is clustered on the basis of a user operation history, so that a habitual operation cluster is generated. This enables execution of a voice macro conversion process for each habitual operation cluster, a suggestion of macro conversion through a state suggestion notification, and a suggestion of collective execution of a habitual operation cluster including a keyword having a higher degree of coincidence with a keyword uttered by the user than a predetermined degree of coincidence.

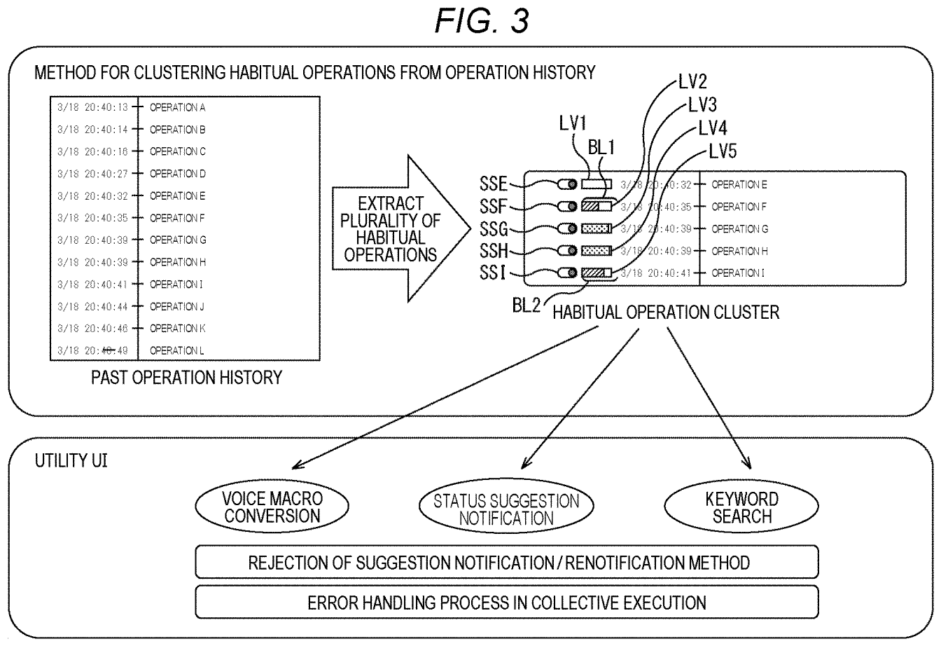

Before a description of an outline of the technology according to the present disclosure is started, an explanation is now made as to an example in which a user operation history is recorded and presented as shown in the upper left portion of FIG. 3, for example, and a habitual operation cluster as shown in the upper right portion of FIG. 3 is set for a plurality of operations having high degrees of operational habituation.

Note that, as shown from the top in the user operation history in the upper left portion of FIG. 3, an operation A was performed at 20:40:13 on March 18, an operation B was performed at 20:40:14 on March 18, an operation C was performed at 20:40:16 on March 18, and an operation D was performed at 20:40:27 on March 18.

The user operation history also indicates that an operation E was performed at 20:40:32 on March 18, an operation F was performed at 20:40:35 on March 18, an operation G was performed at 20:40:39 on March 18, an operation H was performed at 20:40:39 on March 18, and an operation I was performed at 20:40:41 on March 18.

The user operation history further indicates that an operation J was performed at 20:40:44 on March 18, an operation K was performed at 20:40:46 on March 18, and an operation was performed at 20:40:49 on March 18.

In the user operation history shown in the upper left portion of FIG. 3, a habituation score indicating a decree of habituation of each operation is calculated in each user operation history, which might be only in part of each user operation history though. A plurality of operations that are two or more operations having habituation scores higher than a predetermined value is clustered, and is set as a habitual operation cluster as shown in the upper right portion of FIG. 3.

The upper right portion of FIG. 3 is an example of a habitual operation cluster formed with a plurality of operations that are two or more operations having habituation scores higher than a predetermined value.

In the upper right portion of FIG. 3, the operations F to I have habituation scores higher than the predetermined value, and form a plurality of operations that are two or more operations. Accordingly, the operations F to are clustered as a habitual operation cluster.

In the habitual operation cluster, the operation E that is immediately before the plurality of operations that are the two or more operations having habituation scores higher than the predetermined value is also included in the habitual operation cluster.

Accordingly, in the upper right portion of FIG. 3, the operations E to I are included as the habitual operation cluster.

For the habitual operation cluster in the upper right portion of FIG. 3, score display fields LV1 to LV5 indicating the degrees of selected habituation scores are displayed on the left side of the respective operations F to L.

In the respective score display fields LV1 to LV5, a bar graph extending longer rightward in the drawing is displayed for a higher habituation score, and the displayed bar graphs are color-coded according to the habituation scores.

Specifically, the upper right portion of FIG. 3 shows that the habituation scores in the respective score display fields LV3 and LV4 of the operations G and H are the highest, and the habituation scores in the respective score display fields LV2 and LV5 of the operations F and I are the second highest.

Also, in the upper right portion of FIG. 3, the score display fields LV2 to LV5 of the operations having habituation scores higher than the predetermined threshold are sandwiched between brackets BL1 and BL2.

With the display of the brackets BL1 and BL2, it becomes possible to visually confirm that there are the operations F to I formed with a plurality of operations that are two or more operations having habituation scores higher than the predetermined value, and the operations F to I and the operation immediately before the operations F to I form a habitual operation cluster.

Further, for the operations E to I, switches SSE to SSI are provided on the left side of the respective score display fields LV1 to LV5. By operating the respective switches, the operations to be registered at the time of macro conversion can be selected.

In the present disclosure, a habitual operation cluster based on the user operation history is set as shown in the upper left portion and the upper right portion of FIG. 3. Accordingly, after a plurality of operations having high degrees of habituation is turned into a macro, the macro is associated with a phrase and is stored. In this manner, a macro registration process is performed, and voice macro conversion is realized (voice macro conversion shown in the lower portion of FIG. 3).

As a result, the user can cause collective execution of a plurality of operations having high degrees of habituation, by uttering the registered phrase.

Also, in the present disclosure, as shown in the lower portion of FIG. 3, the habitual operation cluster formed with the plurality of operations having habituation scores higher than the predetermined value is presented, so that the state of habituation of a plurality of consecutive operations is presented to the user, and a state suggestion notification for determining whether or not to turn the operations into a macro is presented to the user (state suggestion notification in the lower portion of FIG. 3).

As a result, the user can be conscious of the plurality of his/her habitual consecutive operations, and can register the plurality of consecutive operations having high habituation scores as a macro at the time when the user recognizes that the habituation scores have increased to a certain degree.

Further, in the present disclosure, the habitual operation cluster including a keyword uttered by the user is detected and presented, as shown in the upper right portion in the lower portion of FIG. 3 (keyword search in the lower portion of FIG. 3).

As a result, even if the user fails to remember the phrase associated with the habitual operation cluster registered as a macro, the habitual operation cluster detected on the basis of a related phrase is presented, and collective execution thereof is proposed, so that the habitual operation cluster registered as a macro can be utilized.

In addition to the above, in the present disclosure, in a case where macro registration or collective execution is suggested on the basis of a state suggestion notification, a process to be performed in a case where the macro registration or the collective is rejected by the user, and a method for resending a state suggestion notification are also suggested, as shown in the lower portion of FIG. 3 (distance of suggestion notification/renotification method).

Further, in the present disclosure, an error handling process to be performed in a case where an error occurs due to a plurality of consecutive operations associated with a phrase and registered by the macro registration process is also suggested, as shown in the lower portion of FIG. 3 (error handling process in collective execution).

<<2. Preferred Embodiment>>

Next, a preferred embodiment of the present disclosure is described.

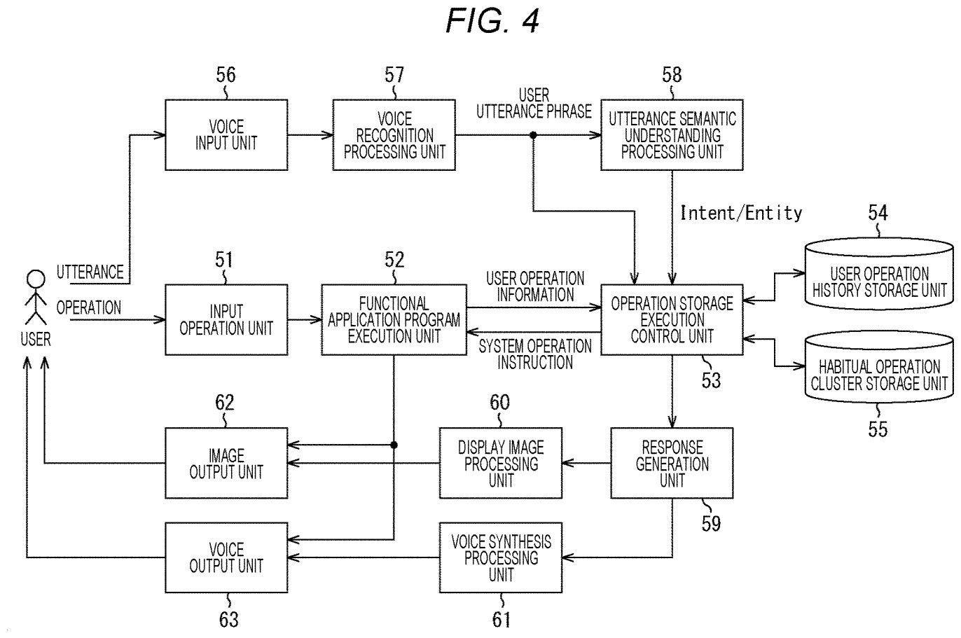

FIG. 4 shows a preferred embodiment of an information processing apparatus to which the technology of the present disclosure is applied.

An information processing apparatus 41 in FIG. 4 includes an input operation unit 51, a functional application program execution unit 52, an operation storage execution control unit 53, a user operation history storage unit 54, a habitual operation cluster storage unit 55, a voice input unit 56, a voice recognition processing unit 57, an utterance semantic understanding processing unit 58, a response generation unit 59, a display image processing unit 60, a voice synthesis processing unit 61, an image output unit 62, and a voice output unit 63.

The input operation unit 51 includes a keyboard, a mouse, a touch panel (an input operation device), or the like, receives a user's operation input, generates an operation signal corresponding to the received operation input, and outputs the operation signal to the functional application program execution unit 52.

On the basis of the operation signal supplied from the input operation unit 51 and a system operation instruction supplied from the operation storage execution control unit 53, the functional application program execution unit 52 executes an application program for realizing various functions such as presenting content supplied from a web browser or an accessed site, for example.

More specifically, the functional application program execution unit 52 realizes functions of general operations of a game machine (a controller), a television set (a remote controller), a music/video player, a smartphone/tablet, a personal computer (PC), or the like, and of an entire device that has a plurality of operational functions, such as an augmented reality (AR)/virtual reality (VR) device, a home appliance, a camera/camcorder, or a business system.

Note that, in the description below in this specification, an example case where the functional application program execution unit 52 functions as a web browser will be described. However, as a matter of course, the functions of some other device may be realized.

The functional application program execution unit 52 also outputs an image including a moving image and a still image that constitute an execution result based on the operation signal supplied from the input operation unit 51 and the system operation instruction supplied from the operation storage execution control unit 53, to the image output unit 62.

The functional application program execution unit 52 further outputs a sound forming an execution result based on the operation signal supplied from the input operation unit 51 and the system operation instruction supplied from the operation storage execution control unit 53, to the voice output unit 63.

The voice input unit 56 includes a microphone or the like, receives an input of an uttered phrase including a voice emitted by the user, generates a corresponding voice signal, and outputs the generated voice signal to the voice recognition processing unit 57.

The voice recognition processing unit 57 performs a voice recognition process (automatic speech recognition (ASR)) on the basis of the voice signal supplied from the voice input unit 56, and outputs a voice recognition result including a text to the utterance semantic understanding processing unit 58 and the operation storage execution control unit 53.

The utterance semantic understanding processing unit 58 performs an utterance semantic understanding process (natural language understanding (NLU)) on the voice recognition result including the text supplied from the voice recognition processing unit 57, and estimates an utterance intention (Intent) of the user's uttered phrase and attribute information (Entity) to be an utterance target.

The utterance semantic understanding processing unit 58 outputs the utterance intention (Intent) of the user's uttered phrase and the utterance target attribute information (Entity), which are the estimation result, to the operation storage execution control unit 53.

The operation storage execution control unit 53 adds a time stamp to user operation information supplied from the functional application program execution unit 52, and stores and accumulates the user operation information as a user operation history in the user operation history storage unit 54.

The operation storage execution control unit 53 may cause the display image processing unit 60 to generate a specific history management screen or the like via the response generation unit 59, and may cause the image output unit 62 to display the user operation history stored in the user operation history storage unit 54 as the past user operation history described with reference to the upper left portion of FIG. 3 in chronological order so that the user can view the user operation history, for example.

The use operation information is information corresponding to the contents of an operation of the input operation unit 51. For example, in a case where the functions to be realized by the functional application program execution unit 52 are those of a web browser, the user operation information is information corresponding to operations such as clicking, form inputting, form submission, and site transition.

Further, the user operation information also includes information about a user interface (UI) component such as a link/form to be operated and information about the uniform resource locator (URL) of the transition destination (+the title of the site).

Note that the user operation information may include context information that is information about the URL of the site (+the title of the site) at a time when an operation through the input operation unit 51 is performed.

On the basis of the past user operation history accumulated in the user operation history storage unit 54, the operation storage execution control unit 53 estimates a plurality of user's habitual operations (combined operations) as a habitual operation cluster, and stores the habitual operation cluster into the habitual operation cluster storage unit 55.

On the basis of the user's uttered phrase, the utterance intention (Intent), the attribute information (Entity) of the utterance target, and the user operation information, the operation storage execution control unit 53 reads the corresponding habitual operation cluster from the habitual operation cluster storage unit 55.

The operation storage execution control unit 53 then generates a system operation instruction by turning the read habitual operation cluster into a voice macro, or conducting collective execution or macro execution of a plurality of operations based on the habitual operation cluster, and outputs the system operation instruction for the functional application program execution unit 52 to execute.

The functional application program execution unit 52 collectively executes the plurality of operations constituting the habitual operation cluster each in chronological order, on the basis of the system operation instruction in response to the habitual operation cluster.

To issue a suggestion notification and a confirmation dialogue regarding the voice macro conversion and the execution of the habitual operation cluster to the user, the operation storage execution control unit 53 also controls the response generation unit 59 to generate and output a display image and a voice for the suggestion notification and the confirmation dialogue regarding the voice macro conversion and the collective execution of the habitual operation cluster.

The response generation unit 59 causes the display image processing unit 60 to generate a display image for the suggestion notification and the confirmation dialogue regarding the voice macro conversion and the execution of the habitual operation cluster, and causes the voice synthesis processing unit 61 to generate a voice for a similar suggestion notification and a confirmation dialogue.

The display image processing unit 60 outputs, to the image output unit 62, the generated display image for the suggestion notification and the confirmation dialogue regarding the voice macro conversion and the execution of the habitual operation cluster, and causes the image output unit 62 to display the display image.

The voice synthesis processing unit 61 causes the voice output unit 63 to output a voice for the suggestion notification and the confirmation dialogue regarding the voice macro conversion and the execution of the habitual operation cluster.

The image output unit 62 is formed with a display, a projector, or the like, and is controlled by the functional application program execution unit 52 to display a display image as a result of processing performed by the functional application program execution unit 52.

The image output unit 62 also displays the display image supplied from the display image processing unit 60.

The voice output unit 63 is formed with a speaker, headphones, or the like, and is controlled by the functional application program execution unit 52 to output a voice as a result of processing performed by the functional application program execution unit 52.

The voice output unit 63 also outputs the voice supplied from the voice synthesis processing unit 61.

<Habituation Scores Corresponding to User Operation Information>

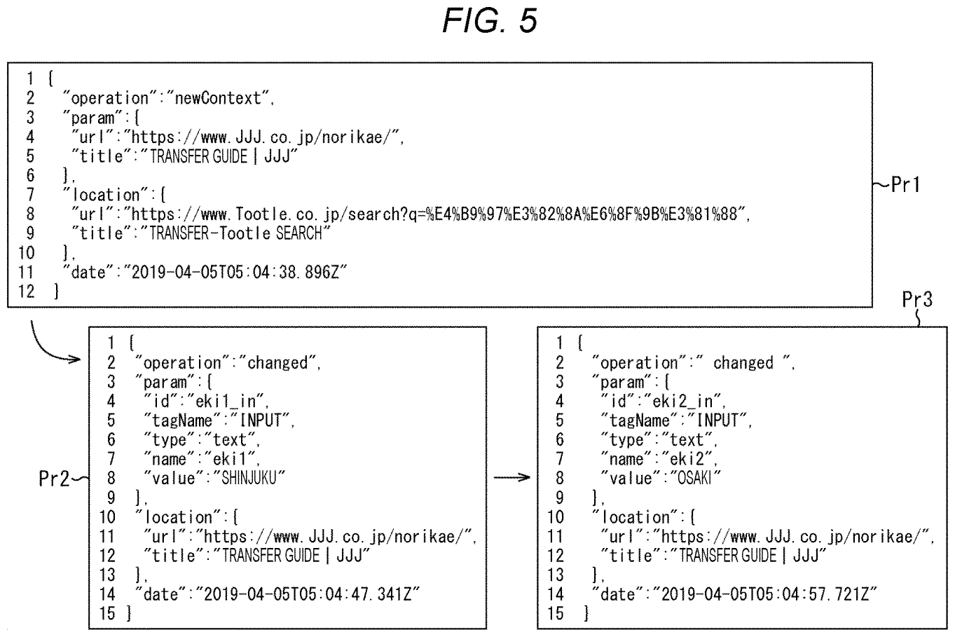

Next, the habituation scores corresponding to the user operation information are be described with reference to FIG. 5.

The user operation information is accumulated as information such as user operation information Pr1 to Pr3 shown in FIG. 5, for example.

Specifically, the user operation information Pr1 in FIG. 5 is formed with descriptions in lines 1 to 12. Lines 2 to 6 show that an operation to display the transfer guide homepage having the URL represented by “url”: “https://www.JJJ.co.jp/norikae/” and “title”: “TRANSFER GUIDE|JJJ” has been performed.

Further, lines 7 to 10 of the user operation information Pr1 in FIG. 5 show that information stored at the position represented by “url”: “https://www.Tootle.co.jp/search?q=%E4%B9%97%E3%82%8A%E6%8F%9B%E3%81%88” and “title”: “TRANSFER—Tootle SEARCH” in the network has been read and is displayed.

Furthermore, line 11 of the user operation information Pr1 in FIG. 5 shows that an operation according to user operation information ST1 has been performed at 05:04:38.896 on Apr. 5, 2019, as indicated by “date”: “2019-04-05T05:04:38.896Z”.

Information about an operation to input the station name of the departure station to the displayed home page of the transfer guide in response to the operation according to the user operation information Pr1 is then described in the user operation information Pr2.

Specifically, the uses operation information Pr2 in FIG. 5 is formed with descriptions in lines 1 to 15, and lines 2 to 9 show that an operation to input “SHINJUKU” as the departure station has been performed.

Further, lines 10 to 13 of the user operation information Pr2 in FIG. 5 show that the information stored at the position represented by “url”: “https://www.JJJ.co.jp/norikae/” and “title”: “TRANSFER GUIDE|JJJ” in the network has been read and is displayed.

Furthermore, line 14 of the user operation information Pr2 in FIG. 5 shows that an operation according to user operation information ST2 has been performed at 05:04:46.341 on Apr. 5, 2019, as indicated by “date”: “2019-04-05T05:04:46.341Z”.

Also, information about an operation to input the station name of the destination station to the displayed home page of the transfer guide in response to the operation according to the user operation information Pr1 is described in the user operation information Pr3.

Specifically, the user operation information Pr3 in FIG. 5 is formed with descriptions in lines 1 to 15, and lines 2 to 9 show that an operation to input “OSAKI” as the destination station has been performed.

Further, lines 10 to 13 of the user operation information Pr3 in FIG. 5 show that the information stored at the position represented by “url”: “https://www.JJJ.co.jp/norikae/” and “title”: “TRANSFER GUIDE|JJJ” in the network has been read and is displayed.

Furthermore, line 14 of the user operation information Pr3 in FIG. 5 shows that an operation according to user operation information ST3 has been performed at 05:04:57.721 on Apr. 5, 2019, as indicated by “date”: “2019-04-05T05:0457.721Z.”.

That is, the user operation information Pr1 to Pr3 in FIG. 5 is sequentially accumulated in the user operation history storage unit 54 in chronological order.

When the user operation information is supplied, the operation storage execution control unit 53 sequentially accumulates the user operation information in the user operation history storage unit 54, and forms a user operation history.

When the user operation information is supplied, the operation storage execution control unit 53 also calculates habituation scores using the user operation history accumulated in the user operation history storage unit 54, accumulates the habituation scores associated with the user operation history, and sequentially updates the habituation scores.

Here, a habituation score is a value indicating the tendency of habituation with respect to the past user operation history of the operation n corresponding to the nth operation in the user operation history, for example, and is a score defined by Equation (1) shown below.

Sₙ=3/(1/Tₙ+1/Fₙ+1/Pₙ) (1)

Here, Sₙ represents the habituation score of the operation n, Tₙ represents the time interval from the previous operation n−1 to the operation n, Fₙ represents the number of transitions from the operation n−1 to the operation n, and Pₙ represents the probability of a transition from the operation n−1 to the operation n.

That is, the habituation score of the operation n is the harmonic average of the time interval Tₙ from the previous operation n−1 to the operation n, the number Fₙ of transitions from the operation n−1 to the operation n, and the probability Pₙ of a transition from the operation n−1 to the operation n.

Further, the time interval Tₙ from the previous operation n−1 to the operation n is defined by Equation (2) shown below.

TₙHₜ/((tₙ−tₙ₋₁₎)) +Hₜ) (2)

Here, Tₙ represents the time interval from the previous operation n−1 to the operation n, tₙ represents the time when the operation n was performed, t₍ₙ₋₁₎ is the time when the operation n−1 was performed, and Hₜ is a normalization constant. The normalization constant Hₜ may be 30 seconds, for example.

Note that the normalization constant Hₜ can be changed by the user. Specifically, the influence of a time difference on the time interval Tₙ varies with a normalization constant H_{c}. For this reason, a person who is accustomed to the operation and a person who is not accustomed to the operation may be determined from the average values of the use times and the operation time intervals of the device, for example. The normalization constant Hₜ may be made smaller for the person who is accustomed to the operation, and the normalization constant Hₜ may be made greater for the person who is not accustomed to the operation.

Further, the number Fₙ of transitions from the operation n−1 to the operation n is defined by Equation (3) shown below.

Fₙ=1−H_{c}/(Cₜₙ+H_{c}) (3)

Here, Cₜₙ represents the number of times a transition has been made from the same operation as the operation n−1 to the same operation as the operation n in the past in the user operation history, and H_{c} represents the normalization constant. The normalization constant H_{c} is three times, for example.

Meanwhile, the probability Pₙ of a transition from the operation n−1 to the operation n is defined by Equation (4) shown below.

Pₙ=Cₜₙ/C₍ₙ₋₁₎ (4)

Here, C₍ₙ₋₁₎ represents the number of times the same operation as the operation n−1 has been performed in the past in the user operation history.

Specifically, where the operation n is performed in a shorter time than the previous operation n−1, and the number Fₙ of transitions and the probability Pₙ of a transition are higher, the operation n is determined to be more habitually performed, and the habituation score Sₙ of the operation n is higher.

When the user operation information is supplied and is newly accumulated in the user operation history in the user operation history storage unit 54, the operation storage execution control unit 53 sequentially calculates the habituation scores Sₙ described above, stores the calculated scores with the respective operations accumulated in the user operation history, and updates the scores as necessary.

More specifically, when there are two or more operations having habituation scores Sₙ higher than a habituation threshold Sₜₕ (0.5, for example) in the time series in the operation history, the operation storage execution control unit 53 sets a candidate habitual operation cluster that is from the operation immediately before the operation whose habituation score Sₙ becomes higher than the habituation threshold Sₜₕ first to the operation whose habituation score Sₙ becomes higher than the habituation threshold Sₜₕ last.

Next, in a case where the habitual operation clusters stored in the habitual operation cluster storage unit 55 include no habitual operation clusters having the same sequence as the candidate habitual operation cluster (or having the same order of operations as that in the habitual operation clusters), and include no habitual operation clusters having the same operations but having a different order from the candidate habitual operation cluster, the operation storage execution control unit 53 stores the candidate habitual operation cluster as a new habitual operation cluster into the habitual operation cluster storage unit 55.

Further, in a case where the habitual operation clusters stored in the habitual operation cluster storage unit 55 include a habitual operation cluster having the same operations as the candidate habitual operation cluster but having a different order of operations from that in the candidate habitual operation cluster, the operation storage execution control unit 53 compares the two habitual operation clusters, which are the candidate habitual operation cluster and the habitual operation cluster, integrates the two habitual operation clusters after detecting order-variable operations in the habitual operation cluster, and updates and stores the integrated habitual operation cluster as a habitual operation cluster in the habitual operation cluster storage unit 55.

<Habitual Operation Clustering Process>

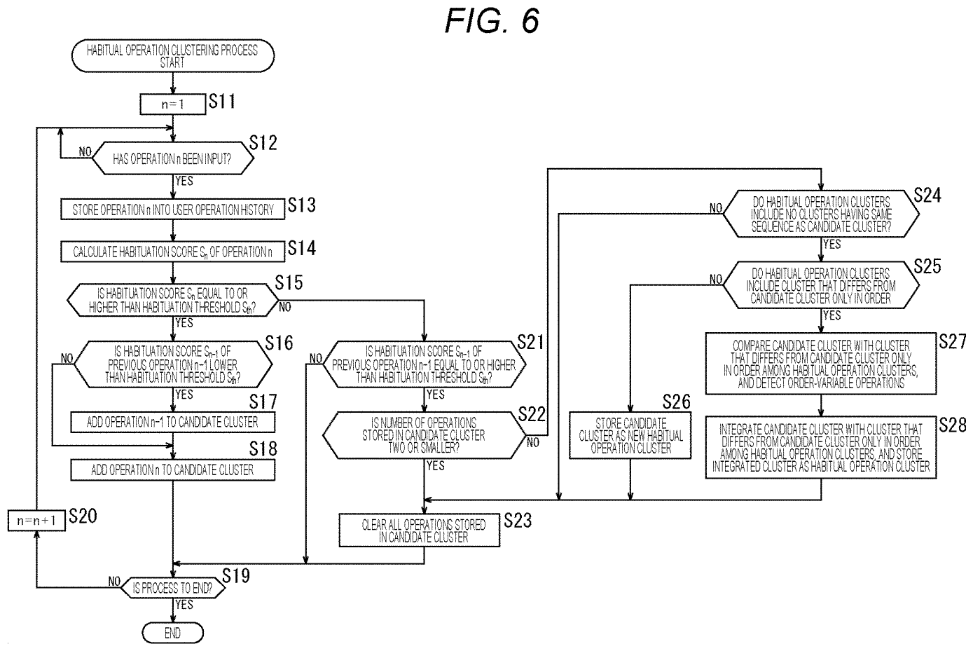

Next, a habitual operation clustering process is described with reference to a flowchart shown in FIG. 6.

In step S11, the operation storage execution control unit 53 initializes a counter n that counts operations to 1.

In step S12, the operation storage execution control unit 53 determines whether or not the user operation information regarding the operation n has been supplied, and repeats a similar process until the user operation information regarding the operation n is supplied.

If the user operation information regarding the operation n has been supplied in step S12, the process then moves on to step S13.

In step S13, the operation storage execution control unit 53 gives a time stamp to the user operation information regarding the operation n, and stores the user operation information as a user operation history in the user operation history storage unit 54.

In step S14, the operation storage execution control unit 53 calculates the habituation score S, of the operation n by the calculation described with. reference to Equations (1) to (4) shown above, on the basis of the user operation history stored in the user operation history storage unit 54.

In step S15, the operation storage execution control unit 53 determines whether or not the habituation score Sₙ corresponding to the operation n is higher than the habituation threshold Sₜₕ.

If the habituation score Sₙ corresponding to the operation n is determined to be higher than the habituation threshold Sₜₕ in step S15, the operation n is regarded as a highly habitual operation, and the process moves on to step S16.

In step S16, the operation storage execution control unit 53 determines whether or not the habituation score Sₙ₋₁ of the operation n−1 immediately before the operation n is lower than the habituation threshold Sₜₕ.

If the habituation score Sₙ₋₁ of the operation n−1 immediately before the operation n is determined to be lower than the habituation threshold Sₜₕ in step S16, the process moves on to step S17.

In step S17, the operation storage execution control unit 53 adds the operation n−1 to the candidate habitual operation cluster.

In step S18, the operation storage execution control unit 53 adds the operation n to the candidate habitual operation cluster.

In step S19, the operation storage execution control unit 53 determines whether or not an instruction to end the process has been issued. If the end instruction has been issued, the process comes to an end.

If the end instruction has not been issued yet in step S19, on the other hand, the process moves on to step S20.

In step S20, the operation storage execution control unit 53 increments the counter n by 1, and the process then returns to step S12.

Specifically, when there is a plurality of operations n having higher habituation scores Sₙ than the habituation threshold Sₜₕ before an instruction to end the habitual operation clustering process is issued, the processes in steps S11 to S20 are repeated, the counter n is incremented by 1 at a time, and an operation continues to be added to the candidate habitual operation cluster.

Further, the top operation among the operations constituting a habitual operation cluster is the operation immediately before the operation whose habituation score Sₙ exceeds the habituation threshold Sₜₕ first. Therefore, when the habituation score Sₙ₋₁ of the operation n−1 immediately before the operation n is determined to be lower than the habituation threshold Sₜₕ in the process in step S16, the operation n−1 immediately before the operation n is included as the top operation of the candidate habitual operation cluster in the process in step S17.

Accordingly, of the operations constituting the candidate habitual operation cluster, the habituation scores Sₙ of the operations other than the top operation are higher than the habituation threshold Sₜₕ. Therefore, the habituation score Sₙ is not lower than the habituation threshold Sₜₕ step S16, and the process in step S17 is skipped.

Further, if the habituation score Sₙ corresponding to the operation n is determined not to be higher than the habituation threshold Sₜₕ in step S15, the operation n is not regarded as a highly habitual operation, and the process moves on to step S21.

In step S21, the operation storage execution control unit 53 determines whether or not the habituation score Sₙ₋₁ of the operation n−1 immediately before the operation n is higher than the habituation threshold Sₜₕ.

If the habituation score Sₙ₋₁ of the operation n−1 is determined to be higher than the habituation threshold Sₜₕ in step S21, the operations up to the most recent one are regarded as part of the operations included in the candidate habitual operation cluster, and the process moves on to step S22.

Note that, if the habituation score Sₙ₋₁ of the operation n−1 is determined to be lower than the habituation threshold Sₜₕ in step S21, the most recent operation is regarded as an operation not included in the candidate habitual operation cluster, and the process moves on to step S19.

In step S22, the operation storage execution control unit 53 determines whether or not the number of operations included in the candidate habitual operation cluster formed with the operations up to the most recent operation is two or smaller.

Since a habitual operation cluster should include three or more operations, if the number of operations included is the candidate habitual operation cluster formed with the operations up to the most recent operation is determined to be two or smaller in step S22, it is determined that a habitual operation cluster is not formed, and the process moves on to step S23.

In step S23, the operation storage execution control unit 53 then clears the information regarding the operations stored as the candidate habitual operation cluster, and the process moves on to step S19.

If the number of operations included in the candidate habitual operation cluster formed with the operations up to the most recent operation is determined not to be two or smaller in step S22, on the other hand, it is determined that the candidate habitual operation cluster includes three or more operations, and the process moves on to step S24.

In step S24, the operation storage execution control unit 53 determines whether or not the habitual operation clusters already registered and stored in the habitual operation cluster storage unit 55 include a cluster that includes the same operations as those included in the candidate habitual operation cluster currently being processed, and has completely the same sequence (the same order) as that in the candidate habitual operation cluster currently being processed.

Specifically, in a case where the candidate habitual operation cluster is completely the same as a habitual operation cluster already registered in the habitual operation cluster storage unit 55, there is no need to newly register the candidate habitual operation cluster. Therefore, a check is made to determine whether or not there is an already registered habitual operation cluster that is completely the same as the candidate habitual operation cluster.

In step S24, if the habitual operation clusters already registered and stored in the habitual operation cluster storage unit 55 include one that is completely the same as the candidate habitual operation cluster currently being processed, the process moves on to step S23.

Specifically, in this case, the habitual operation clusters already registered and stored in the habitual operation cluster storage unit 55 include one that is completely the same as the candidate habitual operation cluster currently being processed. Therefore, the process moves on to step S23, and the information regarding the candidate habitual operation cluster currently being processed is cleared.

In step S24, if the habitual operation clusters already registered and stored in the habitual operation cluster storage unit 55 do not include any one that is completely the same as the candidate habitual operation cluster currently being processed, on the other hand, the process moves on to step S25.

In step S25, the operation storage execution control unit 53 determines whether or not the habitual operation clusters already registered and stored in the habitual operation cluster storage unit 55 include one that includes the same operations as those included in the candidate habitual operation cluster currently being processed but does not have the same order of operations as that in the candidate habitual operation cluster, or one that is the same as the candidate habitual operation cluster in the operations but differs only in the order of the operations from the candidate habitual operation cluster.

In step S25, if the habitual operation clusters already registered and stored in the habitual operation cluster storage unit 55 do not include any one that includes the same operations as those included in the candidate habitual operation cluster currently being processed but differs only in the order of the operations from the candidate habitual operation cluster, the process moves on to step S26.

In step S26, the operation storage execution control unit 53 registers the candidate habitual operation cluster currently being processed as a new habitual operation cluster in the habitual operation cluster storage unit 55, without a change in the order of the operations in the candidate habitual operation cluster.

Specifically, the habitual operation clusters already registered and stored in the habitual operation cluster storage unit 55 do not include any one that includes the same operations as those included in the candidate habitual operation cluster currently being processed and differs only in the order of the operations from the candidate habitual operation cluster. Accordingly, the candidate habitual operation cluster currently being processed is regarded as a new habitual operation cluster formed with a plurality of operations, and is registered in the habitual operation cluster storage unit 55.

In step S25, if the habitual operation clusters already registered and stored in the habitual operation cluster storage unit 55 includes one that includes the same operations as those included in the candidate habitual operation cluster currently being processed but does not have the same order of the operations as that in the candidate habitual operation cluster, or one that differs only in the order of the operations from the candidate habitual operation cluster, the process moves on to step S27.

In step S27, the operation storage execution control unit 53 compares the candidate habitual operation cluster currently being processed with the registered habitual operation cluster that includes the same operations as those included in the candidate habitual operation cluster currently being processed but differs in the order of the operations from the candidate habitual operation cluster. By doing so, the operation storage execution control unit 53 detects order-variable operations. Hereinafter, this will be also referred to as detection of order-variable operations.

In step S28, the operation storage execution control unit 53 integrates the candidate habitual operation cluster currently being processed with the registered habitual operation cluster that includes the same operations as those included in the candidate habitual operation cluster currently being processed but differs in the order of the operations from the candidate habitual operation cluster, together with information about the variable range of the order-variable operations. By doing so, the operation storage execution control unit 53 generates one habitual operation cluster, and registers the one habitual operation cluster in the habitual operation cluster storage unit 55.

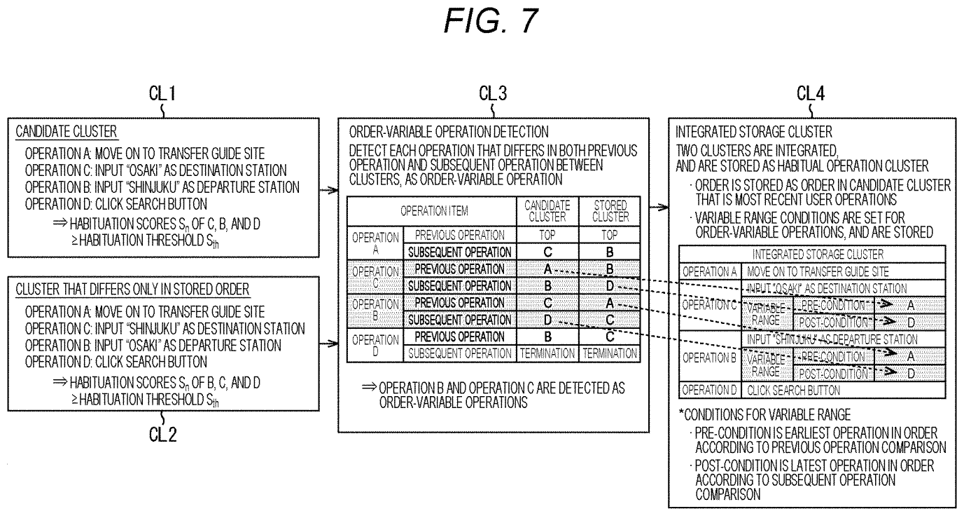

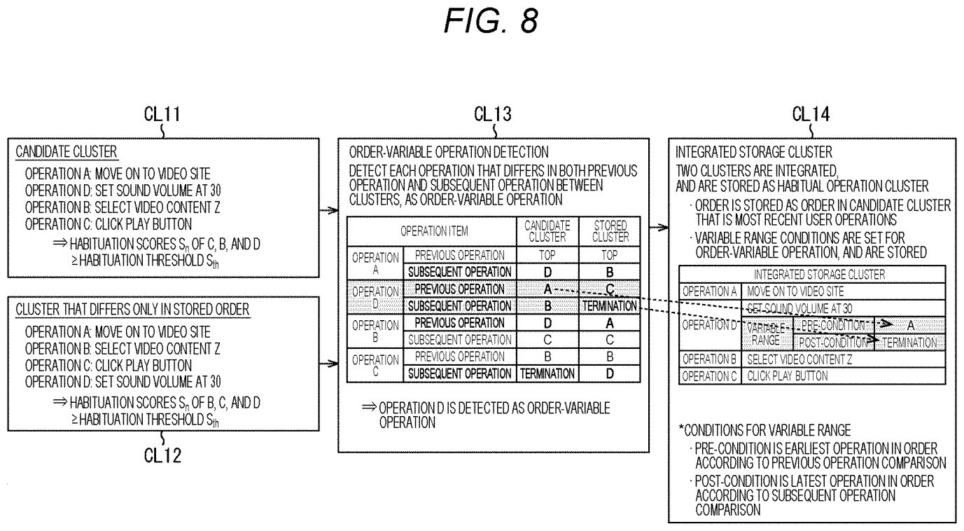

Note that the comparison and integration of habitual operation clusters will be described later in detail, with reference to FIGS. 7 and 8.

When a new operation n is received in the above process, the habituation scores Sₙ are sequentially obtained, and are compared with the habituation threshold Sₜₕ, so that a candidate habitual operation cluster is set.

Also, the operations constituting a candidate habitual operation cluster are compared with the operations constituting an already registered habitual operation cluster, so that a candidate habitual operation cluster including completely different operations from those included in a registered habitual operation cluster is registered as a new habitual operation cluster.

Further, the operations constituting a candidate habitual operation cluster are compared with the operations constituting an already registered habitual operation cluster, so that a candidate habitual operation cluster that differs only in the order of the operations from an already registered habitual operation cluster is integrated with the registered habitual operation cluster to generate one habitual operation cluster, and the one habitual operation cluster is registered in the habitual operation cluster storage unit 55.

As a result, a plurality of operations having high habituation scores and high degrees of habituation as user's operations can be sequentially registered as a habitual operation cluster.

Note that, as for registered habitual operation clusters, there is a possibility that the degrees of habituation will become different from actual ones over time. Therefore, habitual operation clusters that remain registered over a predetermined period of time may be deleted.

<Comparison and Integration (1) of Habitual Operation Clusters>

Referring now to FIG. 7, the comparison and integration of habitual operation clusters is described.

In the case described herein, a candidate habitual operation cluster CL1 and a habitual operation cluster CL2 that differs only in the stored order from the candidate habitual operation cluster CL1 as shown in FIG. 7 exist as a candidate habitual operation cluster and a registered habitual operation cluster, for example.

Here, the candidate habitual operation cluster CL1 in FIG. 7 includes the four operations of operations A to D, and the habitual operation cluster CL2 also includes the four operations of operations A to D.

Here, in the candidate habitual operation cluster CL1, the operations are performed in the order of the operation A, the operation C, the operation B, and the operation D. In the registered habitual operation cluster, on the other hand, the operations are performed in the order of the operation A, the operation B, the operation C, and the operation D.

Note that the operation A is an operation to move on to a transfer guide site, the operation C is an operation to input “OSAKI” as the destination station, the operation B is an operation to input “SHINJUKU” as the departure station, and the operation D is an operation to click a search button.

Further, in both the candidate habitual operation cluster CL1 and the habitual operation cluster CL2, each of the habituation scores Sₙ of the operation B, the operation C, and the operation D is higher than the habituation threshold Sₜₕ.

That is, when the operations in the candidate habitual operation cluster CL1 are compared with the operations in the habitual operation cluster CL2, the operation B that is an operation to input the departure station, and the operation C that is an operation to input the destination station are switched in order.

However, although the order of the operation B to input the departure station and the operation C to input the destination station is different, the same transfer guide is displayed as a result of the final operation D. Accordingly, the candidate habitual operation cluster CL1 and the habitual operation cluster CL2 are substantially the same, and are preferably integrated and handled as the same habitual operation cluster.

Therefore, as shown in a comparison result CL3 in FIG. 7, the operation storage execution control unit 53 compares the operations before and after each of the operations constituting the candidate habitual operation cluster CL1 and the habitual operation cluster CL2.

Specifically, as for the operation A in the candidate habitual operation cluster CL1, the operation A, which is the top operation, has no preceding operations (shown as “TOP” in the drawing), and the subsequent operation is the operation C.

As for the operation C in the candidate habitual operation cluster CL1, the previous operation is the operation A, and the subsequent operation is the operation B.

As for the operation B in the candidate habitual operation cluster CL1, the previous operation is the operation C, and the subsequent operation is the operation D.

Further, as for the operation D in the candidate habitual operation cluster CL1, the previous operation is the operation B, and there are no subsequent operations, because the operation D is the termination operation (the subsequent operation is shown as “END” in the drawing).

Meanwhile, as for the operation A in the habitual operation cluster CL2, the operation A, which is the top operation, has no preceding operations (shown as “TOP” in the drawing), and the subsequent operation is the operation B.

As for the operation C in the habitual operation cluster CL2, the previous operation is the operation B, and the subsequent operation is the operation D.

As for the operation B in the habitual operation cluster CL2, the previous operation is the operation A, and the subsequent operation is the operation C.

Further, as for the operation D in the habitual operation cluster CL2, the previous operation is the operation C, and there are no subsequent operations, because the operation D is the termination operation (the subsequent operation is shown as “END” in the drawing).

Here, on the basis of the comparison result CL3 in FIG. 7, the operation storage execution control unit 53 detects order-variable operations that are the operations that differ in both the previous operation and the subsequent operation between the candidate habitual operation cluster CL1 and the habitual operation cluster CL2.

That is, in the comparison result CL3 in FIG. 7, the operation B and the operation C among the operations differ in both the previous operation and the subsequent operation, and therefore, are detected as order-variable operations.

Note that the operation A is the top operation in both the candidate habitual operation cluster CL1 and the habitual operation cluster CL2, and the operation D is The termination operation in both the candidate habitual operation cluster CL1 and the habitual operation cluster CL2. Accordingly, neither the operation A. nor the operation D is an order-variable operation.

Therefore, on the basis of the detected order-variable operations, the operation storage execution control unit 53 generates an integrated storage cluster CL4 in which the candidate habitual operation cluster CL1 and the habitual operation cluster CL2 are integrated as shown in FIG. 7, and registers the integrated storage cluster CL4 in the habitual operation cluster storage unit 55.

Specifically, in the integrated storage cluster CL4 in FIG. 7, it is recorded that, of the operations from the left, the operation A is an operation to move on to a transfer guide site, the operation C is an operation to input “OSAKI” as the destination station, the operation B is an operation to input “SHINJUKU” as the departure station, and the operation D is an operation to click the search button.

Further, of these operations, the operation C and the operation B are detected as order-variable operations, and therefore, a variable range is set.

The variable range includes a pre-condition and a post-condition. The top operation that can be the previous operation of an operation in order is set as the pre-condition, and the termination operation that can be the subsequent operation of an operation in order is set as the post-condition.

In the integrated storage cluster CL4 in FIG. 7, since the operation C and the operation B have been detected as order-variable operations, the operation C and the operation B each have the operation A as the pre-condition and the operation D as the post-condition, as indicated by arrows in the drawing.

That is, with the information in the integrated storage cluster CL4 in FIG. 7, it is recorded that the order can be changed, as long as both the operation C and the operation B are in the range between the operation A and the operation D, or in the variable range.

Note that the integrated storage, cluster CL4 shown in FIG. 7 is an example in which registration is performed in the order of operations performed most recently. However, registration may be performed in the order of operations in an already registered habitual operation cluster.

<Comparison and Integration (2) of Habitual Operation Clusters>

In the case described above, there are two operations that differ in the previous operation and the subsequent operation in the comparison between a candidate habitual operation cluster and a registered habitual operation cluster, and a variable range is set for each operation.

However, the number of order-variable operations may be any number other than two, and, for example, may be one.

In the example case described herein, a candidate habitual operation cluster CL11 and a habitual operation cluster CL12 that differs only in stored order from the candidate habitual operation cluster CL11 as shown in FIG. 8 exist as a candidate habitual operation cluster and a registered habitual operation cluster, for example.

Here, the candidate habitual operation cluster CL11 in FIG. 8 includes the four operations of operations A to D, and the habitual operation cluster CL12 also includes the four operations of operations A to D.

Here, in the candidate habitual operation cluster CL11, the operations are performed in the order of the operation A, the operation D, the operation C, and the operation B. In the registered habitual operation cluster, on the other hand, the operations are performed in the order of the operation A, the operation B, the operation C, and the operation D.

Note that the operation A is an operation to move on to a video site, the operation D is an operation to set the sound volume at 30, the operation B is an operation to select video content Z, and the operation C is an operation to click the play button.

Further, in both the candidate habitual operation cluster CL11 and the habitual operation cluster CL12, each of the habituation scores Sₙ of the operation B, the operation C, and the operation D is higher than the habituation threshold Sₜₕ.

That is, when the operations in the candidate habitual operation cluster CL11 are compared with the operations in the habitual operation cluster CL12, the operation D that is an operation to set the sound volume at 30 is an order-variable operation between the operation A and the operation B.

However, although the order of the operation D to set the sound volume at 30 is different, the sound volume is set at 30. Accordingly, the candidate habitual operation cluster CL11 and the habitual operation cluster CL12 are substantially the same, and are preferably integrated and handled as the same habitual operation cluster.

Therefore, as shown in a comparison result CL13 in FIG. 8, the operation storage execution control unit 53 compares the operations before and after each of the operations constituting the candidate habitual operation cluster CL11 and the habitual operation cluster CL12.

Specifically, as for the operation A in the candidate habitual operation cluster CL11, the operation A, which is the top operation, has no preceding operations (shown as “TOP” in the drawing), and the subsequent operation is the operation D.

As for the operation D in the candidate habitual operation cluster CL11, the previous operation is the operation A, and the subsequent operation is the operation B.

As for the operation B in the candidate habitual operation cluster CL11, the previous operation is the operation D, and the subsequent operation is the operation C.

Further, as for the operation C in the candidate habitual operation cluster CL11, the previous operation is the operation B, and there are no subsequent operations, because the operation C is the termination operation (the subsequent operation is shown as “END” in the drawing).

Meanwhile, as for the operation A in the habitual operation cluster CL12, the operation A, which is the top operation, has no preceding operations (shown as “TOP” in the drawing), and the subsequent operation is the operation B.

As for the operation D in the habitual operation cluster CL12, the previous operation is the operation C, and there are no subsequent operations, because the operation D is the termination operation (the subsequent operation is shown as “END” in the drawing).

As for the operation B in the habitual operation cluster CL12, the previous operation is the operation A, and the subsequent operation is the operation C.

Further, as for the operation C in the habitual operation cluster CL12, the previous operation is the operation B, and the subsequent operation is the operation D.

Here, on the basis of the comparison result CL13 in FIG. 8, the operation storage execution control unit 53 detects order-variable operations that are the operations that differ in both the previous operation and the subsequent operation between the candidate habitual operation cluster CL11 and the habitual operation cluster CL12.

That is, in the comparison result CL13 in FIG. 8, the operation D among the operations differs in both the previous operation and the subsequent operation, and therefore, is detected as an order-variable operation.

Note that the operation A and the operation C have different subsequent operations, but have the same previous operations. Further, as for the operation B, the previous operation is different, but the subsequent operation remains the same. Accordingly, none of the operation A, the operation B, and the operation C is detected as an order-variable operation.

Therefore, on the basis of the detected order-variable operation, the operation storage execution control unit 53 generates an integrated storage cluster CL14 by integrating the candidate habitual operation cluster CL11 and the habitual operation cluster CL12 as shown in FIG. 8, and registers the integrated storage cluster CL14 in the habitual operation cluster storage unit 55.

Specifically, in the integrated storage cluster CL14 in FIG. 8, it is recorded that, of the operations from the left, the operation A is an operation to move on to a video site, the operation D is an operation to set the sound volume at 30, the operation B is an operation to select the video content Z, and the operation C is an operation to click the play button.

Further, of these operations, the operation C is detected as an order-variable operation, and therefore, a variable range is set.

In the integrated storage cluster CL14 in FIG. 8, since the operation D has been detected as an order-variable operation, the operation D has the operation A as the pre-condition and the end as the post-condition, as indicated by arrows in the drawing.

That is, with the information in the integrated storage cluster CL14 in FIG. 8, it is recorded that the order can be changed, as long as both the operation D in the variable range between the operation A and the termination operation.

Note that the integrated storage cluster CL14 shown in FIG. 8 is an example in which registration is performed in the order of operations performed most recently. However, registration may be performed in the order of operations in an already registered habitual operation cluster.

By the process described above, of the registered habitual operation clusters, a candidate habitual operation cluster having the same operations but a different order is integrated with a registered habitual operation cluster and is registered as one habitual operation cluster (the integrated storage cluster CL14).

At this stage, for the operation recognized as an order-variable operation, a variable range in which the order of operations can be changed can be set.

<Example Presentation of a Habitual Operation Cluster>

Through the process described above, habitual operation clusters are sequentially registered in the habitual operation cluster storage unit 55. Meanwhile, a registered habitual operation cluster is presented to the user, and a plurality of operations constituting the habitual operation cluster is collectively executed or is registered as a macro, so that a plurality of operations with high degrees of habituation can be performed.

However, unless information indicating what habituation scores the operations constituting the habitual operation cluster have, or which combination of operations has a high degree of habituation is presented, it is not possible to determine which habitual operation cluster is to be collectively executed, or which habitual operation cluster is to be turned into a macro.

Therefore, the operation storage execution control unit 53 may read a user operation history registered in the user operation history storage unit 54 and a habitual operation cluster registered in the habitual operation cluster storage unit 55, and display two kinds of graphical user interfaces (GUIs) of user operation history mode display and recommended cluster mode display.

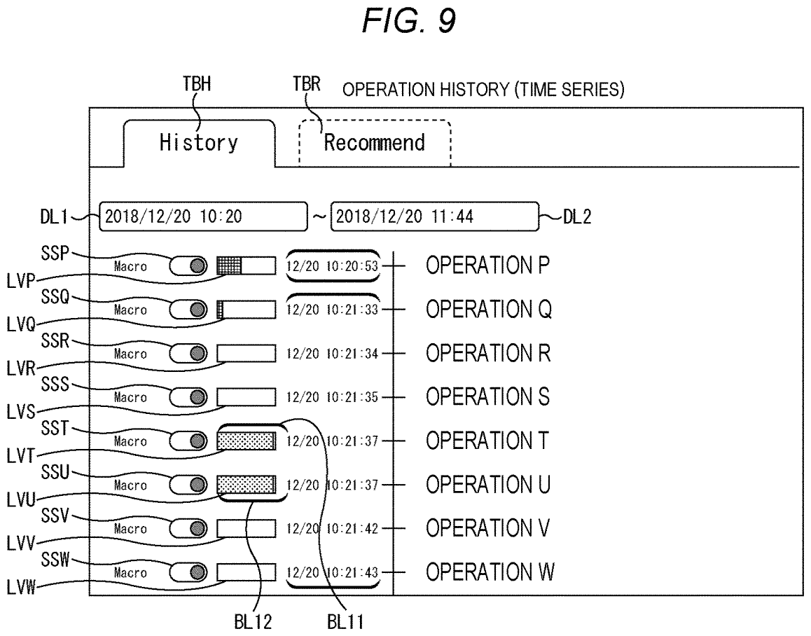

The user operation history mode display is a GUI in which a user operation history as shown in FIG. 9 is displayed in chronological order, for example.

In FIG. 9, as shown in the uppermost row, a tab TBH that is indicated as “History” and a tab TBR indicated as “Recommend” are provided. The tab TBH is tapped when the user operation history mode display is selected, and the tab TBR is tapped when the recommended cluster mode display is selected.

In FIG. 9, the tab TBH is selected, and thus, the GUI of the operation history mode display is displayed.

Below the tabs TBH and TBR, accumulation period display fields DL1 and DL2 showing the period during which the user operation history was accumulated are provided. In FIG. 9, “2018/12/20 10:20” to “2018/12/20 11:44” are written in DL1 and DL2, respectively, indicating that the accumulation period is from. 10:20, Dec. 20, 2018 to 11:44, Dec. 20, 2018.

Below the accumulation period display fields DL1 and DL2, the user operation history is displayed in chronological order from the top in the drawing, and operations are shown in chronological order from the top on the right side in FIG. 9, operations P to W are displayed in this order from the top.

On the left side of the operations P to W, time information corresponding to the time stamps at the times when the respective operations were performed is written, indicating that the operation P was performed at 10:20:53 on December 20.

Likewise, the time information indicates that the operation Q was performed at 10:21:33 on December 20, the operation R was performed at 10:21:34 on December 20, the operation S was performed at 10:21:35 on December 20, the operation T was performed at 10:21:37 on December 20, the operation U was performed at 10:21:37 on December 20, the operation V was performed at 10:21:42 on December 20, and the operation W was performed at 10:21:43 on December 20.

Further, on the left side of the time information, bar graph display fields LVP to LVW indicating the values of habituation scores Sₙ are provided in association with the operations P to W, respectively, and are color-coded and displayed in accordance with the values of the habituation scores represented by the respective bar graphs.

FIG. 9 shows that the habituation scores of the operation T and the operation U are the highest, followed by the habituation scores of the operation P and the operation Q.

Further, as for the bar graph display fields LVT and LVU having high habituation scores among the bar graph display fields LVP to LVW, brackets BL11 and BL12 indicating registration as a habitual operation cluster are displayed.

Since the top operation of the habitual operation cluster includes an operation having a lower habituation score than the habituation threshold, the operation S, the operation T, and the operation U are registered as a habitual operation cluster in the case shown in FIG. 9.

Further, on the left side of the bar graph display fields LVP to LVW, switches SSP to SSW for selecting operations to be turned into a macro are provided, and can be turned on or off by tapping. Turned-on operations are set as the operations to be turned into a macro.

Note that, in FIG. 9, all of the switches SSP to SSW are in an off-state.

The GUI of the user operation history mode display as shown in FIG. 9 enables the user to grasp what kinds of operations have been performed in chronological order, and to grasp which operations have higher habituation scores among the operations performed in chronological order, and which plurality of operations is registered as a habitual operation cluster.

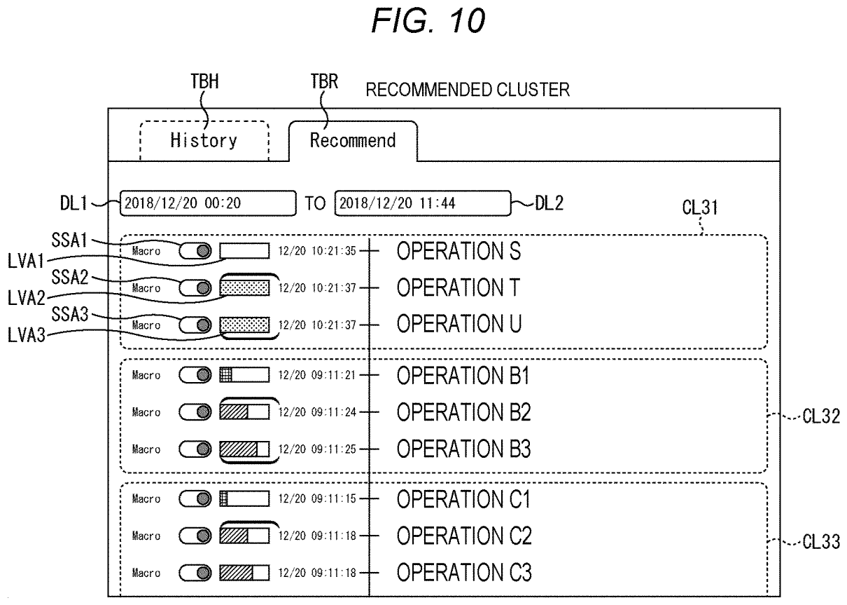

Further, when the tab TBR is tapped, the GUI is switched from the user operation history mode display shown in FIG. 9 to the recommended cluster mode display as shown in FIG. 10.

In the recommended cluster mode display in FIG. 10, the individual displays are also displayed in a manner similar to that in the configuration in the user operation history mode display in FIG. 9. However, in the recommended cluster mode display, operations are displayed on a habitual operation cluster basis, and further, the habitual operation clusters are displayed in an upper portion of the drawing in descending order of the average values of habituation scores.

Specifically, in the recommended cluster mode display in FIG. 10, a habitual operation cluster CL31 that is the highest in the average value of the habituation scores is displayed at the top, a habitual operation cluster CL32 that is the second highest in the average value of the habituation scores is displayed below the cluster CL31, and a habitual operation cluster CL33 that is the third highest in the average value of the habituation scores is further displayed below the cluster CL2.

Note that, in FIG. 10, the habitual operation cluster CL31 includes the operations S, T, and U, the habitual operation cluster CL32 includes operations B1, B2, and B3, and the habitual operation cluster CL33 includes operations C1, C2, and C3.

With the GUI of the recommended cluster mode display as shown in FIG. 10, the user can recognize what kind of operation of what plurality of operations in a habitual operation cluster has a high degree of habituation simply at a glance.

The operation storage execution control unit reads the user operation history and the habitual operation cluster information stored in the user operation history storage unit 54 and the habitual operation cluster storage unit 55, and outputs the read user operation history and habitual operation cluster information to the response generation unit 59.

The response generation unit 59 outputs the user operation history and the habitual operation cluster information to the display image processing unit 60, and performs control to generate the respective GUIs corresponding to the user operation history mode display or the recommended cluster mode display.

The display image processing unit 60 causes the image output unit 62 to display the generated GUI corresponding to the user operation history mode display or the recommended cluster mode display as shown in FIGS. 9 and 10, for example.

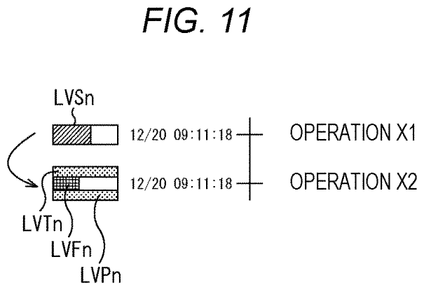

Note that, as for the user operation history mode display or the recommended cluster mode display generated in FIGS. 9 and 10, an example in which the habituation scores Sₙ are displayed in the bar graph display fields has been described. However, as shown in FIG. 11, for example, the time interval Tₙ, the number Fₙ of transitions, and the probability Pₙ of a transition, which are to be used for calculating the habituation scores Sₙ, may be displayed as bar graphs.

Specifically, in FIG. 11, a bar graph display field LVSn in which only the habituation score Sₙ is displayed is provided in the bar graph display field of an operation X1.

In the bar graph display field of an operation X2, on the other hand, bar graph display fields LVTn, LVFn, and LVPn that represent the values of the time interval Tₙ, the number Fₙ of transitions, and the probability Pₙ of a transition, respectively, are provided.

In FIG. 11, when the display position of the bar graph display field LVSn is tapped, the display is switched to show the bar graph display fields LVTn, LVFn, and LVPn. When the display position of the bar graph display fields LVTn, LVFn, and LVPn is tapped, the display is switched to show the bar Graph display field LVSn.

That is, the display of only the bar graph display field LVSn, and the display of all the bar graph display fields LVTn, LVFn, and LVPn are switched by a tap on the display position.

Note that, alternatively, a mode in which all of the bar graph display fields LVSn, LVTn, LVFn, and LVPn are displayed may be set, and displays may be switched by a tap.

<Voice Macro Conversion>

Next, an operation to be performed when macro conversion is performed is described. In this operation, the user selects a plurality of operations constituting a habitual operation cluster, on the basis of information indicating the degrees of habituation of the respective operations in the habitual operation cluster through the GUI of the user operation history mode display or the recommended cluster mode display.

In a case where the user selects a plurality of operations constituting a habitual operation cluster on the basis of the habitual operation cluster information displayed in the user operation history mode display or the recommended cluster mode display, and turns the plurality of operations into a macro, the operations to be turned into a macro are selected.

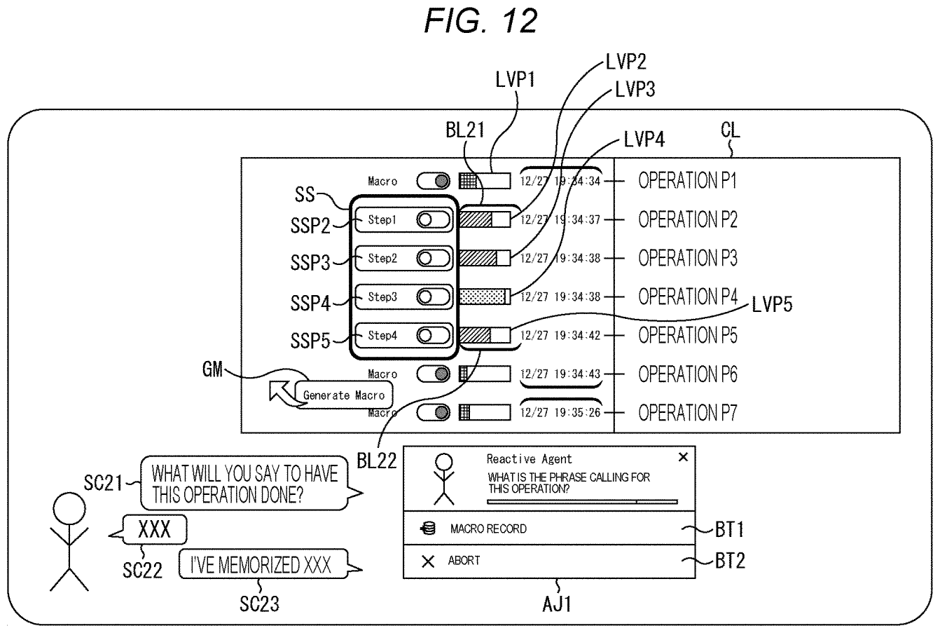

Specifically, the following is a description of a case where operations P1 to P7 formed with the operations shown in FIG. 12 are displayed in chronological order, brackets BL21 and BL22 are set for the bar graph display fields LVP2 to LVP5 of the operations P2 to P5, and a habitual operation cluster formed with the operations P1 to P5 is set.

Here, when a macro is to be generated to collectively perform a plurality of operations P2 to P5, the switches are operated to be in an on-state as indicated by switches SSP2 to SSP5 surrounded by a frame SS.

When the operation storage execution control unit 53 recognizes user operation information indicating that the input operation unit 51 has been operated, and the switches SSP2 to SSP5 have been operated to enter an on-state as shown in FIG. 12 via the functional application program execution unit 52, the operation storage execution control unit 53 causes display of a button GM for performing macro conversion.

For example, the button GM is written as “Generate Macro” as shown in FIG. 12, and is operated when the user wishes macro conversion for performing a plurality of selected operations.

When the button GM is operated through the input operation unit 51, and a macro conversion instruction is issued, the operation storage execution control unit 53 controls the response generation unit 59 to output an image and a voice inquiring about what kind of speech/utterance is to be emitted to the user to execute a macro.

By this process, the response generation unit 59 controls the display image processing unit 60 to generate an inquiry display field. AJ1 as shown in FIG. 12, for example, and causes the image output unit 62 to display the inquiry display field AJ1.

In the inquiry display field AJ1, “What is the phrase calling for this operation?” is displayed at the top, and information for inquiring what calling phrase is to be used in voice macro conversion is displayed. Below that, a button BT1 that is written as “MACRO RECORD” and is operated when voice macro conversion is to be performed, and a button BT2 to be operated when macro conversion is to be stopped are displayed.

Further, in a process SC21, the response generation unit 59 controls the voice synthesis processing unit 61 to generate an image as a response such as “What will you say to have this operation done?”, generates a voice, and causes the voice output unit 63 to output the voice.

Next, in a process SC22, in a case where the user operates the button BT1 for issuing a macro conversion instruction, and utters “XXX ” as the phrase to be used for voice macro conversion, the operation storage execution control unit 53 generates a macro for collectively executing the plurality of operations formed with the operations P2 to P5 corresponding to the switches SSP2 to SSP5 in an on-state in response to the phrase “XXX ”, and stores the generated macro into the habitual operation cluster storage unit 55.

Further, in a process SC23, in accordance with a macro conversion instruction such as “I've memorized XXX”, for example, the operation storage execution control unit 53 notifies that the registration of the macro for collectively performing the plurality of operations formed with the operations P2 to P5 has been completed.

<GUI Macro Conversion Process>

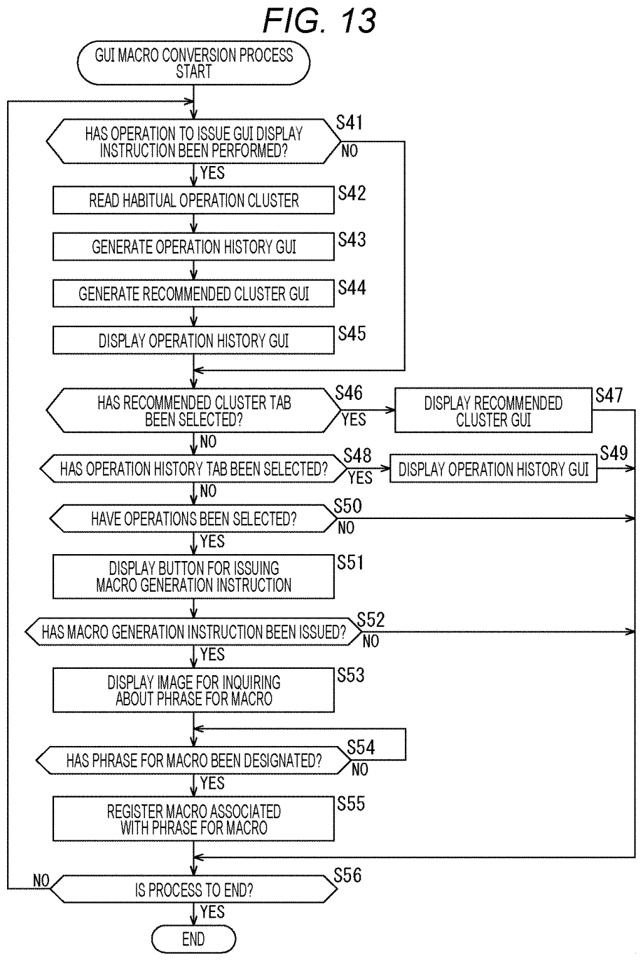

Next, referring to a flowchart shown in FIG. 13, a GUI macro conversion process is described. In this process, a habitual operation cluster is presented through the user operation history mode display or the recommended cluster mode display described above with reference to FIGS. 9 to 12, and a plurality of operations desired by the user is selected and is turned into a macro, on the basis of information about the presented habitual operation cluster.

Note that, the process in which the operation storage execution control unit 53 acquires user operation information via the functional application program execution an it 52 when the input operation unit 51 is operated, and the process in which Intent and Entity corresponding to the user's uttered phrase are supplied from the utterance semantic understanding processing unit 58 in response to an input of a voice emitted by the user through the voice input unit 56 are the same as above, and therefore, explanation of them is not repeated herein.

That is, in the description below, it is assumed that the operation storage execution control unit 53 has the functions of the input operation unit 51, the functional application program execution unit 52, and the user operation history storage unit 54 to the voice output unit 63.

Specifically, explanation is not made herein either in the following aspects: the response generation unit 59 controls the display image processing unit 60 to generate an image as a response on the basis of an instruction from the operation storage execution control unit 53, and causes the image output unit 62 to display the image; and the response generation unit 59 controls the voice synthesis processing unit 61 to generate a voice as a response, and causes the voice output unit 63 to output the voice.

Further, in the description below, the operation storage execution control unit 53 acquires user operation information, and Intent and Entity corresponding to an uttered phrase, and explanation of the route for acquisition of various kinds of information or the like is not made.

Furthermore, in the simplified description below, the operation storage execution control unit 53 causes display of a response image, and outputting of a response voice. The other components and functions are not explained herein.

In step S41, the operation storage execution control unit 53 determines whether or not the input operation unit 51 has been operated, or an utterance has requested presentation of the GUI of the user operation history mode display or the recommended cluster mode display.

If it is determined in step S41 that presentation of the GUI of the user operation history mode display or the recommended cluster mode display has been requested, the process moves on to step S42.

In step S42, the operation storage execution control unit 53 reads the user operation history stored in the user operation history storage unit 54 and the information about the habitual operation cluster stored in the habitual operation cluster storage unit 55.

In step S43, the operation storage execution control unit 53 causes generation of the GUI of the user operation history mode display, on the basis of the read user operation history stored in the user operation history storage unit 54 and the read information about the habitual operation cluster stored in the habitual operation cluster storage unit 55.

In step S44, the operation storage execution control unit 53 causes generation of the GUI of the recommended cluster mode display, on the basis of the read user operation history stored in the user operation history storage unit 54 and the read information about the habitual operation cluster stored in the habitual operation cluster storage unit 55.

In step S45, the operation storage execution control unit 53 causes display of the GUI of the user operation history mode display as the default GUI.

Note that, if it is determined in step S41 that presentation of the GUI of the user operation history mode display or the recommended cluster mode display has not been requested, the processes in steps S42 to S45 are skipped.

In step S46, the operation storage execution control unit 53 determines whether or not the tab BTR for selecting the recommended cluster mode display has been selected, and an instruction to display the recommended cluster mode display has been issued.

If it is determined in step S46 that the tab BTR for selecting the recommended cluster mode display has been selected, the process moves on to step S47.

In step S47, the operation storage execution control unit 53 causes display of the GUI (recommended cluster GUI) of the recommended cluster mode display.

If it is determined in step S46 that the tab BTR for selecting the recommended cluster mode display has not been selected, on the other hand, the process moves on to step S48.

If it is determined in step S48 that the tab BTH for selecting the user operation history mode display has been selected, the process moves on to step S49.

In step S49, the operation storage execution control unit 53 causes display of the GUI (user operation history GUI) of the user operation history mode display.

If it is determined in step S48 that the tab BTH for selecting the user operation history mode display has not been selected, on the other hand, the process moves on to step S50.

In step S50, the operation storage execution control unit 53 determines whether or not a switch corresponding to any of the operations has been turned on, as indicated by the switches SSP2 to SSP5 in FIG. 12, for example.

Note that, if it is determined in step S41 that any GUI display instruction has not been issued, any GUI is not displayed, and therefore, “not selected” is regarded as the result of each of the processes in steps S46, S48, and S50.

If it is determined in step S50 that the switch corresponding to one of the operations has been turned on, the process moves on to step S51.

In step S51, the operation storage execution control unit 53 causes generation and display of the button GM for issuing a macro conversion instruction.

In step S52, the operation storage execution control unit 53 determines whether or not a macro conversion instruction has been issued. If the button GM for issuing a macro conversion instruction has been operated, and a macro conversion instruction has been issued, for example, the process moves on to step S53.

In step S53, the operation storage execution control unit 53 causes display of an image for inquiring about the phrase for executing the macro, and outputs a voice. The process in step S53 corresponds to the process SC21 in FIG. 12.

In step S54, the operation storage execution control unit 53 determines whether or not the phrase for executing the macro has been designated, and repeats a similar process until the phrase is designated. If it determined in step S54 that the phrase has been designated, the process then moves on to step S55. The process in which the phrase is designated corresponds to the process SC22 in FIG. 12.

In step S55, the operation storage execution control unit 53 registers, together with the designated phrase, the macro for collectively performing the operations selected by turning on switches as indicated by the switches SSP2 to SSP5 in FIG. 12.

At this point of time, a response image or a response voice indicating that the macro has been registered may be output as necessary. The process in step S55 corresponds to the process SC23 in FIG. 12.

In step S56, the operation storage execution control unit 53 determines whether or not an instruction to end the process has been issued. If the end instruction has not been issued, the process returns to step S41, and the processes that follow are repeated.

Also, in step S56, the operation storage execution control unit 53 determines whether or not an instruction to end the process has been issued, and, if the end instruction has been issued, the process comes to an end.

In the above process, the user operation history stored in the user operation history storage unit 54 and the information about the habitual operation cluster stored in the habitual operation cluster storage unit 55 are presented together with the habituation scores. Thus, the user can visually recognize a plurality of operations with which the user unconsciously has habituation.

At this point of time, the habituation scores can be recognized as bar graphs or the like. Accordingly, it is possible to recognize not only the operations selected as a habitual operation cluster, but also the degree of habituation of each of the operations selected as the habitual operation cluster.

Further, it is possible to select the operations constituting the habitual operation cluster and register a voice macro, after recognizing the habitual operation cluster and the degrees of habituation based on the habituation scores.

<Example in Which the Termination Operation of a Habitual Operation Cluster is Detected, and Macro Conversion is Suggested>

In the above description, the process of causing the user to recognize a habitual operation cluster and turn the habitual operation cluster into a macro in presentation of a user operation history has been described. However, macro conversion may be suggested when the termination operation of a habitual operation cluster is detected, for example.

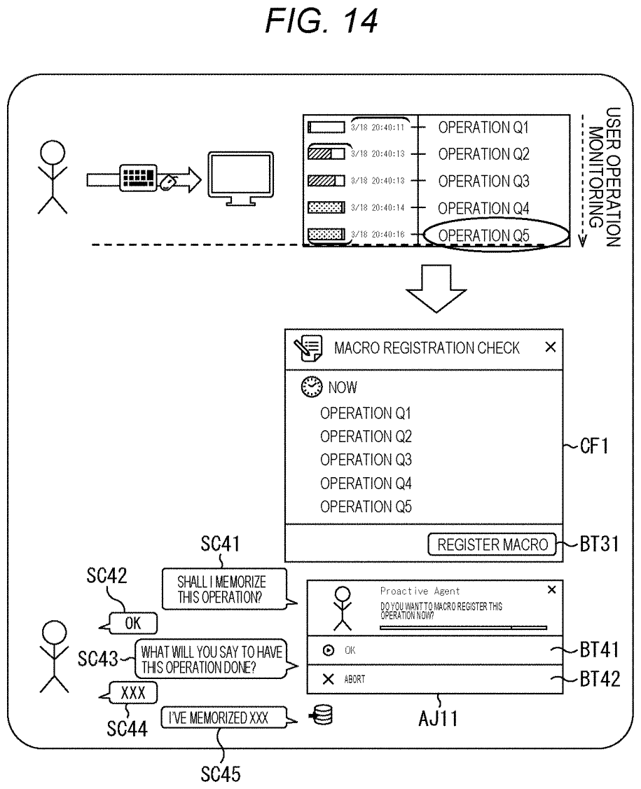

For example, as indicated by the user operation history shown in the upper portion of FIG. 14, an operation Q1 is performed at 20:40:11 on March 18, an operation Q2 is performed at 20:40:13 on March 18, an operation Q3 is performed at 20:40:13 on March 18, an operation Q4 is performed at 20:40:14 on March 18, and an operation Q5 is performed at 20:40:16 on March 18. This example case is now described.

Further, the habituation scores of the operations Q2 to Q5 in the user operation history in the upper portion of FIG. 14 are higher than the habituation threshold, and the operations Q1 to Q5 are registered as a habitual operation cluster.

The operation storage execution control unit 53 monitors the user operation history, and, every time user operation information is supplied, searches for the habitual operation cluster including the operation corresponding to the supplied user operation information, for example.

Next, in a case where the habitual operation cluster including the operation corresponding to the supplied user operation information is successfully detected, the operation storage execution control unit 53 determines whether or not the operation corresponding to the supplied user operation information is the termination operation among the operations constituting the detected habitual operation cluster.

For example, in a case where the operation corresponding to the supplied user operation information is the operation Q5 surrounded by a circle at the timing indicated by a dashed line in the upper portion of FIG. 14, the corresponding operation is regarded as the termination operation among the operations constituting the detected habitual operation cluster.

As described above, in a case where the operation corresponding to the supplied user operation information is the termination operation among the operations constituting the detected habitual operation cluster, the operation storage execution control unit 53 suggests conversion of the detected habitual operation cluster into a macro.

More specifically, the operation storage execution control unit 53 causes display of a suggestion image CF1 as shown in the middle portion of FIG. 14, for example.

In the suggestion image CF, “MACRO REGISTRATION CHECK” is written at the top, indicating that an image suggesting macro conversion is displayed.

Below that, the operations Q1 to Q5 are also shown as the operations constituting the detected habitual operation cluster having the most recent operation Q5 as the termination operation.

Further, below that, a button BT31 that is written as “REGISTER MACRO” and is operated when a detected habitual operation cluster is to be turned into a macro is displayed.

When the button BT31 is operated, the operation storage execution control unit 53 displays an inquiry display field AJ11 for turning the detected habitual operation cluster into a macro, and outputs an inquiry voice, as shown in the lower portion of FIG. 14.

In the display field AJ11, “Proactive Agent” is written at the top, indicating that this is an inquiry from a voice agent. Below that, “Do you want to macro register this operation now?” is written, indicating that an inquiry as to whether or not to register a macro is being made.

Further, below that, a button BT41 that is written as “OK” and is operated when a macro registration instruction is to be issued, and a button BT42 that is written as “ABORT” and is operated when macro registration is to be stopped are displayed.

At the same time, in a process SC41, the operation storage execution control unit 53 also outputs an inquiry voice for inquiring whether or not to perform macro registration, through the audio guidance “Shall I memorize this operation?”.

When the user utters “OK” in response to this, for example, the operation storage execution control unit 53 recognizes that a macro registration instruction has been issued in a process SC42.

Further, in a process SC43, the operation storage execution control unit 53 outputs an inquiry voice for inquiring which phrase is to be used to perform a plurality of operations included in the macro-registered habitual operation cluster, through the audio guidance “What will you say to have this operation done?”.

When the user utters “XXX” in response to this, for example, the operation storage execution control unit 53 in a process SC44 registers “XXX” as the phrase to be used when a plurality of operations included in the macro-registered habitual operation cluster is to be performed.

Further, in a process SC45, the operation storage execution control unit 53 outputs a voice for notifying that registration of a macro for executing the habitual operation cluster including the current operation as the termination operation in response to the phrase “XXX” has been completed, through the audio guidance “I've memorized XXX”.

In the above process, in a case where the user's operation is an operation included in a habitual operation cluster and is the termination operation of the habitual operation cluster, macro conversion for the corresponding habitual operation cluster is suggested. Thus, it is possible to efficiently turn a habitual operation cluster into a macro, without the user being conscious of his/her own habituation with respect to the operation.

<Macro Conversion Suggesting Process at a Time of the Termination Operation of a Habitual Operation Cluster>

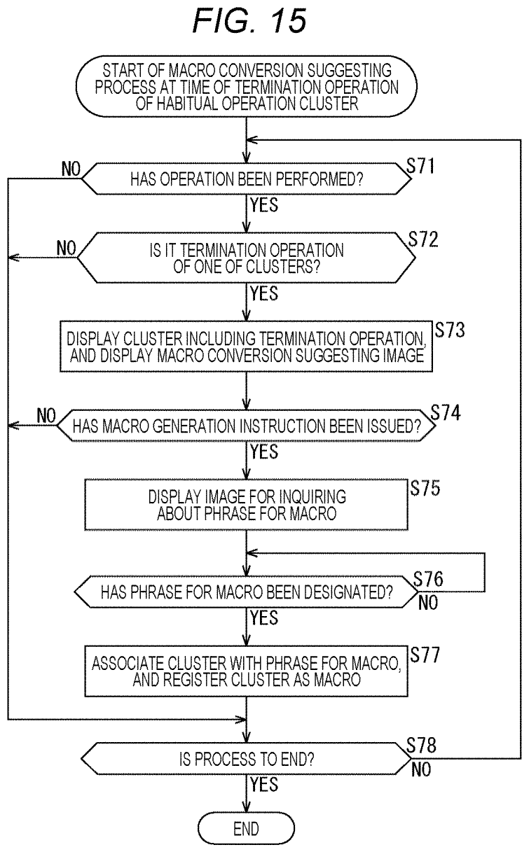

Next, a macro conversion suggesting process at a time of the termination operation of a habitual operation cluster is described with reference to a flowchart shown in FIG. 15.

In step S71, the operation storage execution control unit 53 determines whether or not the input operation unit 51 has been operated, user operation information has been supplied, and an operation has been detected.

If it is determined in step S71 that an operation has been detected, the process moves on to step S72.

In step S72, the operation storage execution control unit 53 determines whether or not the detected operation is the termination operation of one of the habitual operation clusters stored in the habitual operation cluster storage unit 55.

If it is determined in step S72 that the detected operation is the termination operation of one of the habitual operation clusters stored in the habitual operation cluster storage unit 55, the process moves on to step S73.

In step S73, the operation storage execution control unit 53 displays the suggestion image CF1 shown in FIG. 14, for example. The suggestion image CF1 suggests macro conversion for the habitual operation cluster in which the detected operation is the termination operation, among the habitual operation clusters stored in the habitual operation cluster storage unit 55.

In step S74, the operation storage execution control unit 53 determines whether or not a macro conversion instruction has been issued by the user operating the button BT31 in FIG. 14 or the like, for example.

If it is determined in step S74 that a macro conversion instruction has been issued by the user, the process moves on to step S75.

In step S75, the operation storage execution control unit 53 outputs an in voice as in the process SC43 described above with reference to FIG. 14, for example, and inquires about the phrase to be used when a plurality of operations in the habitual operation cluster for which macro conversion has been suggested is collectively performed.

In step S76, the operation storage execution control unit 53 determines whether or not the phrase to be used when a plurality of operations in the habitual operation cluster for which macro conversion has been suggested is collectively performed, and repeats a similar process until the phrase is designated.

In step S76, if the phrase is designated as in the process SC44 in FIG. 14, for example, the process then moves on to step S77.

In step S77, the operation storage execution control unit 53 associates the habitual operation cluster that is stored in the habitual operation cluster storage unit 55 and for which macro conversion has been suggested, with the designated phrase, and registers the habitual operation cluster as a macro.

In step S78, the operation storage execution control unit 53 determines whether or not an operation end instruction has been issued. If any end instruction has not been issued, the process returns to step S71.

If it is determined in step S78 that an end instruction has been issued, the process then comes to an end.

On the other hand, if it is determined in step S71 that any operation has not been performed, if the detected operation is determined not to be the termination operation of any of the habitual operation clusters in step S72, or if it is determined in step S74 that any macro generation instruction has not been issued, the process moves on to step S78.

In the above process, in a case where the termination operation or a registered habitual operation cluster is detected, macro conversion for the habitual operation cluster is suggested. Accordingly, the user can recognize that a series of operations constituting a registered habitual operation cluster have been performed, without being conscious of his/her habituation with respect to the operation. Further, as macro conversion is suggested, the habitual operation cluster can be efficiently turned into a voice macro.

<Example in Which the Top Operation of a Habitual Operation Cluster is Detected, and Macro Conversion is Suggested, on the Basis of a Macro Conversion Instruction by Voice During an Operation>

In the example described above, in a case where the termination operation of a habitual operation cluster is detected, macro conversion for the corresponding habitual operation cluster is suggested. However, the top operation of a habitual operation cluster may be detected, and macro conversion for the habitual operation cluster may be suggested, on the basis of a macro conversion instruction by voice during the operation.

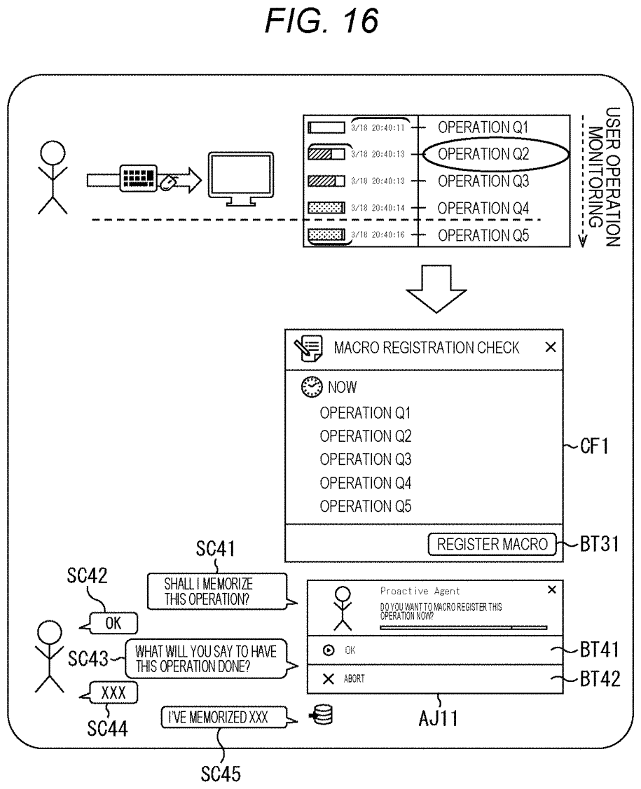

Specifically, as shown in the upper portion of FIG. 16, in a case where the operations Q1 to Q5 are performed in chronological order, when a macro conversion instruction is issued by the user's utterance at the time when the operation Q4 is performed as indicated by a dashed line, the operation storage execution control unit 53 searches for the habitual operation cluster to which the operations belong, on the basis of the plurality of operations most recently performed, such as the operations Q1 to Q4.

When the habitual operation cluster is successfully detected, the operation storage execution control unit 53 then reads the detected habitual operation cluster up to the top operation, generates and displays the suggestion image CF1 shown in the middle portion of FIG. 16, for example, and suggests macro conversion for the detected habitual operation cluster.

Note that the process related to a macro conversion suggestion is similar to the process described above with reference to FIG. 14, and therefore, explanation thereof is not repeated herein. Further, in a case where a macro conversion instruction is not issued in response to a macro conversion suggestion, the process may be switched to a GUI macro conversion process that can be set for each operation by the process described above with reference to FIGS. 12 and 13, for example.

In the above process, even in a state where the user does not accurately recognize that his/her operation is an operation included in a habitual operation cluster, a macro conversion instruction is simply issued at the time when a specific operation supposed to be included in a habitual operation cluster is performed, so that macro conversion for the corresponding habitual operation cluster is suggested.

As a result even in a state where the degree of habituation of the user's operation is not accurately stored, it is possible to receive a macro conversion suggestion for the habitual operation cluster simply by issuing a macro conversion instruction at the when the user recognizes that the specific operation has been performed. Thus, the habitual operation cluster can be efficiently turned into a macro.

<Habitual Operation Cluster Macro Conversion Suggesting Process Based on a Voice Macro Conversion Instruction>

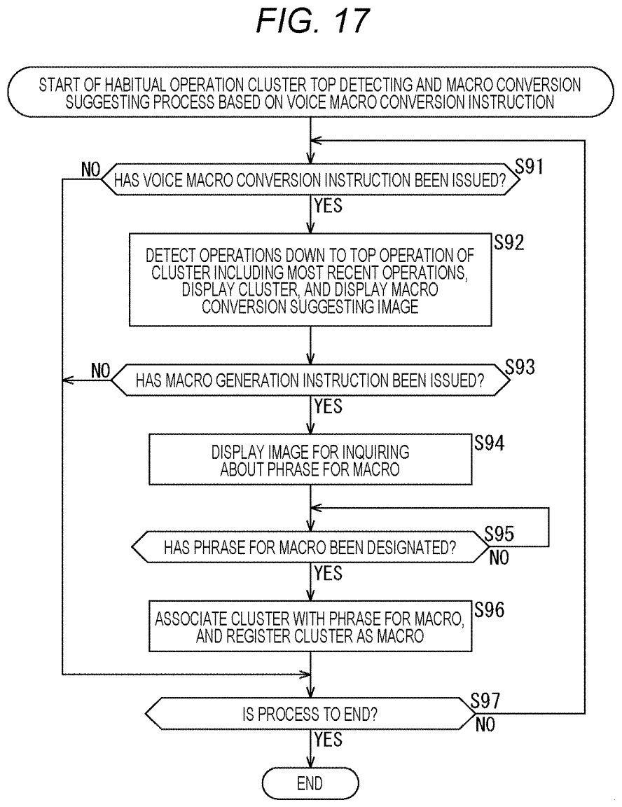

Next, a habitual operation cluster macro conversion suggesting process based on a macro conversion instruction during an operation is described with reference to a flowchart shown in FIG. 17.

In step S91, the operation storage execution control unit 53 determines whether or not a voice macro conversion instruction has been issued.

If it is determined in step S91 that a macro conversion instruction has been issued, the process moves on to step S92.

In step S92, the operation storage execution control unit 53 detects the habitual operation cluster that is stored in the habitual operation cluster storage unit 55 and includes the operations up to the operation immediately before the macro conversion instruction, and displays the suggestion image CF1 shown in FIG. 16, for example, to suggest macro conversion for the detected habitual operation cluster.

In step S93, the operation storage execution control unit 53 determines whether or not a macro conversion instruction has been issued by the user operating the button BT31 in FIG. 16 or the like, for example.

If it is determined in step S93 that a macro conversion instruction has been issued by the user, the process moves on to step S94.

In step S94, the operation storage execution control unit 53 outputs an inquiry voice as in the process SC43 described above with reference to FIG. 14, for example, and inquires about the phrase to be used when a plurality of operations in the habitual operation cluster for which macro conversion has been suggested is collectively performed.

In step S95, the operation storage execution control unit 53 determines whether or not the phrase to be used when a plurality of operations in the habitual operation cluster for which macro conversion has been suggested is collectively performed, and repeats a similar process until the phrase is designated.

If it is determined in step S95 that the phrase has been designated, the process then moves on to step S96.

In step S96, the operation storage execution control unit 53 associates the habitual operation cluster that is stored in the habitual operation cluster storage unit 55 and for which macro conversion has been suggested, with the designated phrase, and registers the habitual operation cluster as a macro.

In step S97, the operation storage execution control unit 53 determines whether or not an operation end instruction has been issued if any end instruction has not been issued, the process returns to step S91.

If it is determined in step S97 that an end instruction has been issued, the process then comes to an end.

On the other hand, if it is determined in step S91 that any macro conversion instruction has not been issued, or if it is determined in step S93 that any macro generation instruction has not been issued, the process moves on to step S93.

In the above process, even in a state where the user does not accurately recognize that his/her operation is an operation included in a habitual operation cluster, a macro conversion instruction is simply issued at the time when a specific operation supposed to be included in a habitual operation cluster is performed, so that macro conversion for the corresponding habitual operation cluster is suggested.

As a result, even in a state where the user does not accurately understand the degree of habituation of his/her operation, it is possible to receive a macro conversion suggestion for the habitual operation cluster simply by issuing a macro conversion instruction at the when the user recognizes that the specific operation has been performed. Thus, the habitual operation cluster can be efficiently turned into a macro.

<Example in Which Collective Execution of a Habitual Operation Cluster is Suggested at a Time of the Top Operation of the Habitual Operation Cluster>

In the example described above, when the user issues macro conversion instruction, the habitual operation cluster to which the most recent operations belong is detected from the top operation, and macro conversion is performed.

However, the user's operations may be monitored, and collective execution of the habitual operation cluster may be suggested at the time of the top operation of the habitual operation cluster.

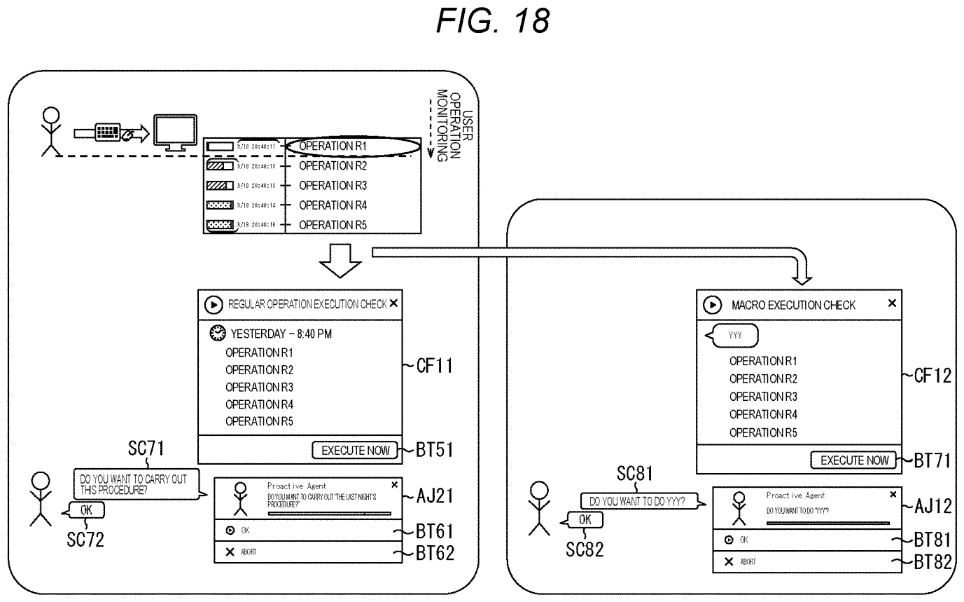

For example, as indicated by the user operation history shown in the upper left portion of FIG. 18, an operation R1 is performed at 09:04:05 on March 19, an operation R2 is performed at 09:04:08 on March 19, an operation R3 is performed at 09:04:11 on March 19, an operation R4 is performed at 09:04:11 on March 19, and an operation R5 is performed at 09:04:14 on March 19. This example case is now described.

Further, the habituation scores of the operations R2 to R5 in the user operation history in the upper left portion of FIG. 18 are higher than the habituation threshold, and the operations R1 to R5 are registered as a habitual operation cluster.

The operation storage execution control unit 53 monitors the user operation history. For example, every time user operation information is supplied, the operation storage execution control unit 53 searches for the registered habitual operation cluster in which the operation corresponding to the supplied user operation information is registered as the top operation among the registered habitual operation clusters, and determines whether or not the top operation of the registered habitual operation cluster has been performed.

For example, as shown in the upper left portion of FIG. 18, when the operation R1 is operated at the timing indicated by a dashed line, it is considered that the top operation of a registered habitual operation cluster has been performed. Accordingly, in such a case, the operation storage execution control unit 53 suggests collective execution of the habitual operation cluster whose the top operation has been performed.

More specifically, the operation storage execution control unit 53 determines whether or not the habitual operation cluster whose top operation has been performed is registered as a macro. If the habitual operation cluster is not registered as a macro, a suggestion image CF11 as shown in the lower left portion of FIG. 18 is displayed, for example.

In the suggestion image CF11, “REGULAR OPERATION EXECUTION CHECK” is written at the top, indicating that this image is a suggestion image for collective execution of the habitual operation cluster whose top operation has been performed.

Below that, “Yesterday—8:40 pm” is written, indicating the time of the most recent operation in the habitual operation cluster whose top operation has been performed. Further, below that, the second and subsequent operations R2 to R5 are written as the operations constituting the habitual operation cluster whose top operation has been performed.

Below the operations R2 to R5, a button BT51 that is written as “EXECUTE NOW” and is operated when a detected habitual operation cluster is to be collectively executed is displayed.

When the button BT51 is operated, the operation storage execution control unit 53 displays an inquiry display field AJ21 for collectively executing the detected habitual operation cluster whose top operation has been performed, and outputs an inquiry voice, as shown in the lower left portion of FIG. 18.

In the display field. AJ21, “Proactive Agent” is written at the top, indicating that this is an inquiry from a voice agent. Below that, “Do you want to carry out the last night's procedure?” is written, indicating that an inquiry as to whether or not to collectively execute the habitual operation cluster whose top operation has been performed is being made.

Further, below that, a button BT61 that is written as “OK” and is operated when a collective operation instruction is to be issued, and a button BT62 that is written as “ABORT” and is operated when the collective operation instruction is to be stopped are displayed.

Also, at the same time, in a process SC71, the operation storage execution control unit 53 outputs an inquiry voice for inquiring whether or not to collectively execute the habitual operation cluster having the top operation performed, through the audio guidance “Do you want to carry out this procedure?”.

When the user utters “OK” in response to this, for example, the operation storage execution control unit 53 recognizes that an instruction to collectively execute the habitual operation cluster having the top operation performed has been issued in a process SC72, and performs collective execution.

In a case where the habitual operation cluster whose top operation has been performed is registered as a macro, on the other hand, the operation storage execution control unit 53 displays a suggestion image CF12 as shown in the lower right portion of FIG. 18, for example.

In the suggestion image CF11, “MACRO EXECUTION CHECK” is written at the top, and an image that suggests execution of the macro associated with the habitual operation cluster whose top operation has been detected is displayed.

Below that, “YYY” is written, indicating the registered phrase associated with the macro associated with the habitual operation cluster whose top operation has been detected. Below that, the second and subsequent operations R2 to R5 are written as the operations constituting the macro-registered habitual operation cluster whose top operation has been performed.

Below the operations R2 to R5, a button BT71 that is written as “EXECUTE NOW” and is operated when a macro registered as a detected habitual operation cluster is to be executed is displayed.

When the button BT71 is operated, the operation storage execution control unit 53 displays an inquiry display field AJ22 for executing the macro registered as the habitual operation cluster whose top operation has been performed, and outputs an inquiry voice, as shown in the lower right portion of FIG. 18.

In the display field AJ22, “Proactive Agent” is written at the top, indicating that this is an inquiry from a voice agent. Below that, “Do you want to do YYY?” is written, indicating that an inquiry as to whether or not to execute the macro registered as the habitual operation cluster whose top operation has been performed is being made.

Further, below that, a button BT81 that is written as “OK” and is operated when a macro execution instruction is to be issued, and a button BT82 that is written as “ABORT” and is operated when the macro execution instruction is to be stopped are displayed.

Also, at the same time, in a process SC81, the operation storage execution control unit 53 outputs an inquiry voice for inquiring whether or not to execute the macro registered as the habitual operation cluster having the top operation performed, through the audio guidance “Do you want to do YYY?”.

When the user utters “OK” in response to this, for example, the operation storage execution control unit 53 recognizes that an instruction to execute the macro registered as the habitual operation cluster having the top operation performed has been issued in a process SC82, and performs macro execution.

<Collective Execution Suggesting Process at a Time of the Top Operation of a Habitual Operation Cluster>

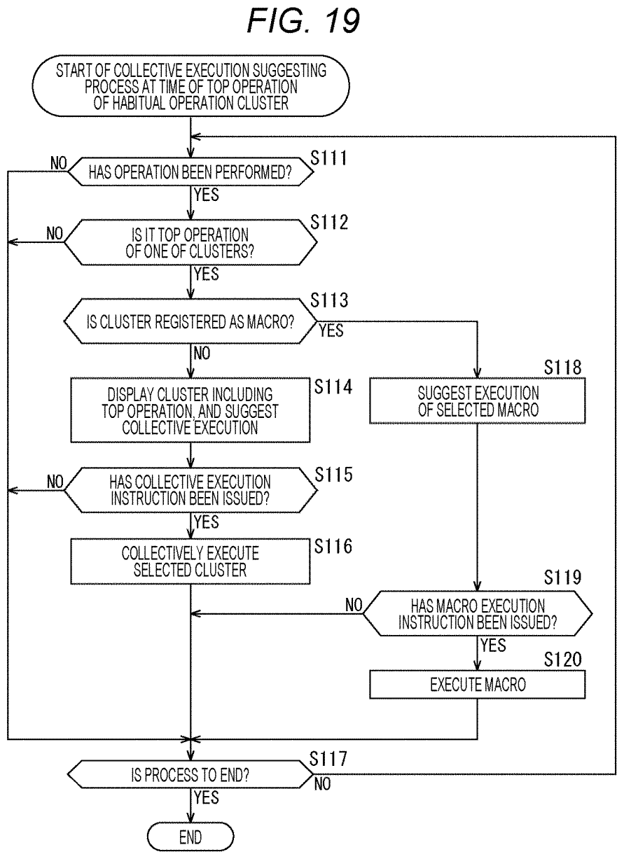

Next, a collective execution suggesting process at a time of the top operation of a habitual operation cluster, which is the process described above with reference to FIG. 18, is now described with reference to a flowchart shown in FIG. 19.

In step S111, the operation storage execution control unit 53 determines whether or not the input operation unit 51 has been operated, user operation information has been supplied, and an operation has been detected.

If it is determined in step S111 that an operation has been detected, the process moves on to step S112.

In step S112, the operation storage execution control unit 53 determines whether or not the detected operation is the top operation of one of the habitual operation clusters stored in the habitual operation cluster storage unit 55.

If it is determined in step S112 that the detected operation is the top operation of one of the habitual operation clusters stored in the habitual operation cluster storage unit 55, the process moves on to step S113.

In step S113, the operation storage execution control unit 53 determines whether or not the habitual operation cluster whose top operation is the detected operation is registered as a macro.

If it is determined in step S113 that the habitual operation cluster having the detected operation as its top operation is not registered as a macro, the process moves on to step S114.

In step S114, the operation storage execution control unit 53 displays the suggestion image CF11 shown in FIG. 18, for example. The suggestion image CF11 suggests collective execution of the habitual operation cluster having the detected operation as its top operation, among the habitual operation clusters stored in the habitual operation cluster storage unit 55.

In step S115, the operation storage execution control unit 53 determines whether or not a collective execution instruction has been issued by the user operating the button BT51 in FIG. 18 or the like, for example.

If it is determined in step S115 that a collective execution instruction has been issued by the user, the process moves on to step S116.

In step S116, the operation storage execution control unit 53 causes collective execution of a plurality of operations of the habitual operation cluster for which collective execution has been suggested.

In step S117, the operation storage execution control unit 53 determines whether or not an operation end instruction has been issued. If any end instruction has not been issued, the process returns to step S118.

If it is determined in step S118 that an end instruction has been issued, the process then comes to an end.

If it is determined in step S113 that the habitual operation cluster having the detected operation as its top operation is registered as a macro, on the other hand, the process moves on to step S118.

In step S118, the operation storage execution control unit 53 displays the suggestion image CF12 shown in FIG. 18, for example. The suggestion image CF12 suggests execution of the macro registered as the habitual operation cluster having the detected operation as its top operation, among the habitual operation clusters stored in the habitual operation cluster storage unit 55.

In step S119, the operation storage execution control unit 53 determines whether or not a macro execution instruction has been issued by the user operating the button BT71 in FIG. 18 or the like, for example.

If it is determined in step S119 that a macro execution instruction has been issued by the user, the process moves on to step S120.

In step S120, the operation storage execution control unit 53 executes the macro for which execution has been suggested.

On the other hand, if it is determined in step S111 that any operation has not been performed, if the detected operation is determined not to be the top operation of any of the habitual operation clusters in step S112, if it is determined in step S115 that an instruction to collectively execute the habitual operation cluster including the detected top operation has not been issued, or if it is determined in step S119 that any macro execution instruction has not been issued, the process moves on to step S117.

In the above process, in a case where the user's operation is the top operation of a registered habitual operation cluster, collective execution of the habitual operation cluster including the detected top operation, or execution the registered macro is suggested.

As a result, even in a state where the user does not remember the operations of the registered habitual operation cluster, the user can conduct collective execution of the habitual operation cluster or execution of the macro of the habitual operation cluster, without being conscious of whether or not the operation performed by the user is included in the habitual operation cluster.

Also, even if the user fails to remember the phrase to be used when conducting execution of a habitual operation cluster registered as a macro, the user can read the corresponding macro by performing an operation the user remembers. Thus, the user can conduct execution of the macro even if he/she fails to remember the phrase.

Note that, in a case where the operation performed by the user is the top operation of a plurality of habitual operation clusters, the habitual operation cluster operated most recently may be suggested, or a plurality of habitual operation clusters may be presented so that the user can select from among the presented operations.

Alternatively, in a case where some other operation is performed, it may be determined in step S115 or S119 that an instruction to collectively execute the habitual operation cluster including the detected top operation has not been issued, or a macro execution instruction has not been issued, and the display of the suggestion image CF11 or CF12 for collective execution or macro conversion may be immediately erased.

Further, if it is determined in step S115 that an instruction to collectively execute the habitual operation cluster including the detected top operation has not been issued, or if it is determined in step S119 that a macro execution instruction has not been issued, there is a high possibility that the corresponding habitual operation cluster is a habitual operation cluster that does not need collective execution or macro execution, and therefore, the corresponding habitual operation cluster may be deleted from the habitual operation cluster storage unit 55.

When the habitual operation cluster is deleted from the habitual operation cluster storage unit 55 as above, collective execution suggestion and macro conversion suggestion are no longer made during a predetermined period of time after the deletion. However, if a plurality of similar operations is habitually repeated, these operations are registered again as a habitual operation cluster.

As a result, after the predetermined period of time has passed, collective execution or macro conversion is suggested again, and the user can recognize that the plurality of similar operations is registered as a habitual operation cluster.

Meanwhile, as for deletion of a habitual operation cluster, a habitual operation cluster that has been temporarily deleted may be temporarily stored until a predetermined time has passed or until the user separately performs a deletion operation. In this manner, the habitual operation cluster can be reused.

<Example in Which Collective Execution of a Habitual Operation Cluster Including Keywords Having a High Degree of Coincidence with Keywords Uttered by the User is Suggested>

In the example described above, in a case where the user's operation is the top operation of a registered habitual operation cluster, collective execution of the habitual operation cluster or execution of the corresponding macro is suggested.

However, collective execution of a habitual operation cluster including keywords having a high degree of coincidence with keywords uttered by the user (keywords having a higher degree of coincidence than a predetermined degree of coincidence), or execution of the corresponding macro may also be suggested.

The operation storage execution control unit 53 monitors utterances of the user, detects uttered keywords, for example, and searches for a habitual operation cluster including keywords having a high degree of coincidence with the detected keywords.

More specifically, the operation storage execution control unit 53 extracts keywords from an utterance of the user by morphological analysis, calculates the degrees of keyword coincidence between the extracted keywords and keywords in the operation text in habitual operation clusters, and searches for the habitual operation cluster including the keyword having the highest degree of coincidence.

A degree of keyword coincidence is calculated by an arithmetic operation expressed by Equation (5) shown below, for example.

M_{c}=N_{c}/Nᵤ (5)

Here, M_{c} represent the degree of keyword coincidence, Nᵤ represents the number of keywords extracted from the user's utterances, and N_{c} represents the number of keywords matched with the operation text in the habitual operation clusters among keywords uttered by the user.

After detecting the habitual operation cluster including the keyword having the highest degree of keyword coincidence on the basis of the keyword coincidence M_{c} calculated according to Equation (5), the operation storage execution control unit 53 suggests collective execution of the detected habitual operation cluster or execution of corresponding macro.

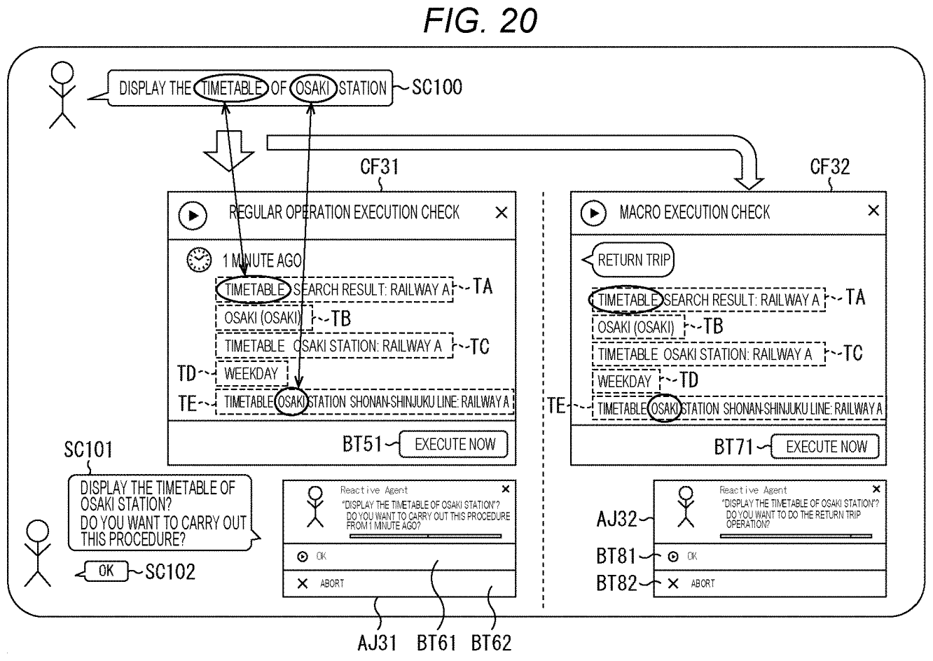

More specifically, as shown in FIG. 20, in a case where the user has uttered “Display the timetable of Osaki Station”, for example, the operation storage execution control unit 53 detects uttered keywords included in the utterance content in a process SC100, and searches for a habitual operation cluster including keywords having a high degree of coincidence with the detected uttered keywords.

After detecting a habitual operation cluster having a high degree of coincidence, the operation storage execution control unit 53 causes display of a suggestion image CF31 as shown in the upper left portion of FIG. 20, for example, in a case where the detected habitual operation cluster is not registered as a macro, for example.

In the suggestion image CF31, “REGULAR OPERATION EXECUTION CHECK” is written at the top, indicating that this is an image that suggests collective execution of the detected habitual operation cluster including keywords having a high degree of coincidence.

Below that, “1 minute ago” is also written, indicating that the detected habitual operation cluster is operations from one minute ago, and further below that, operations TA to TE are written as the operations constituting the detected habitual operation cluster.

Here, the operation TA is written as “Timetable Search result: Railway A”, indicating that this is an operation to display a page of the timetable of the railway A as a search result.

The operation TB is written as “OSAKI (Osaki)”, indicating that this is an operation to input “OSAKI” as the station name for displaying the timetable on the page displayed by the operation TA.

The operation TC is written as “Timetable Osaki Station: Railway A”, indicating that this is an operation to display, as a search result, the page of the timetable at Osaki Station of Railway A.

The operation TD is written as “Weekday”, indicating that this is an operation to select “Weekday” from the timetable displayed by the operation TC.

The operation TE is written as “Timetable Osaki Station Shonan-Shinjuku Line: Railway A”, indicating that this is an operation to display, as a search result, the page of the timetable of Shonan-Shinjuku Line at Osaki Station of Railway A.

Here, the operations TA and TE include the keywords having a high degree of coincidence with the uttered keywords that are “Timetable” and “Osaki”, respectively.

Note that, in the case shown in FIG. 20, the keywords extracted from the utterance in the process SC100 are “Osaki” and “Timetable”, and accordingly, Nᵤ=2. Also, either of the keywords is included in the habitual operation cluster, and accordingly, N_{c}=2.

As a result, the degree of keyword coincidence in the case shown FIG. 20 is M_{c}=1 (=N_{c}/Nᵤ=2/2).

Below the operations TA to TE, a button BT51 that is written as “EXECUTE NOW” and is operated when a detected habitual operation cluster is to be collectively executed is displayed.

When the button BT51 is operated, the operation storage execution control unit 53 displays an inquiry display field AJ31 for collectively executing the habitual operation cluster including the keywords having a high degree of coincidence, and outputs an inquiry voice, as shown in the lower left portion of FIG. 20.

In the display field AJ31, “Proactive Agent” is written at the top, indicating that this is an inquiry from a voice agent. Below that, ““Display the timetable of Osaki. Station”? Do you want to carry out this procedure from 1 minute ago?” is written, indicating that an inquiry as to whether or not to collectively execute the habitual operation cluster including the keywords having a high degree of coincidence is being made.

Further, below that, a button BT61 that is written as “OK” and is operated when a collective operation instruction is to be issued, and a button BT62 that is written as “ABORT” and is operated when the collective operation instruction is to be stopped are displayed.

Also, at the same time, in a process SC101, the operation storage execution control unit 53 outputs an inquiry voice for inquiring whether or not to collectively execute the habitual operation cluster including the keywords having a high degree of coincidence, through the audio guidance “Display the timetable of Osaki Station? Do you want to carry out this procedure?”.

When the user utters “OK” in response to this, for example, the operation storage execution control unit 53 recognizes that an instruction to collectively execute the habitual operation cluster including the keywords having a high degree of coincidence has been issued in a process SC102, and performs collective execution.

In a case where the habitual operation cluster including the keywords having a high degree of coincidence is registered as a macro, on the other hand, the operation storage execution control unit 53 displays a suggestion image CF32 as shown in the upper right portion FIG. 20, for example.

In the suggestion image CF32, “MACRO EXECUTION CHECK” is written at the top, and an image that suggests execution of the macro associated with the habitual operation cluster whose top operation has been detected is displayed.

Further below that, “Return trip” is written, indicating the registered phrase associated with the macro formed with the habitual operation cluster including the keywords having a high degree of coincidence. Below that, the operations TA to TE are written as the operations constituting the macro-registered habitual operation cluster including the keywords having a high degree of coincidence.

Below the operations TA to TE, a but BT71 that is written as “EXECUTE NOW” and is operated when a macro registered as a detected habitual operation cluster is to be executed is displayed.

When the button BT71 is operated, the operation storage execution control unit 53 displays an inquiry display field AJ32 for executing the macro registered as the habitual operation cluster whose top operation has been performed, and outputs an inquiry voice, as shown in the lower right portion of FIG. 20.

In the display field AL “Proactive Agent” is written at the top, indicating that this is an inquiry from a voice agent. Below that, ““Display the timetable of Osaki Station”? Do you want to do the return trip operation?” is written, indicating that an inquiry as to whether or not to collectively execute the habitual operation cluster that is registered as a macro and includes the keywords having a high degree of coincidence is being made.

Further, below that, a button BT81 that is written as “OK” and is operated when a macro execution instruction is to be issued, and a button BT82 that is written as “ABORT” and is operated when the macro execution instruction is to be stopped are displayed.

In the above process, in a case where there is an utterance of the user, collective execution the habitual operation cluster including keywords having a high coincidence with the uttered keywords, or execution of the registered macro is suggested.

<Process of Suggesting Collective Execution of a Habitual Operation Cluster Having a High Degree of Coincidence with Keywords Uttered by the User>

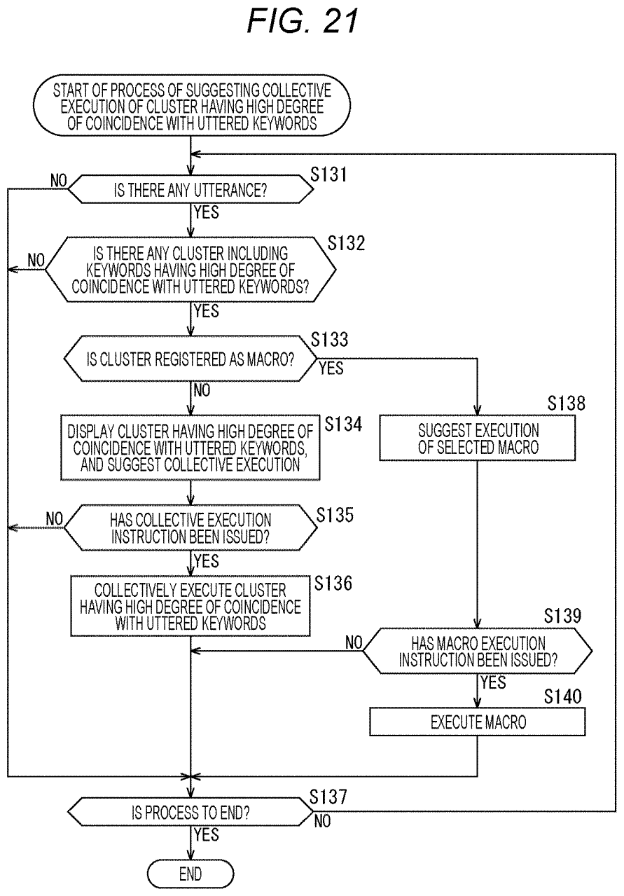

Next, a process of suggesting collective execution of a habitual operation cluster having a high degree of coincidence with user uttered keywords, which is the process described above with reference to FIG. 20, is now described with reference to a flowchart shown in FIG. 21.

In step S131, the operation storage execution control unit 53 determines whether or not there is an utterance by the user.

If it is determined in step S131 that there is an utterance by the user, the process moves on to step S132.

In step S132, the operation storage execution control unit 53 searches for a habitual operation cluster including keywords having a high degree of coincidence with the uttered keywords (keywords having a higher degree of coincidence than a predetermined degree of coincidence) from among the habitual operation clusters stored in the habitual operation cluster storage unit 55, and determines the presence/absence of such a habitual operation cluster.

If it is determined in step S132 that there is a habitual operation cluster including keywords having a high degree of coincidence with the uttered keywords, the process moves on to step S133.

In step S133, the operation storage execution control unit 53 determines whether or not the detected habitual operation cluster including keywords having a high degree of coincidence with the uttered keywords is registered as a macro.

If it is determined in step S133 that the habitual operation cluster including keywords having a high degree of coincidence with the uttered keywords is not registered as a macro, the process moves on to step S134.

In step S134, the operation storage execution control unit 53 displays the suggestion image CF31 shown in FIG. 20, for example, to suggest collective execution of the habitual operation cluster including keywords having a high degree of coincidence with the uttered keywords.

In step S135, the operation storage execution control unit 53 determines whether or not a collective execution instruction has been issued by the user operating the button BT51 in FIG. 20 or the like, for example.

If it is determined in step S135 that a collective execution instruction has been issued by the user, the process moves on to step S136.

In step S136, the operation storage execution control unit 53 causes collective execution of a plurality of operations of the habitual operation cluster for which collective execution has been suggested.

In step S137, the operation storage execution control unit 53 determines whether or not a process end instruction has been issued. If any end instruction has not been issued, the process returns to step S131.

If it is determined in step S137 that an end instruction has been issued, the process then comes to an end.

If it is determined in step S133 that the habitual operation cluster including keywords having a high degree of coincidence with the uttered keywords is registered as a macro, the process moves on to step S138.

In step S138, the operation storage execution control unit 53 displays the suggestion image CF32 shown in FIG. 20, for example, to suggest execution of the macro registered as the habitual operation cluster including keywords having a high degree of coincidence with the uttered keywords.

In step S139, the operation storage execution control unit 53 determines whether or not a macro execution instruction has been issued by the user operating the button BT71 in FIG. 20 or the like, for example.

If it is determined in step S139 that a macro execution instruction has been issued by the user, the process moves on to step S140.

In step S140, the operation storage execution control unit 53 executes the macro for which execution has been suggested.

On the other hand, if it is determined in step S131 that there are no utterances, if it is determined in step S132 that no habitual operation clusters including keywords having a high degree of coincidence with the uttered keywords has been detected, if it is determined in step S135 that an instruction to collectively execute the habitual operation cluster including keywords having a high degree of coincidence with the uttered keywords has not been issued, or if it is determined in step S139 that any macro execution instruction has not been issued, the process moves on to step S137.

In the above process, in a case where there is an utterance of the user, collective execution the habitual operation cluster including keywords having a high coincidence with the uttered keywords, or execution of the registered macro is suggested.

As a result, even in a state where the user does not accurately remember the operations of the registered habitual operation cluster, the user simply has to utter keywords to conduct collective execution of the habitual operation cluster including keywords having a high degree of coincidence with the uttered keywords, or execution of the macro of the habitual operation cluster, without being conscious of the relationship between his/her own utterance and the habitual operation cluster.

As a result, the user can cause execution of a habitual operation cluster including keywords having a high degree of coincidence with uttered keywords or execution or a macro, simply by uttering the keywords indicating the content to be collectively executed.

Note that, in the example described above, collective execution of the habitual operation cluster including keywords having the highest degree of coincidence, or macro execution is suggested. However, all the habitual operation clusters including keywords having higher degrees of coincidence than a predetermined threshold may be extracted, be arranged in descending order of coincidence or in chronological order or the like, and be presented to the user.

With such a presentation, the user may be enabled to select the habitual operation cluster to be collectively executed or subjected to macro execution, from among a plurality of habitual operation clusters that have higher degrees of coincidence with uttered keywords than a predetermined value, and are presented in order of coincidence or in chronological order.

Further, text information for matching with uttered keywords may be set as a tag in each habitual operation cluster by a GUI operation performed on each habitual operation cluster or the macro display screen.

<Another Example Presentation of a Habitual Operation Cluster Including a Keyword Having a High Degree of Coincidence with an Uttered Keyword>

In the example described above, in a case where there is the user's utterance, the habitual operation cluster including keywords having a high degree of coincidence with the uttered keywords is displayed as the suggestion image CF31 or CF32, and collective execution or macro conversion is suggested. However, the presentation may be made by some other method.

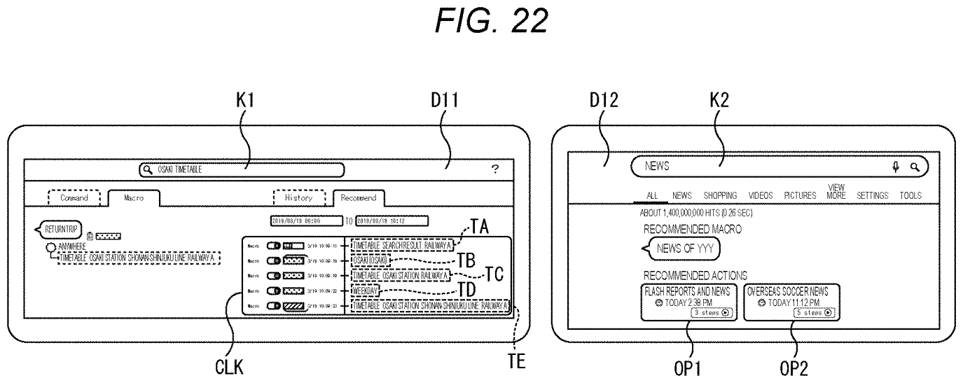

For example, as shown by an image D1 that is the GUI of the user history display mode in the left portion of FIG. 22, keywords may be input to a keyword input field K1, and a habitual operation cluster including keywords having a high degree of coincidence with the input keywords may be presented.

In the image D1, “Osaki” and “Timetable” are input as keywords to the input field K1, and a habitual operation cluster CLK is displayed as the habitual operation cluster including keywords having a high degree of coincidence with the keywords input to the input field K1.

Further, a button for executing the corresponding habitual operation cluster on the basis of the input keywords may be displayed in an input field to which a search keyword is input at a time of searching with a browser.

Specifically, in the right portion of FIG. 22, when a keyword “News” is input to a search keyword input field K2 of the browser, buttons OP1 and OP2 for executing the habitual operation cluster or macro including a keyword having a high degree of coincidence with the keyword “news” are displayed.

When the button OP1 or OP2 is operated, collective execution of the habitual operation cluster including a keyword having a high degree of coincidence with the keyword “news” may be enabled.

In the right portion of FIG. 22, the button OP1 written as “Flash reports and news” and the button OP2 written as “Overseas soccer news”, which are operated when a habitual operation cluster including a keyword having a high degree of coincidence with an uttered keyword is to be executed, are displayed.

In either case, the habitual operation cluster or the macro including a keyword having a high degree of coincidence with an input keyword is displayed. Accordingly, even if the user fails to remember the phrase associated with the macro, he/she can collectively execute the habitual operation cluster or execute the macro simply by inputting a keyword associated with the habitual operation cluster to be collectively operated or the macro, without being conscious of habitual operations.

<Example Process (1) in a Case Where an Error Occurs in Collective Execution of a Habitual Operation Cluster>

Next, a process to be performed in a case where an error occurs in collective execution of a habitual operation cluster is described.

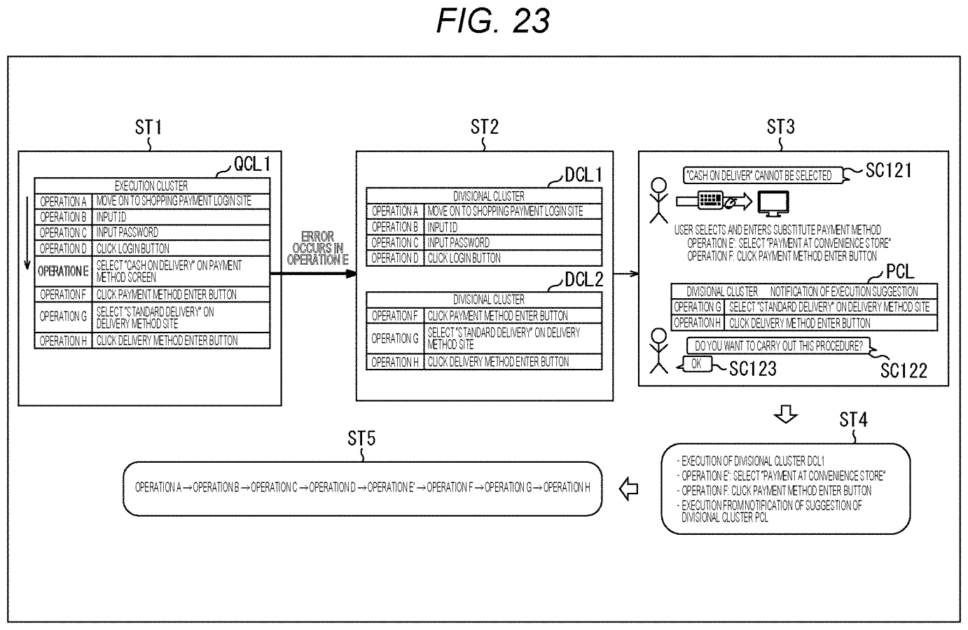

For example, a habitual operation cluster formed with operations A to H shown in a state ST1 in FIG. 23 is executed. Note that the habitual operation cluster formed with the operations A to H shown in the state ST1 will be hereinafter referred to as an execution cluster QCL1.

In the execution cluster QCL1, the operation A is an operation to move on to a shopping payment login site, the operation B is an operation to input an ID, the operation C is an operation to input a password, the operation D an operation to click a login button, the operation E is an operation to select “cash on delivery” on a payment method screen, the operation F is an operation to click a payment method enter button, the operation G is an operation to select “standard delivery” on a delivery method site, and the operation H is an operation to click a delivery method enter button.

Here, in a case where the execution cluster QCL1 formed with the operations A to H indicated in the state ST1 is collectively executed, when the operation E is performed, an error might occur due to abolishment of the payment method “cash on delivery”, for example.

In such a case, the operations after the operation E cannot be performed.

Therefore, the operation storage execution control unit 53 divides the execution cluster QCL1 into a divisional cluster DCL1 formed with The operations A to D, which are the operations to be performed before the operation E, and a divisional cluster DCL2 formed with the operations F to H, as shown in a state ST2 in FIG. 23.

However, since a habitual operation cluster must include three or more operations, divisional clusters can be formed only in a case where each divisional cluster includes three or more operations.

After collectively executing the divisional cluster DCL1, the operation storage execution control unit 53 then presents the error cause “Cash on delivery cannot be selected” to the user in a process SC121, as shown in a state ST3.

In response to such a presentation, the user performs an operation E′ to select “payment at convenience store”, instead of the operation E, for example, and further performs the operation F, which is an operation to click the payment method enter button.

By recognizing that the operation F has been performed, the operation storage execution control unit 53 recognizes that the top operation of the divisional cluster DCL2 has been performed. The operation storage execution control unit 53 then presents a divisional cluster PCL formed with the operation G and the operation H, which are to be performed after the operation F of the divisional cluster DCL2, and suggests execution of the divisional cluster PCL in a process SC122 shown as “Do you want to carry out this procedure?”.

When the user utters “OK” in response to this, the operation storage execution control unit 53 recognizes, from this utterance, an instruction to execute the divisional cluster PCL formed with the operation G and the operation H in a process SC123, and then execute the divisional cluster PCL.

Thereafter, in a case where the user habitually performs an operation that is the operation E′ replacing the operation E, the operation storage execution control unit 53 repeats execution of the divisional cluster DCL1, the operation E′ to select “payment at convenience store”, the operation F to click the payment method enter button, and the process of suggesting the divisional cluster PCL, as shown in a state ST4.

As the operations in the state ST4 are repeatedly performed to gradually increase the respective habituation scores, the operations in the state ST4 are registered as a habitual operation cluster. Accordingly, a habitual operation cluster substantially formed with the operation A, the operation B, the operation C, the operation D, the operation E′, the operation F, the operation G, and the operation H as shown in a state ST5 is registered.

In the above series of processes, even if an error occurs in an operation in a plurality of operations registered as a habitual operation cluster, the operations before and after the occurrence of the error are set as divisional clusters. After a substitute operation in place of the operation having the error is set, a plurality of operations including the substitute operation is repeatedly performed, and thus, is registered as a new habitual operation cluster.

As a result, it becomes possible to register a habitual operation cluster in which an operation is set in place of an operation having an error.

<Example Process (2) in a Case Where an Error Occurs in Collective Execution of a Habitual Operation Cluster>

Next, another process to be performed in a case where an error occurs in collective execution of a habitual operation cluster is described.

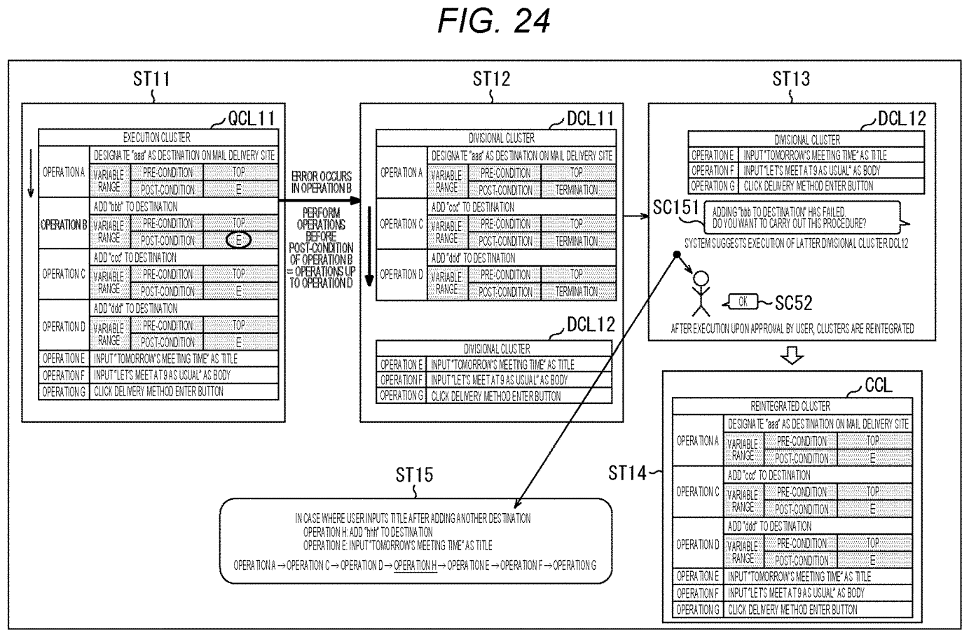

For example, a habitual operation cluster formed with operations A to G shown in a state ST11 in FIG. 24 is the cluster to be executed. Note that the habitual operation cluster formed with the operations A to C shown in the state ST11 in FIG. 24 will be hereinafter referred to as an execution cluster QCL11.

In the execution cluster QCL11, the operation A is an operation to designate “aaa” as a destination on a mail delivery site, the operation B is an operation to add “bbb” to the destination, the operation C is an operation to add “ccc” to the destination, the operation D is an operation to add “ddd” to the destination, the operation E is an operation to input a title “tomorrow's meeting time”, the operation F is an operation to input “let's meet at 9 as usual” as the body, and the operation G is an operation to click a delivery method enter button.

Here, the operations A to D are order-variable operations, the pre-condition for the variable range is the top in each operation, and the post-condition is set as the operation E.

In a case where the execution cluster QCL11 formed with the operations A to G shown in the state ST11 is collectively executed, when the operation B is performed, for example, an error might occur due to deletion of “bbb” from the address book information.

In such a case, the operations after the operation B cannot be performed.

Therefore, the operation storage execution control unit 53 divides the execution cluster QCL11 into a divisional cluster DCL11 formed with the operations A, C, and D, which are the operations to be performed before the operation E, and a divisional cluster DCL12 formed with the operations E to G, as shown in a state ST12 in FIG. 24.

Here, since all the operations A to D are order-variable operations, the operation A, the operation C, and the operation D, which are the operations up to the operation D before the post-condition of the operation B having the error are set as one divisional cluster SCL11.

As for the variable range at this point of time, the pre-condition is the top operation, and the post-condition is the termination operation in any of the operation A, the operation C, and the operation D.

After collectively executing the divisional cluster DCL11, the operation storage execution control unit 53 then presents the divisional cluster DCL12 as shown in a state ST13, and suggests execution of the divisional cluster DCL12 in a process SC151 shown as “Adding “bbb” to the destination has failed. Do you want to carry out this procedure?”.

When the user utters “OK” in response to this, the operation storage execution control unit 53 recognizes, from this utterance, an instruction to execute the divisional cluster DCL12 formed with the operations E to G in a process SC152, and execute the divisional cluster DCL12.

After that, the operation storage execution control unit 53 reintegrates the divisional clusters DCL11 and DCL12, and collectively executes a reintegrated cluster CCL, as shown in a state ST14.

Further, a case where an operation H to add “hhh” to the destination is performed after the suggestion of execution of the divisional cluster DCL12 in the state ST13, and the operation E to input the title “tomorrow's meeting time” is further performed as shown in a state S115 is now described.

In this case, when recognizing that the top operation of the divisional cluster DCL12 has been performed by recognizing that the operation E has been performed, the operation storage execution control unit 53 suggests execution of the operation F and the operation G, which are the subsequent operations in the divisional cluster DCL12. Here, when execution of the operation F and the operation G is approved by the user, the operation F and the operation G are performed.

Thereafter, when the user habitually repeats the divisional cluster DCL11, the operation H, the operation E, the operation F, and the operation G, the habituation scores gradually become higher, and the series of a plurality of operations are registered as a habitual operation cluster.

As a result, a new habitual operation cluster formed with the operation A, the operation C, the operation D, the operation H, the operation E, the operation F, and the operation G is registered, as shown in the state ST15.

In the above series of processes, even if an error occurs in an operation in a plurality of operations registered as a habitual operation cluster, the operations before and after the occurrence of the error are set as divisional clusters, and only the divisional clusters are executed. Alternatively, after a substitute operation in place of the operation having the error is set, a plurality of operations including the substitute operation is then repeatedly performed, and thus, is registered as a new habitual operation cluster.

As a result, it becomes possible to register a new habitual operation cluster in which an operation is set in place of an operation having an error.

<Example Process (3) in a Case Where an Error Occurs in Collective Execution of a Habitual Operation Cluster>

Next, yet another process to be performed in a case where an error occurs in collective execution of a habitual operation cluster is described.

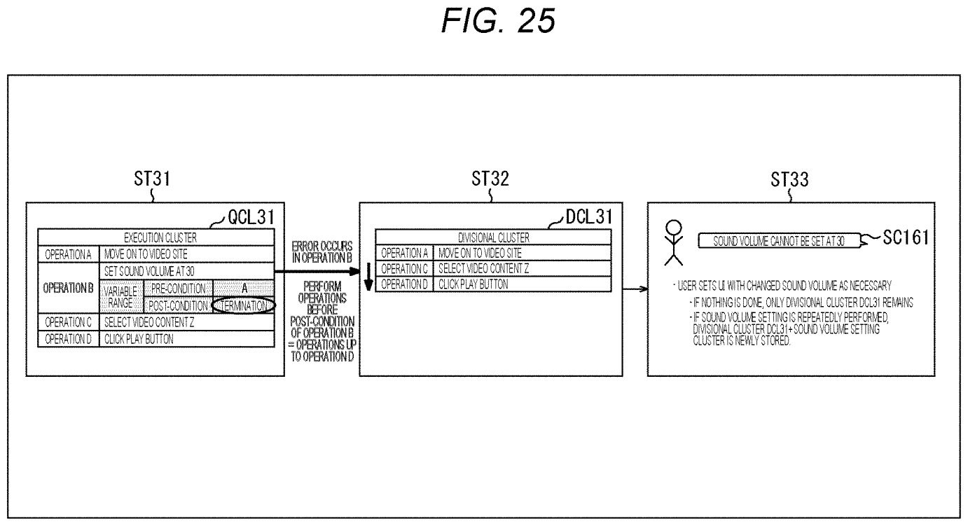

For example, a habitual operation cluster formed with operations A to D shown in a state ST31 in FIG. 25 is the cluster to be executed. Note that the habitual operation cluster formed with the operations A to D shown in the state ST31 in FIG. 25 will be hereinafter referred to as an execution cluster QCL31.

In the execution cluster QCL31, the operation A is an operation to move on to a video site, the operation B is an operation to set the sound volume at 30, the operation C is an operation to select video content Z, and the operation D is an operation to click the play button.

Here, the operation B is an order-variable operation, the pre-condition for the variable range is the operation A, and the post-condition is the termination operation.

In a case where the execution cluster QCL31 formed with the operations A to D shown in the state ST31 is collectively executed, when the operation B is to be performed, the operation B cannot be performed due to a change in a voice setting user interface (UI), for example, and an error occurs.

In such a case, the operations after the operation B cannot be performed.

Therefore, the operation storage execution control unit 53 divides the execution cluster QCL31 into a divisional cluster DCL31 formed with the operation A, the operation C, and the operation D, which are the operations before the termination operation, as shown in a state ST32 in FIG. 25.

Here, since the operation B is an order-variable operation, the operation A, the operation C, and the operation D up to the termination operation before the post-condition of the operation B having the error are set as one divisional cluster SCL31. Because there are no operations after the operation B having the error in this case, any divisional cluster including an unexecuted operation is not generated.

After collectively executing the divisional cluster DCL31, the operation storage execution control unit 53 then presents the error “Sound volume cannot be set at 30” in a process SC161, as shown in a state ST33.

If any sound volume setting operation is not performed thereafter, execution of the divisional cluster DCL31 is repeated, so that the divisional cluster DCL31 is newly registered as a regular habitual operation cluster.

In a case where the operation E to set the sound volume with the changed voice setting UI is performed, on the other hand, the divisional cluster DCL31 and the operation E are repeated, so that a plurality of operations each formed with the divisional cluster DCL31 and the operation E is newly registered as a regular habitual operation cluster.

In the above series of processes, even if an error occurs in an operation in a plurality of operations registered as a habitual operation cluster, the operations excluding the operation having the error is set as a divisional cluster, and only the divisional cluster is executed. Alternatively, after the operation to be added to the divisional cluster is set, a plurality of operations including the added operation is then repeatedly performed, and thus, is registered as a new habitual operation cluster.

As a result, it becomes possible to newly register a habitual operation cluster to which a new operation has been added as necessary, excluding an operation in which an error has occurred.

<Error Handling Process>

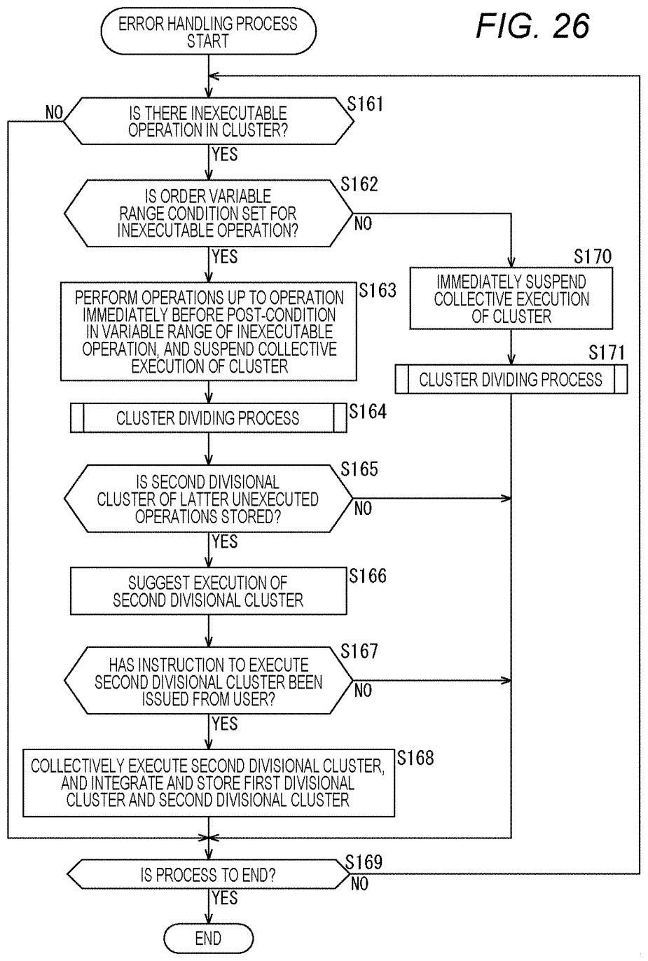

Next, an error handling process is described, with reference to a flowchart shown in FIG. 26. Note that, the description of the error handling process is based on the assumption that one of the regular habitual operation clusters is collectively executed as an execution cluster, or is executed as a macro.

In step S161, the operation storage execution control unit 53 determines whether or not an operation that cannot be performed is generated when a habitual operation cluster is collectively executed or is executed as a macro.

If it is determined in step S161 that there is an operation that cannot be performed, the process moves on to step S162.

In step S162, the operation storage execution control unit 53 determines whether or not an order variable range condition is set for the operation that cannot be performed.

If it is determined in step S162 that the order variable range condition is set for the operation that cannot be performed, the process moves on to step S163.

In step S163, the operation storage execution control unit 53 performs operations up to the operation immediately before the post-condition of the variable range condition of the operation that cannot be performed, and suspends the operations that follow.

In step S164, the operation storage execution control unit 53 performs a cluster dividing process, to divide the execution cluster and generate divisional clusters.

In the cluster dividing process, two divisional clusters, which are a first divisional cluster formed with the former operations in the execution cluster and a second divisional cluster formed with the latter operations in the execution cluster, are basically generated.

However, in a case where the post-condition in the variable range of the operation having an error is the termination operation, there are no unexecuted operations. Therefore, the second divisional cluster as not generated, and only the first divisional cluster is generated in some cases.

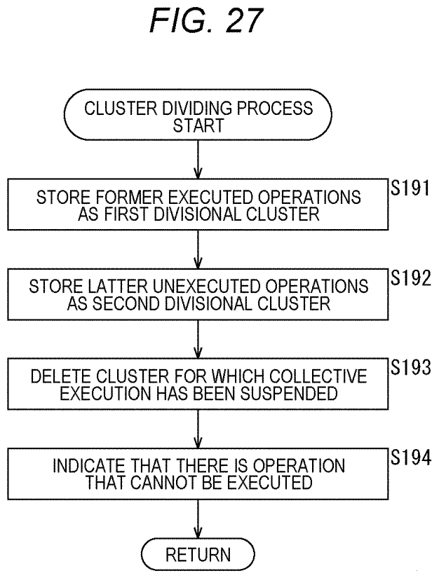

Note that that the cluster dividing process will be described later in detail, with reference to a flowchart shown in FIG. 27.

In step S165, the operation storage execution control unit 53 determines whether or not there is the second divisional cluster formed with the unexecuted operation(s).

If it is determined in step S165 that there is the second divisional cluster formed with the unexecuted operation(s), the process moves on to step S166.

In step S166, the operation storage execution control unit 53 suggests execution of the second divisional cluster.

In step S167, the operation storage execution control unit 53 determines whether or not an execution instruction has been issued in response to the suggestion of execution of the second divisional cluster.

If it is determined in step S167 that an instruction to execute the second divisional cluster has been issued, the process moves on to step S168.

In step S168, the operation storage execution control unit 53 integrates the first divisional cluster and the second divisional cluster, and stores the integrated clusters as a habitual operation cluster.

In step S169, the operation storage execution control unit 53 determines whether or not a process end instruction has been issued.

If it is determined in step S169 that an end instruction has been issued, the process then comes to an end.

If it is determined in step S169 that any process end instruction has not been issued, on the other hand, the process returns to step S161, and the processes that follow are repeated.

If it is determined in step S162 that the order variable range condition is not set for the operation that cannot be performed, on the other hand, the process moves on to step S170.

In step S170, the operation storage execution control unit 53 suspends the operations after the operation that cannot be performed.

In step S171, the operation storage execution control unit 53 executes the cluster dividing process, to divide the execution cluster and generate divisional clusters, and the process moves on to step S169.

Note that, if it is determined in step S165 that the second divisional cluster formed with the unexecuted operation(s) does not exist, or that there is only one divisional cluster, or if it is determined in step S167 that any instruction to execute the second divisional cluster has not been issued, the process moves on to step S169.

In the above process, in a case where a habitual operation cluster is collectively executed, even if an error occurs in one of the operations, divisional clusters are generated before and after the operation in which the error has occurred. A new operation is added to and integrated with the divisional clusters as necessary, and is registered.

As a result, it becomes possible to register a new habitual operation cluster even if an error occurs in an operation during collective execution of a habitual operation cluster.

<Cluster Dividing Process>

Next, the cluster dividing process is described, with reference to a flowchart shown in FIG. 27.

In step S191, the operation storage execution control unit 53 generates a first divisional cluster that is the former divisional cluster of executable operations from the top operation to the operation immediately before as error in an execution cluster. However, since at least three operations must be included in a cluster, the first divisional cluster is not generated in a case where the number of operations is two or smaller.

In step S192, in a case where there is an unexecuted operation after the operation that cannot be performed due to the occurrence of the error, the operation storage execution control unit 53 generates a second divisional cluster that is the latter divisional cluster. Therefore, in a case where there are no unexecuted operations, the second divisional cluster is not generated.

In step S193, the operation storage execution control unit 53 deletes the habitual operation cluster corresponding to the execution cluster, which has not been collectively executed, from the habitual operation cluster storage unit 55.

In step S194, the operation storage execution control unit 53 indicates that there is an operation that cannot be performed due to an error in an operation included in the habitual operation cluster for which a collective execution instruction has been issued.

In the above process, even if an operation that cannot be performed due to an error therein is included in a habitual instruction cluster for which a collective execution instruction has been issued, divisional clusters formed with the operations before and after the operation having the error are generated.

As a result, it becomes possible to leave a divisional cluster formed with error-free operations as a habitual operation cluster. Thus, a divisional cluster formed only with executable operations can be collectively executed.

<Example Process (1) in a Case Where an Operation in the Middle of a Registered Habitual Operation Cluster is Detected>

Next, a process in a case where an operation in the middle of a registered habitual operation cluster is detected is described.

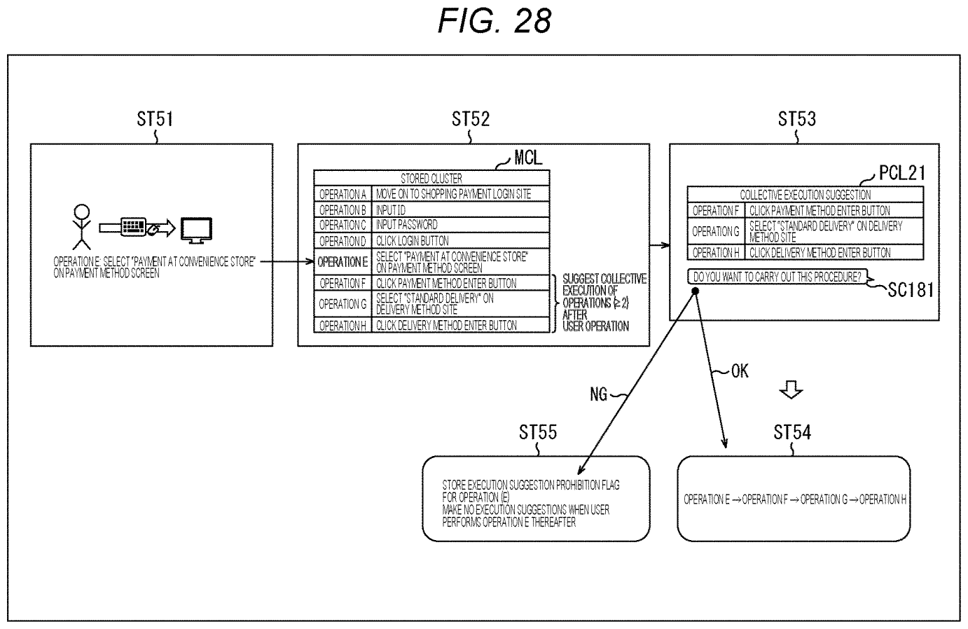

For example, a case where there is a registered habitual operation cluster formed with operations A to H shown in a state ST52 in FIG. 28 is now described.

Hereinafter, the registered habitual operation cluster formed with the operations A to H shown in state ST52 in FIG. 28 will be simply referred to as the stored cluster MCL.

In the stored cluster MCL, the operation A is an operation to move on to a shopping payment login site, the operation B is an operation to input an ID, the operation C is an operation to input a password, the operation D is an operation to click a login button, the operation E is an operation to select “payment at convenience store” on a payment method screen, the operation F is an operation to click a payment method enter button, the operation G is an operation to select “standard delivery” on a delivery method site, and the operation H is an operation to click a delivery method enter button.

Here, a case where the operation E in the stored cluster MCL formed with the operations A to H has been performed as shown in a state ST51 is described.

Here, the operation storage execution control unit 53 reads the operations F to H after the operation E in the stored cluster MCL as shown in the state ST52 in FIG. 28, presents the read operations as a suggestion image PCL21 as shown in a state ST53, and suggests collective execution by the audio guidance “Do you want to carry out this procedure?” in a process SC181.

However, since a habitual operation cluster must include three or more operations including the executed operation E, a collective execution suggestion can be made only in cases where the number of operations after the detected operation is two or larger.

In a case where a collective execution instruction has been issued from the user in response to the collective execution suggestion, the operation storage execution control unit 53 collectively performs the operation F, the operation G, and the operation H.

Thereafter, when the operation E, the operation F, the operation G, and the operation H are repeatedly performed as shown in a state ST54, and the habituation scores become higher than the habituation threshold accordingly, a news habitual operation cluster formed with the operation E, the operation F, the operation G, and the operation H is registered in the habitual operation cluster storage unit 55.

In a case where there is a response indicating that collective execution is not to be performed from the user, on the other hand, the operation storage execution control unit 53 sets an execution suggestion prohibition flag for the operation E as shown in a state ST55, so that collective execution of the operations F to H will not be suggested even when the operation F is performed.

In the above process, when one of the operations included in a registered habitual operation cluster is performed, the processes that follow can be collectively performed with high efficiency, and be registered as a new habitual operation cluster.

<Example Process (2) in a Case Where an Operation in the Middle of a Registered Habitual Operation Cluster is Detected>

Next, another process in a case where an operation in the middle of a registered habitual operation cluster is detected is described.

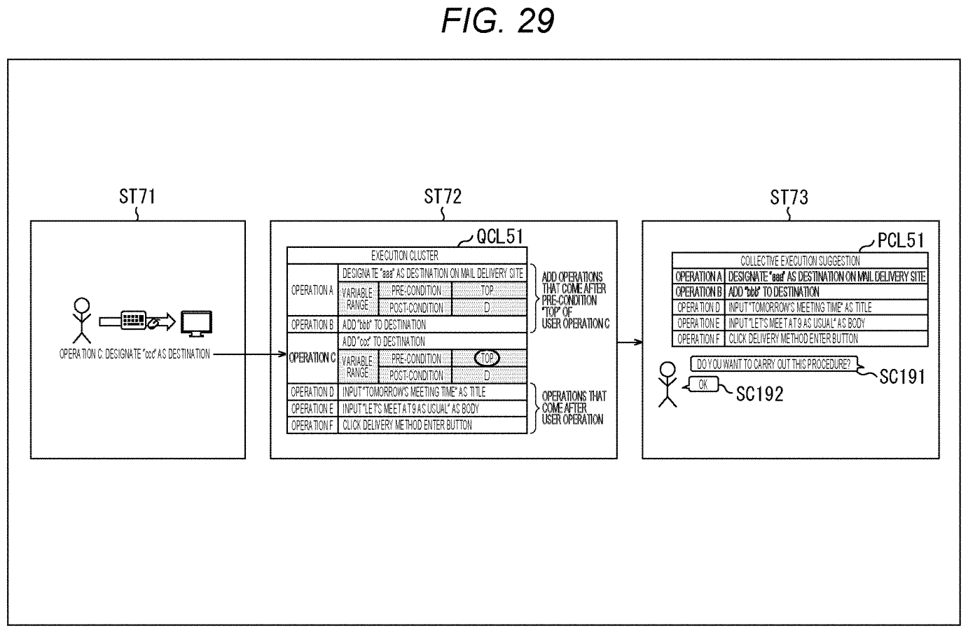

For example, a habitual operation cluster formed with operations A to F shown in a state ST72 in FIG. 29 is the cluster to be executed. Note that the habitual operation cluster formed with the operations A to F shown in the state ST72 in FIG. 29 will be hereinafter referred to as an execution cluster QCL51.

In the execution cluster QC1,51, the operation A is an operation to designate “aaa” as a destination on a mail delivery site, the operation B is an operation to add “bbb” to the destination, the operation C is an operation to add “ccc” to the destination, the operation D is an operation to input a title “tomorrow's meeting time”, the operation B is an operation to input “let's meet at 9 as usual” as the body, and the operation F is an operation to click a delivery method enter button.

Here, a case where the operation C in the execution cluster QCL51 formed with the operations A to F shown in the state ST72 has been performed in the state ST71 is described.

When the execution of the operation C is detected herein, the operation storage execution control unit 53 extracts the operations D to F after the operation C as candidate operations for collective execution, as shown in the state ST72 in FIG. 28.

Further, the operation C performed in a state ST71 is an order-variable operation, the pre-condition of the range is the top operation, and the post-condition is the operation D. Therefore, the operation storage execution control unit 53 additionally extracts the operation A and the operation B, which are the operations after the top operation that is the pre-condition of the operation C, as candidate operations for collective execution.

That is, since the operation C is a variable operation, and the pre-condition of its variable range is the top operation, there is a possibility that the operation C will be the top operation. In that case, the operation A and the operation B can be operations after the operation C, and therefore, are additionally extracted as candidate operations for collective execution.

The operation storage execution control unit 53 then presents a suggestion image PCL51 of the candidate operations for collective execution formed with the extracted operations that are the operation A, the operation B, and the operations D to F, and suggests collective execution by the audio guidance “Do you want to carry out this procedure?” in a process SC191, as shown in a state ST73.

Further, when an instruction to perform the suggested collective execution is issued by the user uttering “OK”, for example, the operation storage execution control unit 53 collectively performs the candidate operations for collective execution formed with the operation A, the operation B, and the operations P to F in a process SC192.

In the above process, when one of the order-variable operations included in a registered habitual operation cluster is performed, operations including those after the operation that is the pre-condition of the range of the order-variable operation can be collectively performed with high efficiency.

<Example Process (3) in a Case Where an Operation in the Middle of a Registered Habitual Operation Cluster is Detected>

In the above described case, the operation C, which is an order-variable operation in the execution cluster QCL51 registered as a registered habitual operation cluster, is performed. However, collective execution of a plurality of other operations can also be suggested in a case where the operation B, which is not an order-variable operation, is performed.

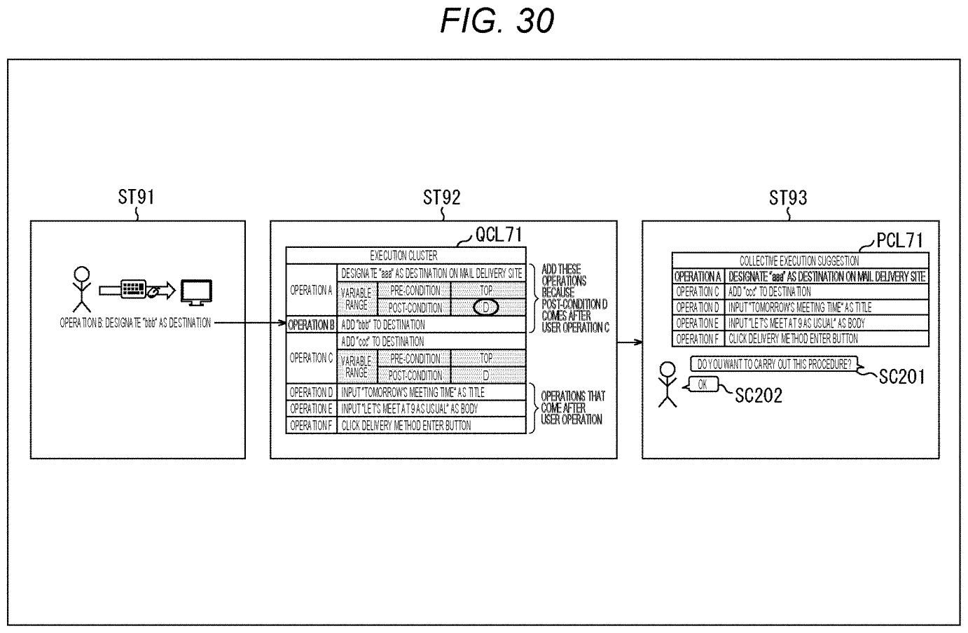

For example, a habitual operation cluster formed with operations A to F shown in a state ST92 in FIG. 30 is the cluster to be executed, and will be hereinafter referred to as an execution cluster QC171. Note that the execution cluster QCL71 in FIG. 30 and the execution cluster QCL51 is the state ST72 in FIG. 29 are formed with the same operations A to F.

Here, a case where the operation B in the execution cluster QCL71 formed with the operations A to F shown in the state ST92 has been performed in the state ST91 is described.

When the execution of the operation B is detected herein, the operation storage execution control unit 53 extracts the operations C to F after the operation B as candidate operations for collective execution, as shown in the state ST92 in FIG. 30.

Further, among the operations before the operation B performed in a state ST91, the operation A is an order-variable operation, and the post-condition of the variable range thereof is the operation D, which is an operation after the operation C. Therefore, the operation storage execution control unit 53 additionally extracts the operation A as a candidate operation for collective execution.

That is, because the post-condition of the variable range of the operation A is the operation D, the operation A can be an operation after the operation C included in the unexecuted operations. Therefore, the operation A is additionally extracted as a candidate operation for collective execution.

The operation storage execution control unit 53 then presents a suggestion image PCL71 of the candidate operations for collective execution formed with the extracted operations that are the operation A and the operations C to F, and suggests collective execution by the audio guidance “Do you want to carry out this procedure?” in a process SC201, as shown in a state ST73.

Moreover, when a collective execution instruction is obtained from the user uttering “OK” in response to the execution suggestion, for example, the operation storage execution control unit 53 collectively executes a plurality of operations that are the operation A and the operations C to F in a process SC202.

In the above process, when one of the order-variable operations included in a registered habitual operation cluster is performed, collective execution can be suggested, with the operations after the operation that is the pre-condition of the variable range of the order-variable operation being taken into consideration.

<Intermediate Operation Handling Process>

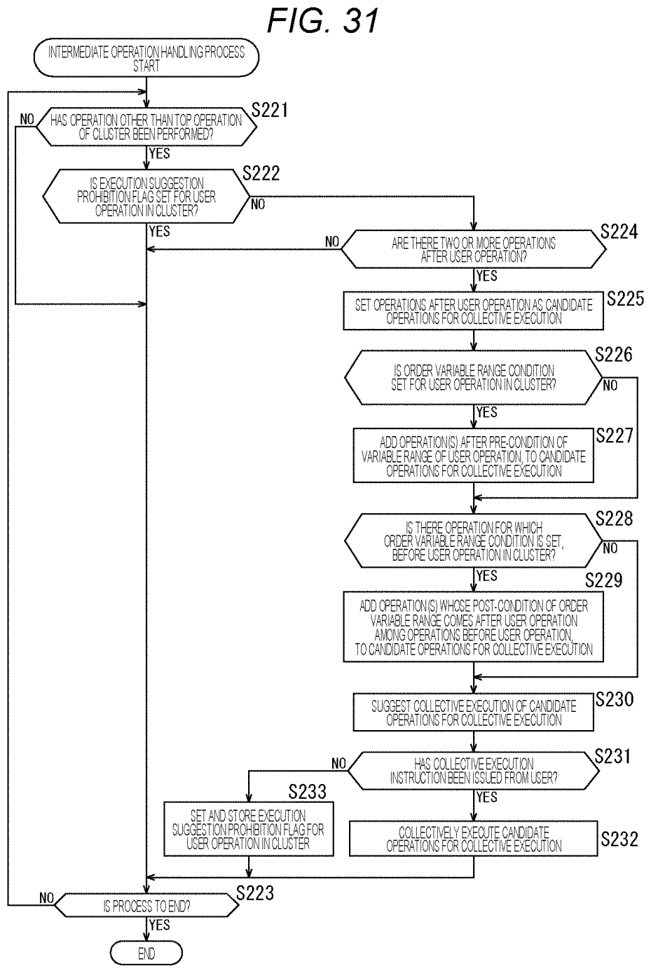

Next, an intermediate operation handling process that is a process to be performed in a case where an operation in the middle of a registered habitual operation cluster is detected is described with reference to a flowchart shown in FIG. 31.

In step S221, the operation storage execution control unit 53 determines whether or not an operation other than the top operations of the habitual operation clusters stored n the habitual operation cluster storage unit 55 has been performed as a user operation.

If it is determined in step S221 that a user operation other than the top operations of the habitual operation clusters stored in the habitual operation cluster storage unit 55 has been performed, the process moves on to step S222.

In step S222, the operation storage execution control unit 53 determines whether or not the execution suggestion prohibition flag is set for the executed user operation that is an operation other than the top operations of the habitual operation clusters.

If it is determined in step S222 that the execution suggestion prohibition flag is set for the user operation, the process moves on to step S223.

That is, in this case, even if a habitual operation cluster including the executed and detected user operation as an operation other than the top operation is detected, a collective execution suggestion is prohibited and therefore, the process related to a collective execution suggestion is ended.

In step S223, the operation storage execution control unit 53 then determines whether or not an instruction to end the process has been issued, and, if an end instruction has been issued, the process comes to an end.

If it is determined in step S223 that any end instruction has not been issued, on the other hand, the process returns to step S221, and the processes that follow are repeated.

If it is determined in step S222 that the execution suggestion prohibition flag is not set for the user operation, the process moves on to step S224.

In step S224, the operation storage execution control unit 53 determines whether or not the number of operations after the user operation in the detected habitual operation cluster is two or larger.

That is, since the number of operations for which collective execution is suggested needs to be two or more operations required for constituting the habitual operation cluster, a check is made to determine whether or not the condition of the number of operations for which collective execution is suggested is satisfied.

If it is determined in step S224 that the number of operations after the user operation in the detected habitual operation cluster is two or larger, the process moves on to step S225.

In step S225, the operation storage execution control unit 53 sets the operations after the user operation in the detected habitual operation cluster, as candidate operations for which collective execution is to be suggested.

In step S226, the operation storage execution control unit 53 determines whether or not the user operation is an order-variable operation in the habitual operation cluster and has its own range condition set.

In a case where the user operation is the operation C that is an order-variable operation as described above with reference to FIG. 29, for example, it is determined in step S226 that the user operation is an order-variable operation in the habitual operation cluster and has its own range condition set, and the process moves on to step S227.

In step S227, the operation storage execution control unit 53 adds the operations after the pre-condition of the variable range of the user operation, to the candidate operations for collective execution.

Note that, if it is determined in step S226 that the user operation is not an order-variable operation in the habitual operation cluster and does not have its own range condition set, the process in step S227 is skipped.

In step S228, the operation storage execution control unit 53 determines whether or not the operations before the user operation include any order-variable operation in the detected habitual operation cluster, and whether or not a range condition is set for that order-variable operation.

In a case where the user operation is the operation B, and the operation A before the user operation is an order-variable operation as described above with reference to FIG. 30, for example, it is determined in step S228 that an order-variable operation is included in the operations before the user operation in the detected habitual operation cluster, and the process moves on to step S229.

In step S229, the operation storage execution control unit 53 adds, to the candidate operations for collective execution, the operation whose post-condition of the order variable condition is an operation after the user operation among the operations before the user operation.

Note that, if it is determined in step S228 that the operations before the user operation do not include any order-variable operation in the detected habitual operation cluster, the process in step S229 is skipped.

In step S230, the operation storage execution control unit 53 presents the candidate operations for collective execution, displays an image that suggests collective execution, and outputs the corresponding audio guidance.

In step S231, the operation storage execution control unit 53 determines whether or not the input operation unit 51 has been operated by the user, and whether or not a collective execution instruction has been issued by voice through the voice input unit 56.

If it is determined in step S231 that a collective execution instruction has been issued, the process moves on to step S232.

In step S232, the operation storage execution control unit 53 causes collective execution of the candidate operations for collective execution.

In step S233, the operation storage execution control unit 53 causes the habitual operation cluster storage unit 55 to register the plurality of operations collectively executed as a new habitual operation cluster.

If it is determined in step S231 that any collective execution instruction has not been issued, on the other hand, the process moves on to step S234.

In step S234, the operation storage execution control unit 53 sets the execution suggestion prohibition flag for the operation corresponding to the user operation in the detected habitual operation cluster.

Note that, if it is determined in step S221 that any user operation other than the top operations of the habitual operation clusters stored in the habitual operation cluster storage unit 55 has not been performed, or if the number of operations after the user operation is determined not to be two or larger in step S224, the process moves on to step S223.

In the above process, in a case where an operation other than the top operations of the registered habitual operation clusters has been performed as a user operation, collective execution of the operations in the habitual operation cluster including the user operation is suggested.

More specifically, in a habitual operation cluster, when a user operation is an order-variable operation, collective execution is suggested for candidate operations for collective execution that are the operations after the user operation and operations after the pre-condition of the variable range of the user operation.

Also, in a habitual operation cluster, when the operations before a user operation includes an order-variable operation, collective execution is suggested for candidate operations for collective execution that are the operations whose post-condition of the variable range of the order-variable operation before the user operation is after the user operation.

As a result, even if a user operation is an operation other than the top operations of the registered habitual operation clusters, the user simply needs to perform the user operation, to present the candidate operations for collective execution in the habitual operation cluster including the user operation, and cause collective execution in response to a reply from the user.

At this point of time, the plurality of collectively executed operations can be registered as a new habitual operation cluster in the habitual operation cluster storage unit 55, and thus, can be treated as a regular habitual operation cluster thereafter.

In a case where any collective execution instruction is not issued in response to the collective execution suggestion, on the other hand, the execution suggestion prohibition flag is set for the user operation, so that a similar collective execution suggesting process will not be repeated even when a similar user operation is detected. Thus, an unnecessary collective execution suggestion to the user can be prevented.

<Utterance Trigger Control Process>

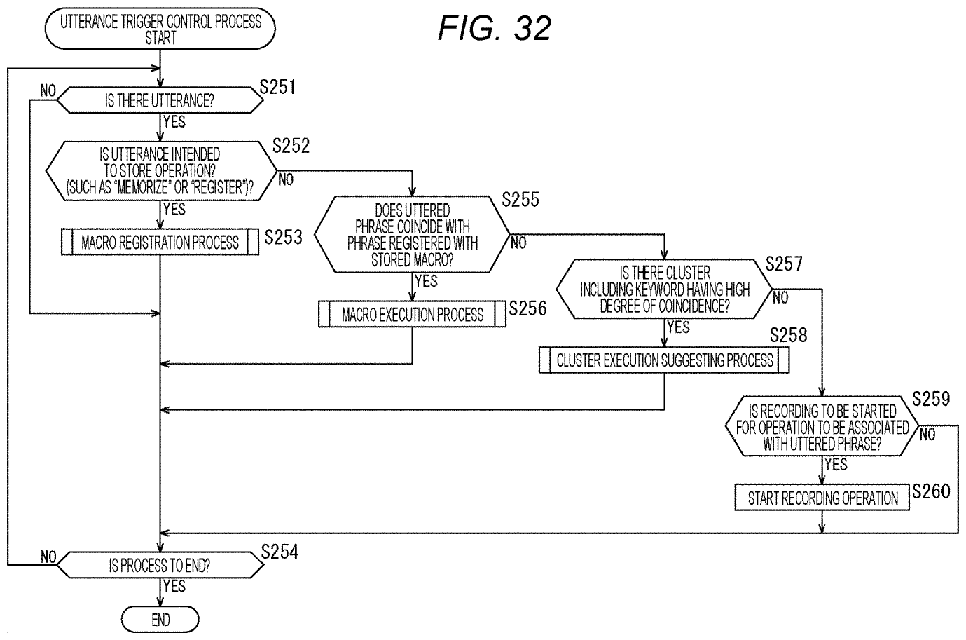

Next, an utterance trigger control process that is a control process to be performed when the above described series of processes are triggered by the user's utterance is described with reference to a flowchart shown in FIG. 32.

In step S251, the operation storage execution control unit 53 determines whether or not a voice has been input by the user's utterance through the voice input unit 56.

If it is determined in step S251 that a voice has been input by an utterance, the process moves on to step S252.

In step S252, the operation storage execution control unit 53 determines whether or not the utterance is “memorize”, “register”, or the like indicating the intention to store operations as a macro, for example.

If it is determined in step S252 that the intention of the utterance is to store operations as a macro, the process moves on to step S253.

In step S253, the operation storage execution control unit 53 performs a macro registration process, and registers a macro associated with the phrase to be used when a habitual operation cluster formed with a plurality of operations is collectively executed.

That is, in this case, the macro registration process is the process described above with reference to the upper left portion and the upper right portion of FIG. 2, or the process of suggesting macro conversion of a habitual operation cluster in response to a voice macro conversion instruction as described above with reference to FIGS. 16 and 17.

In step S254, the operation storage execution control unit 53 determines whether or not an instruction to end the process has been issued, and, if the end instruction has been issued, the process comes to an end.

If it is determined in step S254 that any process end instruction has not been issued, on the other hand, the process returns to step S251, and the processes that follow are repeated.

Note that, if it is determined in step S251 that there are no utterances, the processes in steps S252, S253, and S255 to S260 are skipped, and the processes in steps S251 and S254 are repeated until there is an utterance.

If it is determined in step S252 that the intention of the utterance is not to store operations as a macro, the process moves on to step S255.

In step S255, the operation storage execution control unit 53 determines whether or not the uttered phrase coincides with a phrase registered with a macro.

If it is determined in step S255 that the uttered phrase coincides with a phrase registered with a macro, the process moves on to step S256.

In step S256, the operation storage execution control unit 53 performs a macro execution process, to execute a plurality of operations of the habitual operation cluster registered as the macro associated with the matching phrase.

Here, the macro execution process corresponds to the process described above with reference to the lower portion of FIG. 2.

If it is determined in step S255 that the uttered phrase does not coincide with a phrase registered with a macro, the process moves on to step S257.

In step S257, the operation storage execution control unit 53 determines whether or not there is a habitual operation cluster including a phrase having a high degree of coincidence with the uttered phrase among the habitual operation clusters stored in the habitual operation cluster storage unit 55.

If it is determined in step S257 that there is a habitual operation cluster including a phrase having a high degree of coincidence with the uttered phrase among the habitual operation clusters stored in the habitual operation cluster storage unit 55, the process moves on to step S258.

In step S258, the operation storage execution control unit 53 performs a cluster execution suggesting process, to suggest collective execution of the habitual operation cluster including a phrase having a high degree of coincidence with the uttered phrase.

Here, the cluster execution suggesting process corresponds to the process of suggesting collective execution of a habitual operation cluster having a high degree of coincidence with a keyword uttered by the user as described above with reference to FIGS. 20 and 21, for example.

If it is determined in step S257 that there are no habitual operation clusters including a phrase having a high degree of coincidence with the uttered phrase among the habitual operation clusters stored in the habitual operation cluster storage unit 55, the process moves on to step S259.

In step S259, the operation storage execution control unit 53 determines whether or not an instruction to start recording of the operations to be associated with the uttered phrase has been issued.

If it is determined in step S259 that an instruction to start recording of the operations to be associated with the uttered phrase has been issued, the process moves on to step S260.

In step S260, the operation storage execution control unit 53 starts recording the operations to be associated with the uttered phrase.

If it is determined in step S259 that an instruction to start recording of the operations to be associated with the uttered phrase has been issued, the process in step S260 is skipped. The process in step S259 corresponds to the process shown in the upper left portion of FIG. 2, for example.

In the above series of processes, an utterance makes it possible to start a macro registration process, a macro execution process, a cluster execution suggesting process, and recording of the operations to be registered with an uttered phrase.

<Operation Trigger Control Process>

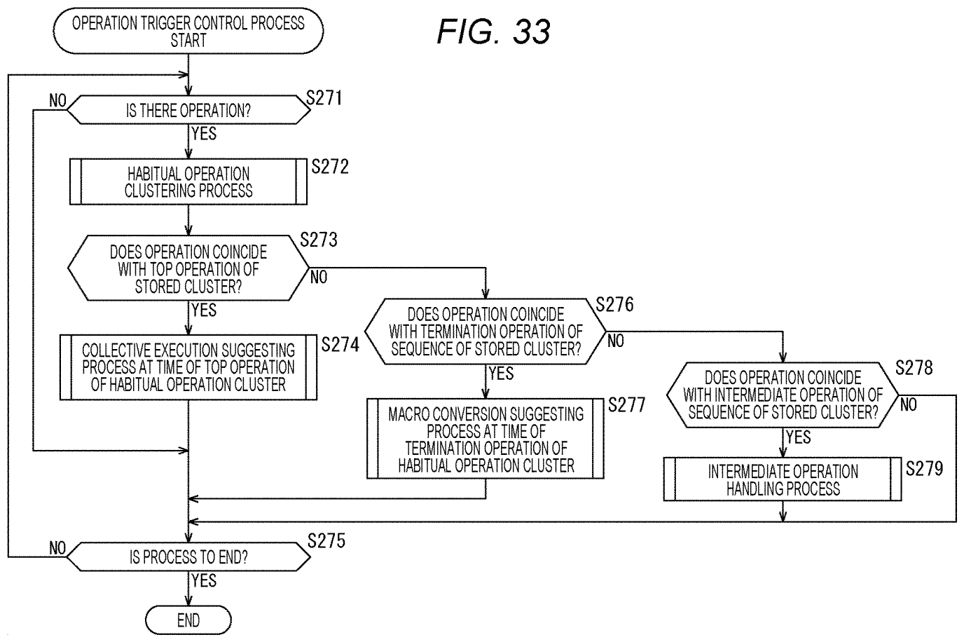

Next, an operation trigger control process that is a control process to be performed when the above described series of processes are triggered by the user's operation is described with reference to a flowchart shown in FIG. 33.

In step S271, the operation storage execution control unit 53 determines whether or not the input operation unit 51 has been operated by the user to input a user operation, depending on the presence/absence of a supply of user operation information.

If it is determined in step S271 that a user operation has been input, the process moves on to step S272.

In step S272, the operation storage execution control unit 53 performs a process corresponding to the habitual operation clustering process described above with reference to FIG. 6, generates a habitual operation cluster, and registers the cluster in the habitual operation cluster storage unit 55.

In step S273, the operation storage execution control unit 53 determines whether or not the user operation is the top operation of a stored habitual operation cluster.

If it is determined in step S273 that the user operation is the top operation of a stored habitual operation cluster, the process moves on to step S274.

In step S274, the operation storage execution control unit 53 performs a process corresponding to the collective execution suggesting process at a time of the top operation of a habitual operation cluster as described above with reference to FIGS. 19 and 20.

In step S275, the operation storage execution control unit 53 determines whether or not an instruction to end the process has been issued. If the end instruction has been issued, the process comes to an end.

If it is determined in step S275 that any process end instruction has not been issued, on the other hand, the process returns to step S271, and the processes that follow are repeated.

Note that, if it is determined in step S271 that any operation has not been input, the processes in steps S272 to S274 and S276 to S270 are skipped, and the processes in steps S271 and S275 are repeated until an operation is input.

If it is determined in step S273 that the input user operation is not the top operation of a stored habitual operation cluster, the process moves on to step S276.

In step S276, the operation storage execution control unit 53 determines whether or not the user operation is the termination operation of a stored habitual operation cluster.

If it is determined in step S276 that the user operation is the termination operation of a stored habitual operation cluster, the process moves on to step S277.

In step S277, the operation storage execution control unit 53 performs a process corresponding to the macro conversion suggesting process at a time of the termination operation of a habitual operation cluster as described above with reference to FIGS. 14 and 15.

If it is determined in step S276 that the user operation is not the termination operation of a stored habitual operation cluster, the process moves on to step S278.

In step S278, the operation storage execution control unit 53 determines whether or not the user operation is an intermediate operation of a stored habitual operation cluster.

If it is determined in step S278 that the user operation is an intermediate operation of a stored habitual operation cluster, the process moves on to step S279.

In step S279, the operation storage execution control unit 53 performs a process corresponding to the intermediate operation handling process described above with reference to FIGS. 28 to 31.

If it is determined in step S278 that the user operation is not an intermediate operation of a stored habitual operation cluster, the process in step S279 is skipped.

In the above series of processes, every time an operation input is detected, a habitual operation clustering process is performed, a habitual operation cluster is registered as necessary, and collective execution of the habitual operation cluster is suggested depending on the top operation, the termination operation, or an intermediate operation of the habitual operation cluster.

As a result, the habitual operation cluster is registered in response to the user operation, and collective execution of the habitual operation cluster is further suggested. Thus, the user can collectively execute a plurality of highly habitual operations, without being conscious of the degrees of his/her habituation with respect to the operations.

In the above process, even if the user does not remember the operations he/she habitually performs, it is possible for the user to receive suggestions of macro registration, collective execution, and macro execution of a plurality of operations that constitute habitual operation clusters generated on the basis of the operation history. Thus, a plurality of highly habitual operations can be collectively performed with ease.

Also, macro registration, collective execution, and macro execution of a habitual operation cluster are suggested in response to the user's operation input. Thus, it is possible to easily perform collective execution even if the user does not remember the habitual operations.

Further, once an unnecessary suggestion is rejected, that suggestion will not be made again because of the execution suggestion prohibition flag. Thus, the user's operations are not hindered by unnecessary suggestions, while necessary execution suggestions are made.

Meanwhile, as for the phrases registered with macros, even in a case where the user's memory becomes blurred over time, or even in a case where the user cannot accurately remember the phrases because the number of registered macros becomes too large, collective execution can be suggested on the basis of habitual operation clusters including keywords having high degrees of coincidence with uttered keywords. Thus, a plurality of highly habitual operations can be collectively executed with high precision in an appropriate manner.

Furthermore, after extended use by the user, habitual operation clusters having high habituation scores are formed. Thus, execution suggestions that suit the habituation unique to the user can be made.

Also, information about habitual operation clusters of a plurality of persons may be shared via a server, a general-purpose habitual operation cluster stored with operations performed by a large number of people may be generated and be used by a large number of people, and collective execution and macro registration of such a general-purpose habitual operation cluster may be suggested.

Further, instead of performing a habitual operation clustering process on all the user operation history, it is possible to set a mode in which recording of the user operation history and clustering are not performed depending on the user setting, as in a secret mode, for example, so that the modes can be switched as necessary.

Meanwhile, because a habitual operation cluster is generated on the basis of a habit of a certain user, the right of use may be limited so that only the user whose user operation history used for generating the habitual operation cluster recorded can use the habitual operation cluster.

For example, secrecy is required for a habitual operation cluster related to authentication such as a password input, and therefore, a restriction may be imposed so that only the user can use the habitual operation cluster.

<<3. Examples in Which Processes Are Carried Out by Software>>

While the above described series of processes can be performed by hardware, those processes can also be performed by software. In a case where the series of processes are performed by software, the program that forms the software may be installed in a computer incorporated into special-purpose hardware, or may be installed from a recording medium into a general-purpose computer or the like that can execute various kinds of functions by installing various kinds of programs, for example.

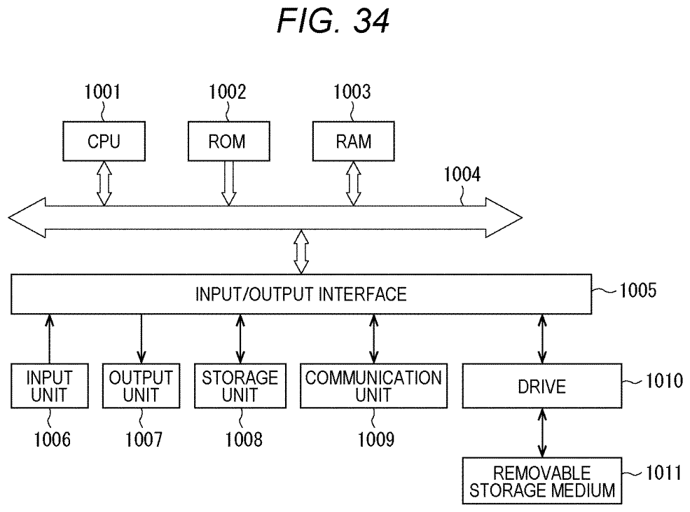

FIG. 34 shows an example configuration of a general-purpose computer. This personal computer includes a central processing unit (CPU) 1001. An input/output interface 1005 is connected to the CPU 1001 via a bus 1004. A read-only memory (ROM) 1002 and a random access memory (RAM) 1003 are connected to the bus 1004.

An input unit 1006, an output unit 1007, a storage unit 1008, and a communication unit 1009 are connected to the input/output interface 1005. The input unit 1006 is formed with an input device such as a keyboard or a mouse through which a user inputs an operation command, the output unit 1007 outputs an image of a process operating screen or a processing result to a display device, the storage unit 1008 is formed with a hard disk drive or the like that stores programs and various kinds of data, and the communication unit 1009 is formed with a local area network (LAN) adapter or the like, and performs a communication process via a network that is typically the Internet. A drive 1010 is also connected to the input/output interface 1005. The drive 1010 performs data reading and writing on a removable storage medium 1011, such as a magnetic disk (such as a flexible disk), an optical disk (such as a Compact Disc-Read-Only Memory (CD-RM or a Digital Versatile Disc (DVD)), a magnetooptical disk (such as Mini Disc (MD)), or a semiconductor memory.

The CPU 1001 performs various processes in accordance with a program that is stored in the ROM 1002, or a program that is read from the removable storage medium 1011, which is a magnetic disk, an optical disk, a magnetooptical disk, a semiconductor memory, or the like, is installed into the storage unit 1008, and is loaded from the storage unit 1008 into the RAM 1003. The RAM 1003 also stores data and the like necessary for the CPU 1001 to perform various processes, as appropriate.

In the computer having the above described configuration, for example, the CPU 1001 loads a program stored in the storage unit 1008 into the RAM 1003 via the input/output interface 1005 and the bus 1004, and executes the program, so that the above described series of processes are performed.

The program to be executed by the computer (the CPU 1001) may be recorded on the removable storage medium 1011 as a packaged medium or the like, for example, and be then provided. Alternatively, the program can be provided via a wired or wireless transmission medium, such as a local area network, the Internet, or digital satellite broadcasting.

In the computer, the program can be installed into the storage unit 1008 via the input/output interface 1005 when the removable storage medium 1011 is mounted on the drive 1010. Also, the program may be received by the communication unit 1009 via a wired or wireless transmission medium, and be installed into the storage unit 1008. Alternatively, the program may be installed beforehand into the ROM 1002 or the storage unit 1008.

Note that the program to be executed by the computer may be a program for performing processes in chronological order in accordance with the sequence described in this specification, or may be a program for performing processes in parallel or performing a process when necessary, such as when there is a call.

Note that the CPU 1001 in FIG. 34 has the functions of the operation storage execution control unit 53 in FIG. 4, and the storage unit 1008 and the removable storage medium 1011 have the functions of the user operation history storage unit 54 and the habitual operation cluster storage unit 55.

Also, in this specification, a system means an assembly of plurality of components (devices, modules (parts), and the like), and not all the components need to be provided in the same housing. In view of this, a plurality of devices that are housed in different housings and are connected to one another via a network forms a system, and one device having a plurality of modules housed in one housing is also a system.

Note that embodiments of the present disclosure are not limited to the above described embodiments, and various modifications may be made to the embodiments without departing from the scope of the present disclosure.

For example, the present disclosure can be embodied in a cloud computing configuration in which one function is shared among devices via a network, and processing is performed by the plurality of devices cooperating with one another.

Further, the respective steps described with reference to the flowcharts described above may be carried out by one device or may be shared among a plurality of devices.

Furthermore, in a case where a plurality of processes is included in one step, the plurality of processes included in the one step may be performed by one device or may be shared among a plurality of devices.

Note that the present disclosure may also be embodied in the configurations described below.

<1> An information processing apparatus including

a control unit that

calculates a habituation score indicating a degree of habituation of a user operation, and

registers a plurality of operations as a habitual operation cluster, the habituation score of the operations being higher than a predetermined threshold.

<2> The information processing apparatus according to <1>, in which

the habituation score is calculated on the basis of a harmonic function of a time interval from a previous operation to a current operation, the number of transitions from the previous operation to the current operation, and a probability of a transition from the previous operation to the current operation.

<3> The information processing apparatus according to <1> or <2>, in which,

when the plurality of operations having the habituation score higher than the predetermined threshold is two or more consecutive operations, the control unit registers the plurality of operations as a habitual operation cluster.

<4> The information processing apparatus according to any one of <1> to <3>, in which,

when each operation is the same in the plurality of operations having the habituation score higher than the predetermined threshold, and there exists a plurality of habitual operation clusters in which an order of the operations varies, the control unit integrates the plurality of habitual operation clusters.

<5> The information processing apparatus according to <4>, in which,

when each operation is the same in the plurality of operations having the habituation score higher than the predetermined threshold, and there exists a plurality of habitual operation clusters in which an order of the operations varies, the control unit sets a variable range of the order of the same operations, and integrates the plurality of habitual operation clusters.

<6> The information processing apparatus according to <5>, in which

the variable range of the order of the same operations is set with a pre-condition that is a condition or an operation immediately before the order of the operations can be changed, and a post-condition that is a condition of an operation immediately after the order change.

<7> An information processing apparatus including

a control unit that collectively executes a habitual operation cluster on the basis of a user operation or a user utterance, the habitual operation cluster having being registered in advance and including a plurality of operations having a higher habituation score than a predetermined threshold, the habituation score indicating a degree of habituation of the user operation.

<8> The information processing apparatus according to <7>, in which

the control unit associates the habitual operation cluster with a phrase obtained from the user utterance, and registers the habitual operation cluster as a macro.

<9> The information processing apparatus accordion to <8>, in which

the control unit associates an operation selected by the user with a phrase obtained from the user utterance among the plurality of operations in the habitual operation cluster, and registers the operation as the macro.

<10> The information processing apparatus according to <8>, in which,

when the habitual operation cluster in which the same operation as the user operation is a termination operation is detected, the control unit suggests registration of the detected habitual operation cluster as a macro, and, when an instruction to register the macro is issued on the basis of the suggestion, registers the habitual operation cluster as the macro.

<11> The information processing apparatus according to <8>, in which,

when an instruction to register the macro is issued by the user utterance, the control unit suggests registration of the macro of the habitual operation cluster including operations up to the most recent operation and the same operation as the user operation, and, when an instruction to register the macro is issued on the basis of the suggestion, the control unit registers the habitual operation cluster as the macro.

<12> The information processing apparatus according to <7>, in which

the control unit suggests collective execution of the habitual operation cluster on the basis of the user operation, and, when a collective execution to is issued in response to the suggestion, collectively executes the habitual operation cluster.

<13> The information processing apparatus according to <12>, in which

the control unit suggests collective execution of the habitual operation cluster in which the same operation as the user operation is a top operation, and, when a collective execution instruction is issued in response to the suggestion, collectively executes the habitual operation cluster.

<14> The information processing apparatus according to <13>, in which,

when the habitual operation cluster in which the same operation as the user operation is the top operation is registered as a macro, the control unit suggests execution of the macro, and, when an instruction to execute the macro is issued on the basis of the suggestion, executes the macro.

<15> The information processing apparatus according to <12>, in which

the control unit suggests collective execution of the habitual operation cluster in which the same operation as the user operation is an operation other than the top operation, and, when a collective execution instruction. Issued in response to the suggestion, collectively executes the habitual operation cluster.

<16> The information processing apparatus according to <15>, in which,

when the same operation as the user operation is an order-variable operation, the control unit suggests collective execution of operations after a pre-condition that is the earliest operation in a variable range in the habitual operation cluster, and, when a collective execution instruction is issued in response to the suggestion, collectively executes the operations for which the collective execution has been suggested.

<17> The information processing apparatus according to <15>, in which,

when an operation before the same operation as the user operation is an order-variable operation, the control unit suggests collective execution of operations that are before the same operation as the user operation and have a post-condition after the same operation as the user operation, and, when a collective execution instruction is issued in response to the suggestion, collectively executes the operations for which the collective execution has been suggested, the post-condition being the latest operation in the variable range in the habitual operation cluster.

<18> The information processing apparatus according to <12>, in which,

when an instruction to collectively execute the habitual operation cluster for which collective execution has been suggested is not issued, the control unit sets a suggestion prohibition flag for the user operation, and prohibits a suggestion of collective execution of the habitual operation cluster based on the same user operation.

<19> The information processing apparatus according to <7>, in which,

when the habitual operation cluster for which a collective execution instruction has been issued is to be collectively executed, and an error occurs due to an operation in the habitual operation cluster, the control unit divides the habitual operation cluster into divisional clusters excluding the operation having the error, and integrates the divisional clusters to be collectively executed.

<20> The information processing apparatus according to <19>, in which,

when the operation having the error is an order-variable operation, the control unit divides the habitual operation cluster into the divisional clusters in accordance with a variable range of the order-variable operation, and collectively executes the divisional clusters.

<21> An information processing method including

a control process to calculate a habituation score indicating a degree of habituation of a user operation, and register a plurality of operations as a habitual operation cluster, the habituation score of the operations being higher than a predetermined threshold.

<22> An information processing method including

a control process to collectively execute a habitual operation cluster on the basis of a user operation or a user utterance, the habitual operation cluster having being registered in advance and including a plurality of operations having a higher habituation score than a predetermined threshold, the habituation score indicating a degree of habituation of the user operation.

### REFERENCE SIGNS LIST

41 Information processing apparatus
51 Input operation unit
52 Functional application program execution unit
53 Operation storage execution control unit
54 User operation history storage unit
55 Habitual operation cluster storage unit
56 Voice input unit
57 Voice recognition processing unit
58 Utterance semantic understanding processing unit
59 Response generation unit
60 Display, image processing unit
61 Voice synthesis processing unit
62 Image output unit
63 Voice output unit

1. An information processing apparatus comprising
a control unit that
calculates a habituation score indicating a degree of habituation of a user operation, and
registers a plurality of operations as a habitual operation cluster, the habituation score of the operations being higher than a predetermined threshold.

2. The information processing apparatus according to claim 1, wherein
the habituation score is calculated on a basis of a harmonic function of a time interval from a previous operation to a current operation, the number of transitions from the previous operation to the current operation, and a probability of a transition from the previous operation to the current operation.

3. The information processing apparatus according to claim 1, wherein,
when the plurality of operations having the habituation score higher than the predetermined threshold is two or more consecutive operations, the control unit registers the plurality of operations as a habitual operation cluster.

4. The information processing apparatus according to claim 1, wherein,
when each operation is the same in the plurality of operations having the habituation score higher than the predetermined threshold, and there exists a plurality of habitual operation clusters in which an order of the operations varies, the control unit integrates the plurality of habitual operation clusters.

5. The information processing apparatus according to claim 4, wherein,
when each operation is the same in the plurality of operations having the habituation score higher than the predetermined threshold, and there exists a plurality of habitual operation clusters is which an order of the operations varies, the control unit sets a variable range of the order of the same operations, and integrates the plurality of habitual operation clusters.

6. The information processing apparatus according to claim 5, wherein
the variable range of the order of the same operations is set with a pre-condition that is a condition of an operation immediately before the order of the operations can be changed, and a post-condition that is a condition of an operation immediately after the order change.

7. An information processing apparatus comprising
a control unit that collectively executes a habitual operation cluster on a basis of a user operation or a user utterance, the habitual operation cluster having being registered in advance and including a plurality of operations having a higher habituation score than a predetermined threshold, the habituation score indicating a degree of habituation of the user operation.

8. The information processing apparatus according to claim 7, wherein
the control unit associates the habitual operation cluster with a phrase obtained from the user utterance, and registers the habitual operation cluster as a macro.

9. The information processing apparatus according to claim 8, wherein
the control unit associates an operation selected by the user with a phrase obtained from the user utterance among the plurality of operations in the habitual operation cluster, and registers the operation as the macro.

10. The information processing apparatus according to claim 8, wherein,
when the habitual operation cluster in which the same operation as the user operation is a termination operation is detected, the control unit suggests registration of the detected habitual operation cluster as a macro, and, when an instruction to register the macro is issued on a basis of the suggestion, registers the habitual operation cluster as the macro.

11. The information processing apparatus according to claim 8, wherein,
when an instruction to register the macro is issued by the user utterance, the control unit suggests registration of the macro of the habitual operation cluster including operations up to the most recent operation and the same operation as the user operation, and, when an instruction to register the macro is issued on a basis of the suggestion, the control unit registers the habitual operation cluster as the macro.

12. The information processing apparatus according to claim 7, wherein
the control unit suggests collective execution of the habitual operation cluster on a basis of the user operation, and, when a collective execution instruction is issued in response to the suggestion, collectively executes the habitual operation cluster.

13. The information processing apparatus according to claim 12, wherein
the control unit suggests collective execution of the habitual operation cluster in which the same operation as the user operation is a top operation, and, when a collective execution instruction is issued in response to the suggestion, collectively executes the habitual operation cluster.

14. The information processing apparatus according to claim 13, wherein,
when the habitual operation cluster in which the same operation as the user operation is the top operation is registered as a macro, the control unit suggests execution of the macro, and, when an instruction to execute the macro is issued on a basis of the suggestion, executes the macro.

15. The information processing apparatus according to claim 12, wherein
the control unit suggests collective execution of the habitual operation cluster in which the same operation as the user operation is an operation other than the top operation, and, when a collective execution instruction is issued in response to the suggestion, collectively executes the habitual operation cluster.

16. The information processing apparatus according to claim 15, wherein,
when the same operation as the user operation is an order-variable operation, the control unit suggests collective execution of operations that are after a pre-condition that is the earliest operation in a variable range in the habitual operation cluster, and, when a collective execution instruction is issued in response to the suggestion, collectively executes the operations for which the collective execution has been suggested.

17. The information processing apparatus according to claim 15, wherein,
when an operation before the same operation as the user operation is an order-variable operation, the control unit suggests collective execution of operations that are before the same operation as the user operation and have a post-condition after the same operation as the user operation, and, when a collective execution instruction is issued in response to the suggestion, collectively executes the operations for which the collective execution has been suggested, the post-condition being the latest operation in the variable range in the habitual operation cluster.

18. The information processing apparatus according to claim 12, wherein,
when as instruction to collectively execute the habitual operation cluster for which collective execution has been suggested is not issued, the control unit sets a suggestion prohibition flag for the user operation, and prohibits a suggestion of collective execution of the habitual operation cluster based on the same user operation.

19. The information processing apparatus according to claim 7, wherein,
when the habitual operation cluster for which a collective execution instruction has been issued is to be collectively executed, and an error occurs due to an operation is the habitual operation cluster, the control unit divides the habitual operation cluster into divisional clusters excluding the operation having the error, and integrates the divisional clusters to be collectively executed.

20. The information processing apparatus according to claim 19, wherein,
when the operation having the error is an order-variable operation, the control unit divides the habitual operation cluster into the divisional clusters in accordance with a variable range of the order-variable operation, and collectively executes the divisional clusters.
